(19) United States
(12) Patent Application Publication
(10) Pub. No.: US 2017/0263073 A1
(43) Pub. Date: Sep. 14, 2017

(54) APPARATUS FOR PLAYING A GAME COMPRISING A SUBSTRATE DISPLAYING A MATRIX

(71) Applicant: LMS PATENTS (ISLE OF MAN) LIMITED, Douglas (IM)

(72) Inventors: John Anthony REID, Auckland (NZ); Glen David SMITH, Auckland (NZ)

(21) Appl. No.: 15/511,710

(22) PCT Filed: Sep. 16, 2015
(86) PCT No.: PCT/IB2015/057104

§ 371 Date: Mar. 16, 2017

(30) Foreign Application Priority Data
Sep. 17, 2014 (NZ) 700135
Dec. 24, 2014 (NZ) 703466
Feb. 17, 2015 (NZ) 705114
Mar. 12, 2015 (NZ) 705936
Apr. 17, 2015 (NZ) 707121

(51) Int. Cl. G07F 17/32

(52) U.S. Cl. CPC G07F 17/329; G07F 17/326; G07F 17/3241; G07F 17/3218; G07F 17/3216; G07F 17/3258

(57) ABSTRACT

Apparatus for playing a game has a set of cards. Each card has at least one matrix of m cells displaying a set of n differing symbols on each card, the layout of the symbols differing from matrix to matrix on the cards with each symbol appearing once on each matrix. In play, the symbols a random process is used to rank the symbols and the ranking of each symbol on a card is recorded. Adjacent symbols having sequential rankings are recognized by displaying links between these cells. Play continues until all symbols in the matrix have been ranked. Single play or multi-player games can be conducted with these cards as well as the sale of “scratch and win” cards.

### FIELD OF THE INVENTION

The present invention relates to apparatus for playing a game comprising a substrate displaying a matrix, typically a card or a set of cards, a game and a method for playing the game. The invention is directed particularly, but not solely towards a game that is played on a novel set of cards similar to those used in bingo games.

### RELATED INVENTIONS

Our co-pending patent application entitled “SYSTEM FOR MAPPING AND CONVERTING ONE OR MORE MATRICES” claims priority from the same priority documents as this application.

### BACKGROUND OF INVENTION

Most people are familiar with a game played on a matrix card or board, for example bingo games. Bingo games initially began as a type of lottery played in Renaissance Italy and then France in the late 18th century where it became known as “Le Lotto.” All main types of bingo have many variations. Accordingly the rules are not always exactly the same. Traditionally they have been played on printed tickets, cards or boards, (collectively called “cards” herein) or more recently on a VDU or some form of electronic terminal. Traditionally such “cards” comprised information in a defined layout printed onto paper or more likely a thin cardboard substrate. More recently these printed cards have been replaced by transient images on VDUs, the image appearing as a representation of a card for the duration for the game. This reference to a matrix displayed on a substrate includes images on the surface of a VDU screen and images created in or at the rear of the VDU screen or otherwise projected so as to be visible to a player whether by virtual reality goggle or a holographic projection or otherwise howsoever.

### Major Versions of Existing Bingo Games

The main types of bingo are:

90-Ball Bingo—

90-ball bingo is the traditional format of the game played in Europe and Australia. It is the most popular form of the game played in the United Kingdom.

Each bingo card has three rows and nine columns, with five numbers on each row for a total of 15 numbers. Each number is between 1 and 90.

Tickets are commonly sold in strips of six, which means that the purchasing player of a strip of 6 will have all 90 numbers across all six cards, and will have a hit for every number called.

As the bingo balls are called, players cross off the numbers, seeking to win by being first to mark five numbers in a line on a single ticket. Subsequent to a winner being announced, players attempt to mark two full lines on one ticket and then a “full house” covering all 15 numbers.

90-ball bingo, (and other bingo games of this similar type/size) can be divided into multiple rounds. For example, a three round game can comprise:
The first round goes to the first player to mark off one complete horizontal line of numbers. This player wins a small portion of the prize fund.
The second round, with a slightly larger prize, goes to the first player to mark off two complete horizontal lines.
The third round goes to the first player to mark off all numbers on their card. This player will win the main prize of the game.

75-Ball Bingo—

The U.S. card features a 25-box grid. It has five rows of boxes arranged in five lettered columns containing 24 numbers and a “free” space in the very middle. Played with just 75 balls, the numbers 1-15 appear in the “B column”, 16-30 fall in the “I column”, 31-45 go in the “N column” (where the free space is located), 46-60 are in the “G column”, and 61-75 occupy the “0 column”. To win, a player must be first to mark five numbers in a row, a column, or a diagonal. Sometimes the requirement to mark 5 in a row is reduced to 4 in a row.

80-Ball Bingo—

This is a relatively new U.K. version of the game. Unlike 75 ball and 90-ball bingo, which originated in the live format of the game, 80-ball bingo is specifically an online variation of the game. It uses a ticket with a 4×4 matrix of numbers consisting of 16 numbers. These cards are usually arranged so that only certain numbers appear in each column:
Column 1: 1-20
Column 2: 21-40
Column 3: 41-60
Column 4: 61-80

The winner of a game is the first player to mark off a specified pattern. The required pattern might be a vertical line or horizontal line, as in 75-ball bingo, but with only 4 numbers required these games are completed more quickly. There are many variations of patterns that might be required to be matched. For example some other required patterns include all 4 corners, 2 complete lines or a full house (every number marked off).

Mini Bingo—

This is 30-ball bingo played on a ticket with nine squares in a 3×3 matrix. It is becoming popular online because it is fast, with each round lasting no more than several minutes, which means more winners per hour.

Pattern Bingo—

Played usually on the U.S. card, winning combinations must form a certain shape or pattern, such as four corners, the letter L or T.

Progressive Bingo—

The player only has a certain number of goes to obtain the required winning pattern. Once the number of tries has been exceeded, the game is over, and the prize is carried into the next round. This has the similar effect to a jackpotting Lotto game.

Coverall—

In the U.K., this is the same as a full house. It may also be referred to as “blackout” in the U.S. The object is to be first to cover all of the numbers appearing on a ticket. In some games, progressive jackpots can be used, awarding a huge prize pool to the player who can cover every box within a certain numbers of balls called.

Quickie—

A game in which numbers are called as quickly as possible. The winner is the first to fill the entire card. A variation of this is “Speed Bingo′ sometimes played with a pattern.

Bonanza Bingo—

In the U.S., a progressive coverall Jackpot that is typically played as the 13th game of a day's sessions. It involves the pre-selection of forty-five numbers, which players mark on separate cards. Assuming no winners to share the prize money initially, numbers are called until a coverall is achieved.

Money Ball—

Prior to the start of a game, one number is designated that will double the player's winnings if a Bingo is hit on that exact number. A variation of this is “Lucky Ball′ where the very first number called during the first session becomes “lucky” for the rest of the day, and any players who Bingo with it receive a bonus.

Texas Blackout—

Whatever number is called first must be odd (1, 3, 5 . . . ) or even (2, 4, 6 . . . ). If it is even, for example, all of the even numbers on every card become “Wild” and are immediately covered—vice versa for odd. The game then continues until someone wins with a blackout.

Horse Race Bingo—

Up to 15 players can play this variant of bingo. These players will have their own numbers from 1-15, which will correspond to the top row of their cards. Once a player gets five matching numbers in his column, he will be the winner of horse race bingo.

Death Bingo—

This game inverts the traditional bingo game. When one player gets bingo, he will be eliminated. Therefore, the last one standing will be declared the winner. Alternatively, in another variation when a player gets bingo, all the other players will find out if they have the least number of filled spaces in their cards. The winner will be the one with the most spaces left.

### Jackpot Games

Jackpot games are games where there is a particularly big prize at stake, which can only be won if certain conditions are met. There are generally two types of jackpot games:
fixed jackpots, where the prize is a set amount of money, and
Progressive jackpots, which increase over time until they are won.

### Bingo Prizes and Jackpots

Usually, the size of the typical jackpot is based on how much money is coming in.

A progressive jackpot is a prize that keeps growing from game to game until somebody wins it. To win the progressive, a player must have an extraordinary win, such as a blackout (covering every space on a bingo card) in only 49 balls. If no one wins, the house chips in extra money to sweeten the pot even more.

The popularity of big prizes has allowed bingo to expand into more lucrative games. This has resulted in the spread of high-stakes games.

Some of the super-jackpots are set up to be “step games' where the game pays different amounts depending on how quickly the winner gets a blackout. For example, a blackout in 49 numbers might pay $50,000, while a blackout in only 45 numbers could earn $100,000. This step in prize amount is because the odds change. It's very hard to get a blackout in so few calls.

In some bingo game variations, in order to win this or other super-jackpots, players may have to get a special pattern within a certain number of calls, and in addition, may have to play another game of chance, such as spinning a wheel.

### Bingo Odds

The odds in a traditional non progressing bingo game, where there is one winner that will emerge, is 1 in the total number of cards in play.

These odds don't apply to progressive jackpot games or step games, as a winner is not guaranteed. In this case the odds depend on the difficulty of covering the pattern in the predetermined number of calls. These odds will vary depending on the game.

### Various Bingo Patterns

The two main types of bingo are 75-ball and 90-ball bingo. But regardless of the main bingo type, there are different patterns used in both. The following patterns are among the most popular seen in both 75-ball and 90-ball bingo.

Horizontal—

With horizontal bingo, a player must have one or more horizontal line(s) of the required number (usually 5 numbers in any order in a row) in order to win the game.

Vertical—

The only difference between horizontal and vertical bingo is the direction of the line.

Diagonal—

requires the player to make a line from one top corner to the opposite bottom corner (usually 5 numbers in any order in a row).

Coverall—

Coverall (or blackout) bingo is the most difficult pattern to achieve. Usually, progressive jackpots use the coverall pattern and require players to get a “bingo” in 40 calls or less in order to win the jackpot.

Pattern—

Pattern bingo can cover a wide array of interesting patterns. The pattern will be shown to all players and in order to win, the pattern must be replicated on the card. Diamonds, castles and hearts are three popular patterns used in pattern bingo.

### Multiple Winners

It is not uncommon in existing bingo games for multiple winners to be declared in a single bingo game. In the case of two or more winners, the prize is split evenly. In 75-ball games, it is less likely that two or more winners will be called but in 90-ball games, multiple winners are more frequent because the odds of correctly getting the right balls and the right matching patterns for the overall winner are harder.

### Bingo Technology Progress

The biggest technological innovation in the past twenty years has been the introduction of electronic daubing to the game. Electronic daubing is made possible through the computerised drawing of numbers.

It started with GameTech's invention called the T.E.D. or “Ted′ a handheld terminal capable of displaying four bingo cards at a time and automatically playing up to 600 cards in a single game. Even newer versions of this electronic daubing technology have been introduced in the past few years, such as the lightweight “Traveller’ which can show up to 21 cards at a time and play up to 1,200 cards in one game.

Technology has also allowed an entirely new form of bingo to grow worldwide via the Internet. Virtual bingo halls now offer players access to games 24/7 and by using devices such as a smart phone, tablets, PDA or PC, it is now also possible to download mobile bingo applications and play anywhere.

### Patents

Examples of patents in this area include:
1. U.S. Pat. No. 8,764,543 “Method and System for Playing a Networked Bingo Game”
2. U.S. Pat. No. 8,956,212 “Method of Playing a Bingo-Type Game with a Mechanical Technological Aid, and an Apparatus and Program Product for Playing the Game”
3. U.S. Pat. No. 7,726,652 “Lottery Game Played on a Geometric Figure Using Indicia with Variable Point Values”
4. US 2004/0119232 “Bingo Type Numbers Game”

### Limitations of Existing Bingo Systems

Existing forms of bingo games often have relatively small prizes, which are won by the bingo player that first gets the required pattern. Prizes, if any, for the other players are often limited.

Some bingo games have a guaranteed winning outcome even if there is no clear winner, but they have the disadvantage that they can have multiple ‘first’ or top placed winners that share the top prize, which is often considered by players to be less desirable than having a game outcome where the first prize is undiluted and is substantially always won by a single bingo card or entry.

Where bingo is played with progressive jackpots, then the odds are stacked against a winner. This means that the games usually have no winner and accordingly the first place prize on offer in a progressive game is often not won and also any other prizes on offer are often limited.

Further, to increase the level of the first place prize (or progressive jackpot) available in a bingo game, the odds against winning the first place prize have to be increased. This is usually done by increasing the number of balls in a bingo game (such as using the 90-ball game), or by increasing the odds by increasing the number of balls that form the pattern to be matched by the players within the game. It can be a combination of both. Alternatively, the bingo gaming operator may require another game of chance to be played by the winning bingo player, such as spinning a wheel, or picking a number from 1 to 10, before that player can claim the first prize.

Further, some or all of these factors increase the length of the bingo game, which can be a disadvantage for some parties, including players who desire a quicker game.

The ability to have numerous prize points on offer, or the flexibility to structure prizes around numerous outcomes within a game, is also desirable.

The ability to have a wide range of odds in respect of numerous outcomes within a game is also desirable.

The ability to allow a player of a game to have instant play access, and to play a game as a sole player of the game where the prizes are set prizes based around the odds of numerous outcomes within the game, including large insured lottery style prizes, is also desirable.

In respect of a game that is played by a pool of players, the ability to substantially always guarantee a sole winner for the first prize on offer, or in the alternative, in a relatively few occasions, a small group of winners for the first prize on offer, in any game, irrespective of the participants' choices on entry, is also desirable.

The ability to reduce the number of balls in a bingo game in a way that decreases the time that a game takes, and when doing so does not result in any adverse reduction in game odds that would adversely affect prize amounts, is also desirable.

The ability to have a winner of the first prize on offer and for that winner to almost always be a single bingo or matrix card entry, but to also allow the game to run its full course so as to create numerous minor winners, is also desirable.

Many other gaming operators, such as a LOTTO operator, are faced with the practical problem that when increasing the odds against there being tied winners of the first prize, they increase the odds against there being a first prize winner at all. For example, in a game of LOTTO if the odds are set at 30 times the expected number of participants (entries), practically that LOTTO Operator's player base won't have a winner of the first prize, the odds are stacked against there being any first prize winner from that LOTTO game, and their players will come to the belief that they can't win, and some will eventually become disillusioned with that LOTTO game and ‘leave’. But on the other hand, if the odds against winning are set too low for the number of participants in that LOTTO game, then too many tied winners will result and the benefits of having a single winner being the sole winner of the first prize in the first division of such a LOTTO game are lost, as the first prize will need to be shared amongst two or more winners of first division.

It would also be desirable for the bingo game to be able to have multiple winners of the top pattern prize, say matching 5 in a row, yet at the same time the game has the ability to rank those multiple winners of the 5 in a row individually (and to rank any smaller sub set or lower ranked prize category) and to determine almost always or with substantial certainty one top winner from the relevant prize group.

It would be further desirable to achieve the ranking of the top winning group in a way that is transparent for players.

It would also be desirable for the bingo gaming event to be capable of a number of different methods of presenting the results of the bingo game to participants, particularly in a simplified manner that is transparent and easily understood.

It would also be desirable for the game to be capable of awarding prizes to those participants that fail in the game in a way that is profitable for the gaming operator.

It would also be desirable for the game results to be independently audited by an independent third party.

It would also be desirable for the game to be capable of use in many different gaming sectors or categories, such as use in the LOTTO and Lottery sectors, the Casino sector, the Slot sector, as well as in the Bingo sector of the gaming market.

### PRIOR REFERENCES

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### Definitions

For the purpose of this specification:

Cell number refers to the numbers printed or displayed on a card.

Comprise: It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Card: Unless otherwise noted, the word “card” or “cards” shall encompass a real matrix card(s) or a virtual representation of a matrix card(s).

Cell: refers to an area within a matrix of similar areas, with or without defining borders.

Drawn number refers to each number as it is called out or transmitted to a visual display unit.

Drawn symbol refers to each symbol as it is called out or transmitted to a visual display unit.

Gaming Operator/s: means any party that is legally able to undertake gaming and or betting activities with or without prizes, and where the context requires shall include any State Lottery Operator. “Gaming operator/s” and or “gaming operator/s” shall have a corresponding meaning.

Game Play Area: a matrix.

Joker/s: Any drawn number that is rejected by a player under the rules of any relevant Link2Win™ game, with the rejected number becoming a “joker” number which can be used as required and in compliance with the rules of any relevant Link2Win™ game in order to complete links, with those links being in respect of 3 Links or greater. An example of a relevant Link2Win™ game is set out in Example 8. Joker Number/s and or Joker number/s shall have a corresponding meaning.

Lottery: Any game of chance.

Matrix: Unless otherwise noted, the word “matrix” or “matrices” shall be comprised of any grouping (including any multi-dimensional grouping) in a grid like array typically but not limited to a rectangular array of a×b cells. Cells at least in the central region of a matrix will have neighbouring cells. Various matrix configurations are illustrated in the drawings. In our most preferred examples we refer to a 5×5 matrix.

Money and Prizes: Depending upon the rules of a game, any prize amounts may include a real prize amount with monetary value. However, it may also include a virtual prize amount with no monetary/financial value in the real world. Examples of virtual prize amount can be scores, visual representations indicating virtual money, or any form of recognition that does not provide any form of financial gain to the player(s)/participant(s) of the game.

Similarly, an entry fee may include an actual fee using real money. However, it may also include a virtual entry fee which is an entry fee that provides no real monetary/financial gain to the gaming operator. Non-monetary payment of the virtual entry fee can be made using “virtual money” or any form of non-monetary recognition that may be earned/collected by the player(s)/participant(s) of the game using several ways such as but not limited to the player's experience, length of membership, scores from previous games, clicking on the advertisements, sharing the game or its advertisement on social media etc.

Quick Response (QR) code: For the purpose of this specification, and unless otherwise noted, the term ‘Quick Response (QR) code’ shall have a wide meaning and shall also include any other form of technology that could be used in the alternative to deliver the same or similar functionality to be used where intended with this invention, including for the avoidance of doubt other technologies such as bar codes and Near Field Communication codes (“NFC” or “NFC codes”). “Quick Response code” and “QR code” have a corresponding meaning.

Random or Random Number Generator as used herein includes both random and pseudo-random selections unless otherwise noted.

State Lottery Operator: Any authorised body or legal entity, including any company or person, authorised by a country or a state of a country, to run its lottery business.

Token number refers to the ranking numbers on the tokens.

### OBJECT OF THE INVENTION

It is an object of this invention to provide novel apparatus for playing a game, or a novel game, and/or a system and method for playing the game, which will obviate or minimise the foregoing disadvantages or go at least some distance towards meeting the foregoing desirable attributes or at least some of them in a simple yet effective manner or one which will at least provide the public with a useful choice.

### SUMMARY OF THE INVENTION

The various aspects of the invention are set out below and in the claims, and the contents of the claims are incorporated herein by way of reference.

In one general aspect the invention provides apparatus for playing a game comprising a substrate wherein the substrate has a matrix of symbols, the symbols comprising a set of sequential symbols (e.g. consecutive numbers), wherein the symbols have been allocated at random to locations on the substrate to populate the matrix so that the resulting layout on the substrate comprises the location of each symbol within the matrix, and means for displaying on or in association with each matrix the existence of links between symbols in the matrix in accordance with the rules of the game.

The substrate may be a VDU screen or some other surface on which the matrix is displayed. In some cases it will be a printed card where the symbols are visible on its face, and in other cases it will be a scratch and win card where the symbols have been hidden by an opaque layer.

In another aspect the invention provides apparatus for playing a game comprising a card wherein the card displays a matrix of symbols, the symbols comprising a set of sequential symbols (e.g. consecutive numbers), wherein the symbols have been allocated to locations on the card to populate the matrix so that the resulting layout on the card comprises the location of each symbol within the matrix, and means for displaying on or in association with each matrix the existence of links between symbols in the matrix in accordance with the rules of the game.

Preferably the location of the symbols on the card and each symbols relationship to its surrounding symbols cannot be pre-determined or predicted by the player, and in most situations this would involve a process for allocating the symbol to card locations by a random process or at random.

The card can be a printed card, a card displayed on a VDU during the course of a game, or a layer printed on and hidden by a scratch-off layer of a scratch card.

The random allocation of symbols from the set of sequential symbols to locations on the card is best suited to the creation of a number of different scratch cards, but can also be used with gaming machines in playing one-off games where the random layout is unique to that machine and that particular game.

Other versions are described where multi-player games can be provided and a single random draw can be applied to a large number of different cards on different gaming machines. In these versions of the game and these versions of the cards it is preferable that the cards display a first layout of first symbols and that these symbols are then ranked in order and replaced by the set of sequential symbols in the order of the draw in the appropriate locations on each card previously occupied by the drawn symbols on the card.

In one aspect the invention provides apparatus for playing a game comprising a set of cards wherein each card displays at least one matrix of m cells, and each matrix displays differing symbols on at least some of its cells, the differing symbols chosen from a set of n symbols, the layout of the symbols differing from matrix to matrix on the cards, means for displaying on or in association with each matrix the sequence in which the symbols have been ranked during the course of a game so that each of the symbols is differently ranked within a matrix, and means for displaying on or in association with each matrix the existence of adjacent symbols having sequential rankings.

Preferably m<n. (An equal number, or in some cases more symbols than can fit in a particular matrix).

In most cases described in the examples we prefer to make m=n (that is to say we have chosen to use 25 symbols in a 5×5 matrix of cells so that all symbols appear once only on each matrix. Cell borders need not be displayed—though they are of assistance in the example with printed cards and plastic tokens used to cover the cells as symbols are ranked. Thus although we mention cells they are more in the nature of locations within each matrix occupied by each cell symbol so the matrix is made up of the chosen arrangement of symbols typically in orderly rank and file whether or not there are borders around each symbol.

Preferably each matrix displays a full set of n differing symbols and each symbol appears only once on each matrix.

Preferably each card is a printed card having a substrate on which the set of m cells is printed in a matrix and the symbols are printed on or in association with the matrix, with each symbol being located within the confines of a respective cell.

Preferably the apparatus also includes a set of at least n tokens, each token being of a size that is equal to or less than the cell size of each cell in the matrix, each token having at least two faces, a first face and a contrasting face and each token having a sequential ranking chosen from 1 to n recorded on both the first face and the contrasting face. In use tokens can be placed on the cells in sequence with a first face showing as each symbol is called and links between sequentially selected symbols in adjacent cells can be recorded by changing the display of one or more tokens on the cells so that the one or more tokens display a contrasting face.

Preferably the cards are scratch cards and the ranking is printed on a hidden layer which can be revealed by scratching away a scratchable layer.

Preferably a random matrix of symbols on each card is printed on or above the scratchable layer.

Preferably each card also includes at least one machine readable code.

Preferably the apparatus includes at least one visual display unit displaying one or more cards.

Preferably the or each visual display unit is adapted to display the ranking of each cell in a matrix as each cell number is selected during the course of a game.

Preferably each visual display unit is adapted to display links between sequentially selected symbols in adjacent cells.

Preferably each visual display unit is adapted to allow a player to allocate or re-arrange the set of n symbols within the matrix of m cells to define his own arrangement of symbols prior to play.

Preferably the apparatus also includes a game server, wherein there are a plurality of visual display units adapted to receive and send game information from and to the game server which is adapted to (a) record entries, (b) use a random or pseudo random selection process for the symbols during the course of a game and (c) to relay information on the selection of the symbols to each visual display unit.

Preferably the plurality of visual display units are or form part of casino machines which are connected to a game server by a secure network.

Preferably the plurality of visual display units are or form part of machines chosen from the group comprising: personal computers, gaming machines, tablets, smart phones, hand held or portable machines, and the like.

A method of playing a game utilizing a set of “cards” as defined in the first statement of invention wherein one or more “cards” are issued to a player and displayed on a player's VDU and the set of n symbols is ranked and electronically changing the display of symbols on the matrix so as to display the ranking of those symbols on the VDU, and displaying on the VDU within each matrix the existence of links between adjacent symbols having sequential rankings.

Preferably prizes are awarded based on the number of links on each matrix.

In another aspect the invention provides a method of playing a game comprising issuing a card or cards to one or more players from a set of cards, wherein each card displays at least one matrix of m cells, and each matrix displays differing symbols on at least some of its cells, the differing symbols chosen from a set of n symbols, the layout of the symbols differing from matrix to matrix on the cards, commencing the game and ranking the symbols, displaying on or in association with each matrix the sequence in which the symbols have been ranked during the course of a game so that each of the symbols is differently ranked within a matrix, and displaying on or in association with each matrix the existence of links between adjacent symbols having sequential rankings.

In some cases the game can be played with printed cards or with scratch cards as will be described in the examples, but in its most preferred forms it is played on a VDU (most preferably some form of portable or mobile device) so that the change from the original symbols represented on the electronic card to the ranking of those symbols can be controlled by the computing device and the links between adjacent symbols having sequential rankings can be displayed on the VDU.

Alternatively m>n, which means that he matrix has more cells than there available symbols, giving rise to a matrix with gaps and thus reducing the probability of links occurring between adjacent cells.

In most cases we prefer to have m=n (to produce fully populated matrices) so that the number of cells equates to the number of symbols. In the examples we refer to a 5×5 matrix with a set of 25 symbols. In most cases we prefer to use the set of ordinal numbers 1 to 25 as the symbols as most people find it easy to distinguish between numbers when called out or displayed on a screen.

The underlying method of playing the game (and recognizing links) is best understood from the various examples. The examples also include variations to the rules on prize allocations and explain the odds against a matrix having a large number of links.

In another aspect the invention provides, a method of playing a game as herein described, wherein prizes are awarded based on the number of links on each matrix. A method of scoring a matrix of symbols, recording a first layout comprising the location of each symbol within the matrix, applying a ranking to the symbols to create a second layout representing the ranking of each symbol within the matrix, recording links between adjacent sequentially ranked symbols in the matrix, and scoring the matrix by counting the number of links to produce a score for that matrix.

Preferably the method further includes the step of allocating a prize based on the score achieving a set number of links.

In another aspect the invention provides, a method of scoring a matrix of symbols printed on a card, the printed layout on the card comprising the location of each symbol within the matrix, applying a ranking to the symbols, using sequentially ranked counters to produce a second layout by placing the counters over the symbols to display the ranking of each symbol with the matrix, recording links between adjacent sequentially ranked symbols in the matrix, and scoring the matrix by counting the number of links.

In another aspect the invention provides, a method of scoring a matrix of symbols displayed on or by a visual display unit (VDU), a first displayed layout comprising the location of each symbol within the matrix, applying a ranking to the symbols, changing the display of the matrix by replacing each symbol within the matrix by its sequential ranking to create a second layout representing the ranking of each symbol within the matrix, recording links between adjacent sequentially ranked symbols in the matrix, and scoring the matrix by counting the number of links to produce a score for that matrix.

Preferably the VDU also displays the links between adjacent sequentially ranked symbols in the matrix.

Preferably the method further includes the step of allocating a prize based on the score achieving a set number of links.

In another aspect the invention provides, a VDU displaying a matrix of symbols, wherein the VDU displays a layout comprising the location of each symbol within the matrix, and wherein each symbol differs from each other symbol within the matrix.

Preferably the VDU also displays links between adjacent sequentially ranked symbols in the matrix.

Preferably the VDU also displays a score for that matrix based on the number of displayed links.

In another aspect the invention provides, a plurality of VDUs, each displaying a matrix of symbols, each VDU displays a first layout comprising the location of each symbol within the matrix, applying a common ranking to the symbols in each displayed matrix to create a second layout on each VDU representing the ranking of each symbol within the VDU's matrix, recording links between adjacent sequentially ranked symbols in each matrix of each VDU, and scoring each matrix by counting the number of links to produce a score for that matrix.

Preferably a set of symbols is common to each matrix, and each the matrix is fully populated with the entire set of symbols, and each matrix differs from each other matrix in the location of some or all of its symbols to display a different pattern of symbols from the displays on the other VDUs.

In another aspect the invention may broadly be said to reside in a system for operating a bingo gaming event or playing a bingo game wherein the bingo gaming event or the bingo game closes at a defined time or upon reaching of defined parameters, wherein the system provides for participants to select all or substantially all of the symbols/numbers from a defined available range of symbols/numbers from one to n and to randomly place those symbols/numbers on a real or a virtual bingo card or board or similar representation.

Preferably, the system is a computerised gaming system.

Preferably, the system provides for a ranking of the symbols/numbers in a defined available range of one to n based on a placement value for each n symbol/number determined on a random draw of all the n symbols/numbers.

Preferably, the system allows participants (including the gaming operator) to use the results of the ranking or placement order of the defined available symbol/number range of one to n, to identify links with the symbols/numbers as set out on the real or virtual bingo card or board or similar representation, the links being determined in accordance with the rules of the game.

Preferably, the identification of links with the participant's numbers is done by the participant directly, or by a gaming operator, or automatically by a computer system. Preferably, the system uses the results of the ranking to rank participants in the gaming event by reference to their associated bingo card(s) and determine one or more winners.

A system and/or method for operating a bingo gaming event wherein the bingo gaming event closes at a defined time or upon reaching of defined parameters, wherein the system and/method provides for participants to select all or substantially all of the symbols/numbers from a defined available range of symbols/numbers from one to n and to place those symbols/numbers, including by random placement, on a real or virtual bingo card or board or similar representation, wherein the system and/or method provides for a ranking of the symbols/numbers in a defined available range of one to n based on a ranking or placement value/order for each n symbol/number on a random draw of all the n symbols/numbers, and wherein the system and/or method allows participants to use the results of the ranking or placement order of the defined available symbol/number range of one to n, to identify links with their symbols/numbers as set out on the real or virtual bingo card or board or similar representation, the links being determined in accordance with the rules of the game.

A computerised bingo game having at least one computer system for recording entries and determining one or more winners, wherein the bingo game closes at a defined time or upon reaching of defined parameters, wherein the bingo game provides for participants to select all or substantially all of symbols/numbers from a defined available range of symbols/numbers from one to n and to place those symbols/numbers, including by random placement, on virtual bingo card or board or similar representation.

In another aspect, the invention resides in a computerised game having at least one computer system for recording entries and determining one or more winners, wherein the game closes at a defined time or upon reaching of defined parameters, wherein the game either:
provides for the participants to select directly or indirectly (including by way of a random choice) some or all of the symbols from a defined available range of symbols from one to n and to place those symbols on a Game Play Area(s); or
uses a random number generator to randomly generate some or all of the symbols on the Game Play Area(s) and
to place those symbols on Game Play Area(s), including by random placement.

Since most of the preferred embodiments show the use of a set of 25 sequential symbols (numeral 1 to 25 for convenience) being used to fully populate a 5×5 matrix it is possible to (a) choose numbers at random and populate the matrix cells one by one in an ordered fashion, say first row from one end to another, then the second row and so on, or (b) choose numbers either sequentially or at random and then allocate them to unfilled locations within the matrix; or (c) provide a first layout of symbols on the card (either a first set or the sequential set of symbols) then rank the symbols preferably by some form of random draw and replace each first symbol with its ranking; or (d) some combination of the above arrangements.

In another aspect, the invention resides in an electronic game apparatus for operating and/or processing a gaming event or a game as defined in any of the statements above, the apparatus comprising: a display; an interface capable of accepting instructions from a player to initiate play of the game; a memory capable of storing a plurality of software instructions, one or more winning game patterns and pay table information corresponding to said one or more winning game patterns; a processor for controlling the display and the interface, the processor being adapted to implement the required software instructions.

Preferably, the processor is adapted to implement the required software instructions including as may be relevant producing, collecting, obtaining and/or otherwise dealing with any one or more symbols produced by one or more random number generators.

In another aspect, the invention resides in a game as defined in any of the statements above, or a game that implements a system as defined in any of the statements above, or a method or a computer program as defined in any of the statements above, wherein there is always a guaranteed first place entry (or best entry) result that wins the relevant prize associated with that outcome and where it is substantially certain that there will always be a single winning entry for this outcome.

In another aspect, the invention resides in a scratch card for use in a game as defined in any of the statements above, the scratch card comprising at least a visual representation of a Game Play Area(s), for example: a matrix showing random placement of n numbers in n cells, wherein the scratch card preferably also has two hidden features printed on it which can be revealed by scratching those features clear, the two hidden features being a unique and individual random draw of n numbers so that a player can manually check the scratch cards for any links, and a machine readable code such as a bar code or a Quick Response (QR) code.

In the alternative, the scratch card could hide the numbers contained in each cell and once revealed, the player can manually check for links in accordance with the rules of the game.

Preferably, the machine readable code comprises:
at least positional placement information of the n symbols at the Game Play Area(s) on the scratch card,
a unique ID of the scratch card,
and as relevant, the scratch Card's unique random draw of n symbols.

Preferably, the Scratch Card further comprises a separate bar code that is used by the POS retailer, scanning it to: (a) at the time of sale, verify to the State Lottery Operator that the Scratch Card has been sold and the entry fee received and/or (b) when presented by a participant following its scratching, whether or not it is a winning Scratch Card, including the amount of any winnings.

In another aspect, the invention resides in a system and/or method and/or computer program and/or a game that involves the use of the scratch card(s) as defined in any of the statements above.

In another aspect, the invention resides in a ticket for use in a single play of a game as defined in any of the statements above,
the ticket showing at least:
a visual representation of a Game Play Area(s), for example: a matrix showing random placement of n symbols in or on n spatial places,
a random draw of n symbols that allows a participant to review the order of the random draw and/or to review the order of draw and based on that order, to manually search for links on the ticket, and
a machine readable code such as a bar code or a QR code.

Preferably, the machine readable code comprises:
at least positional placement information of the n symbols on the issued ticket (being those n symbols that are displayed at the Game Play Area(s), all of which are displayed on the face of the ticket),
a unique ID of the ticket,
the ticket's unique random draw of n symbols.

Preferably, the ticket further comprises a separate bar code that is used by the POS retailer (scanning it when it is presented by a player who wants to check it, or who claims it to be a winning ticket) to (a) confirm whether or not it is a winning ticket, (b) see information on the amount of any winnings, and (c) provide the required advice to, and/or to receive the required confirmations from, the State Lottery Operator.

In another aspect, the invention resides in a system and/or method and/or computer program and/or a game that involves the use of the ticket(s) as defined in any of the above statements.

In another aspect, the invention resides in a ticket for use in a multi entry play of a game as defined in any of the statements above,
the ticket showing at least:
a visual representation of a Game Play Area(s), for example: a matrix showing random placement of n symbols in or on n spatial places, and
a machine readable code such as a bar code or a QR code.

Preferably, the machine readable code comprises:
at least positional placement information of the n symbols on the issued ticket (being those n symbols that are displayed at the Game Play Area(s), all of which is displayed on the face of the ticket),
a unique ID of the ticket.

Preferably, the ticket further comprises a separate bar code that is used by the POS retailer (scanning it when it is presented by a player who wants to check it following the draw, or who claims it to be a winning ticket) to (a) confirm whether or not it is a winning ticket, (b) see information on the amount of any winnings, and (c) provide the required advice to, and/or to receive the required confirmations from, the State Lottery Operator.

In another aspect, the invention resides in a scratch card for use in a game that provides for a ranking of symbols in a defined available range of one to n based on a placement value/order for each n symbol determined on a random draw of all the n symbols, the scratch card comprising at least a visual representation of a Game Play Area(s), for example: a matrix showing random placement of n numbers in n shapes, wherein the scratch card has at least two hidden features printed on it which can be revealed by scratching those features clear, the two hidden features being a unique and individual random draw of n numbers, and a machine readable code such as a bar code or a Quick Response (QR) code.

Preferably, the machine readable code comprises:
at least positional placement information on the Game Play Area(s) on the scratch card (being those n numbers that are displayed at the Game Play Areas, all of which is displayed on the face of the scratch card),
a unique ID of the scratch card,
the scratch Card's unique random draw of n numbers.

Preferably, the scratch card further comprises a separate bar code that is used by the POS retailer, scanning it to: (a) at the time of sale, verify to the State Lottery Operator that the Scratch Card has been sold and the entry fee received and/or (b) when presented by a participant following its scratching, whether or not it is a winning Scratch Card, including the amount of any winnings.

In another aspect, the invention resides in a ticket for use in a game that provides for a ranking of symbols in a defined available range of one to n based on a placement value/order for each n symbol determined on a random draw of all the n symbols,
the ticket showing at least:
a visual representation of a Game Play Area(s), for example: a matrix showing random placement of n symbols in n squares or positions,
a random draw of n symbols that allows a participant to review the order of the random draw and/or to review the order of draw and based on that order, to manually search for links on the ticket, and
a machine readable code such as a bar code or a QR code.

Preferably, the machine readable code comprises:
at least positional placement information at the Game Play Area(s) of the n symbols on the issued ticket (being those n symbols that are displayed at the Game Play Area(s), all of which is displayed on the face of the ticket),
a unique ID of the ticket,
the ticket's unique random draw of n symbols.

Preferably, the ticket further comprises a separate bar code that is used by the POS retailer (scanning it when it is presented by a player who wants to check it, or who claims it to be a winning ticket) to (a) confirm whether or not it is a winning ticket, (b) see information on the amount of any winnings, and (c) provide the required advice to, and/or to receive the required confirmations from, the State Lottery Operator.

In another aspect, the invention resides in a system and/or method and/or computer program and/or a game that involves the use of two or more events, each event applied to one set of n symbols in order to create
one set of n symbols that are ordered by way of a random draw (the “Draw Symbols”) and
at least one set of n symbols that are placed at a game play area,
the game play area containing a number of placement positions sufficient for most or all of the symbols in the range of n symbols to each be uniquely placed on or in a placement position (the “Game Play Area Symbols”) and
where the order of random draw of the Draw Symbols are used to create or identify whether or not there are one or more links between two or more of the Game Play Area Symbols.

Preferably, some or all of the Game Play Area Symbols are placed on or in a placement position by way of a random process.

This invention may also broadly be said to consist in the parts, elements and features referred to or indicated in the specification of the application, individually or collectively, and any or all combinations of any two or more of the parts, elements or features, and where specific integers are mentioned herein which have known equivalents such equivalents are deemed to be incorporated herein as if individually set forth.

### Inventive Step

The invention allows for a method of scoring a Bingo type card by using the ranking of symbols (typically numbers) within the “card” matrix and so that links between adjacent sequentially ranked symbols can be identified within the matrix and the number of such links per card can be counted. This scoring method can be used to play a Bingo style game with prizes. By having a fixed number of symbols per card the game can terminate when all symbols have been ranked—allowing a defined cut off for each game, and the ability to allow significant prizes based on the odds of a large number of links occurring on a card.

### Advantages of Preferred Matrix:

One of the advantages of the layouts described in the preferred embodiments is that by using a matrix of 5×5 symbols, and having the matrix fully populated with all of the 25 symbols, regardless of how many “cards” or matrices are displayed, each symbol in the matrix has between 3 and 8 adjoining neighbouring symbols. A corner symbol has the least number of adjoining neighbours, whilst a symbol in or near the centre of the matrix has the most neighbours and hence a greater chance of being part of a link between adjacent sequentially ranked symbols.

It is also possible to determine the odds of one card having any particular number of links—noting that 2-links are the most common and 5-links are the least common. The 5×5 matrix populated with 25 symbols has been found to be the most effective and practical layout for playing this game of chance. Please refer to the tables of odds based on a 82.958 Billion card run (running simulations is the only known way at present of determining the odds given the large number of possible layouts of 25 symbols in a 5×5 matrix, and the various permutations of links which are possible depending upon each card layout.

Although it is possible to play the game without the matrix being fully populated with symbols (typically where m>n), it will be appreciated that having gaps in a matrix and the location of those gaps will reduce the chance of obtaining a link between sequentially ranked symbols, and the location of the gaps will influence the outcome (a gap in a corner cell is less damaging than a gap in or near the centre of the matrix).

Whatever method of ranking the symbols is used, it is of course highly desirable that the participants who are playing the game, whether on a single card draw, or a large number of people playing using the same draw (ranking sequence), that the participant or participants cannot predict the outcome. The most practical way of achieving this unpredictable ranking is to use some form of randomness in the process of ranking the symbols, typically a random number generator, or some real-world measurement of a truly random phenomena, so that there is no way that a participant can accurately predict the eventual sequence of numbers or symbols, so they cannot choose or rearrange their layout of symbols in such a way as to successfully predict the outcome of the game. In other words, the game, using some form of ranking of the symbols and looking for adjacent sequentially ranked symbol is a game of chance.

In some of the examples, particularly where a set of scratch cards is produced, it may be desirable to use a non-random system when printing the cards so that only a very small number of winning cards are printed, and this may be a logical printing sequence. However once the ranked matrix on the lower layer of the scratch cards is overprinted with a “scratch-off” opaque player, it will not be possible for players to determine which if any of the cards have a winning layout. In this case the distribution of the cards across many different retail outlets, without any apparent knowledge of the contents of the cards will in itself create the necessary degree of uncertainty, which will allow scratch cards to be used in such a way that the game becomes a game of chance, as the players will not be in a position to determine the underlying ranking applied to the card they purchase.

### BRIEF DESCRIPTION OF THE DRAWINGS

These and other aspects of the inventions, which will be considered in all their novel aspects, will become apparent from the following descriptions, which are given by the way of examples only, with reference to the accompanying drawings in which:

FIG. 1 shows one embodiment of a blank matrix card for use in a game of the present invention—in this case a 25 square card in a 5×5 configuration.

FIG. 2 shows an example of a completed matrix card of FIG. 1, for use in a game according to the present invention, and the matrix card is ready to play (ready for the game draw).

FIG. 3-6 shows a process of the n numbers (in this case 25 numbers from 1-25) being randomly drawn and the corresponding number on the matrix card being converted to its ordinal ranking according to one aspect of the present invention.

FIG. 3 shows the first 10 numbers drawn,

FIG. 4 shows the first 10 numbers on the matrix card being converted to their corresponding ordinal ranking as determined by the order of the first 10 drawn numbers,

FIG. 5 shows the random draw of 25 numbers, and

FIG. 6 shows a variation in the display with all 25 numbers on the matrix card having been modified to include their corresponding ordinal ranking as determined by the order of the separate but associated random draw of 25 numbers as shown in FIG. 5. In this display variation the original symbols appear in top left quadrant of each cell and the ordinal ranking is in larger font in the centre of each cell. In this example, the game results in 3 links: 2×2 Links; and 1×5 Links. A single “5-link” is equivalent to 4×“2 links” (if broken down into its constituent parts).

FIGS. 4 and 6 also demonstrate the linking process.

FIG. 7 shows the patterns that need to be linked in order to win prizes according to one aspect of the present invention.

FIGS. 8-11 show one preferred embodiment of the invention where pre-printed cards and tokens are used. These tokens represent ordinal rankings determined from the numbers drawn in the random draw.

FIG. 8 shows the tokens being stacked in an ordinal placing order prior to draw, stacked from 1^{st} to 25^{th}.

FIG. 9 shows the 4^{th} token, representing the 4^{th} drawn number (number 25) where the number 25 on the 5×5 matrix card is about to be converted to 4^{th} by placing the 4^{th} token onto the square containing the number 25.

FIGS. 10 (a) and 10 (b) shows a situation, where a player/participant recognises two instances of 2 Links being achieved and flips Tokens 8^{th}, 9th & 10th over to reveal an alternate colour (showing 10th Token before and after the player flips to the alternate side).

FIG. 11 shows a draw that is complete with 5 Links: 4×2 Links, and 1×5 Link.

FIGS. 12 a to 12 d are pages 1, 2, 3 and 4 respectively of a form of a marketing literature or pamphlet that can be distributed to the public in order to explain the game.

FIG. 13 shows the coordinates in a 5×5 matrix.

FIG. 14 shows a view of part of a card during the draw, with the option for the player to shuffle the position of two numbers that have not yet been drawn in the hope of gaining an advantage.

FIGS. 15A, B, C and D shows a three card game, with each card having 25 numbers from a unique range of numbers: card 1 has numbers from the range of 1-25; card 2 has numbers from the range of 26-50; and card 3 has numbers from the range of 51-75. A random draw of 75 numbers, numbered from 1-75, then operates in this example to be used to govern the outcome of the game, according to the rules set.

FIG. 16 shows a Quick Response (QR) code containing, or which can contain: (a) the 25 ticket or card numbers (there are 25 of them on the 5×5 matrix). These numbers are ordered in a 25 number sequence based on the position of each number on the 5×5 matrix; (b) a unique game ID; (c) the draw information or winning link information, and (d) the date and time of the draw in a common time reference to allow for a draw to take place simultaneously in several different time zones.

FIGS. 16A, B, and C show different stages in the creation of a scratch and win card embodying one variant of this invention.

FIG. 17A-Z and AA show some examples of the different cards with various different matrices which can be used to play the present game.

FIG. 18A-D show variation to the ranking of entries by references to the links achieved, the variation being different to that set out in Example 1.4-1.7, and specifically referenced in Example 1.7.

FIGS. 19A-E show a gaming console which can read the QR code of the scratch card of FIGS. 16A-C, and play the game on the console.

FIGS. 20A to 23A show different scratch cards

FIGS. 20B to 23B show the different rankings applied to the cards, each ranking being a one-off ranking for that card.

FIGS. 20C to 23C show the cards of 20A to 23A with the relevant rankings 20B to 23B applied to the cards to show the resulting links.

FIGS. 24A to 24H shows a gaming machine connected to the internet and the sequence of operations in playing a “card” displayed on the VDU of the gaming machine, with FIG. 24E showing an expanded view of the stack of virtual tokens and the ranking applied to the virtual card displayed on the VDU.

FIG. 25 shows a slot machine displaying 4 cards on its VDU part way through a game as the 10^{th} ranked number is chosen and 4 virtual tokens, each labelled 10^{th} are shown moving from the stacks towards the symbol 4 on each card.

FIG. 26 shows 3 such slot machines connected via a local area network to a game server.

FIG. 27 shows the modules of a gaming machine and a flow chart of its interaction with remote server(s).

FIG. 28 shows a schematic diagram of 5 such gaming machines connected to remote server(s).

FIG. 29A shows a desk type VDU configured as a desk with a tray to one side. The VDU shows a display of 4 cards with a red X highlighted on each card at the start of a game.

FIG. 29B shows the same VDU as in FIG. 29A at the end of play showing that the X pattern has disappeared, rankings of each symbol have been inserted and links between adjacent sequentially ranked symbols have been highlighted.

### DESCRIPTION OF THE PREFERRED EMBODIMENT(S)

The following will describe the invention in relation to preferred embodiments/examples of the invention, namely a game, and a system and method for playing the game. The invention is in no way limited to these preferred embodiments/examples as they are purely to exemplify the invention only and that possible variations and modifications would be readily apparent without departing from the scope of the invention.

The game of the present invention will hereinafter be referred to as Link2Win™ game and a Game Play Area(s) in a form of a matrix card or board will hereinafter be referred to as Link2Win™ card(s) or Link2Win™ card(s) or simply as “card” or “cards” whether on printed cards or on display screens of suitable visual display units such as gaming terminals. Both types of games will be described, all games involve the use of cards, although some games can be single play games.

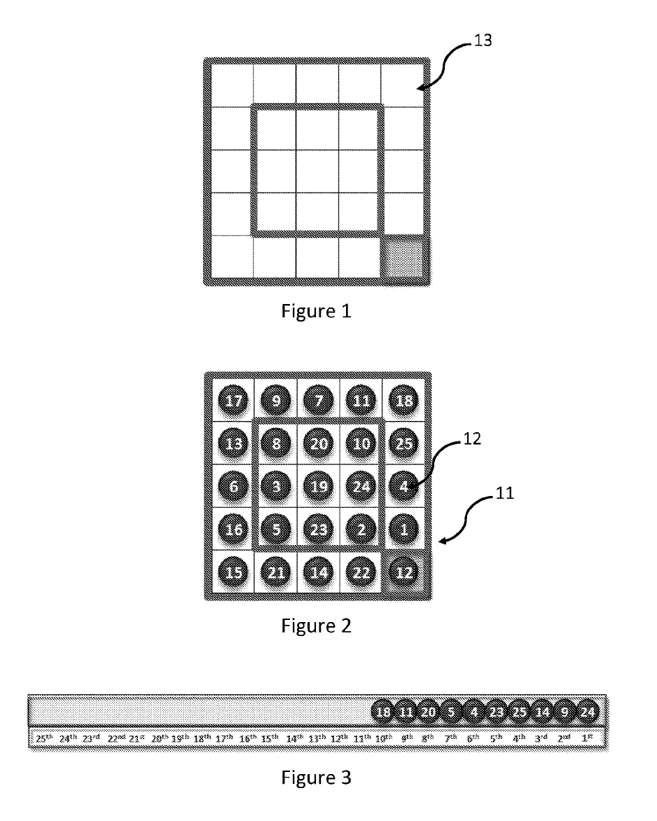

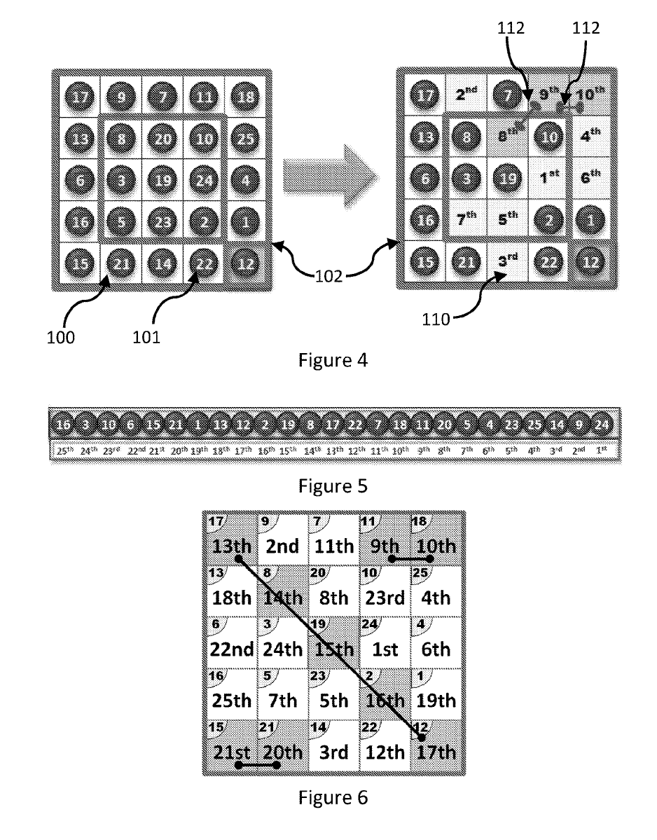

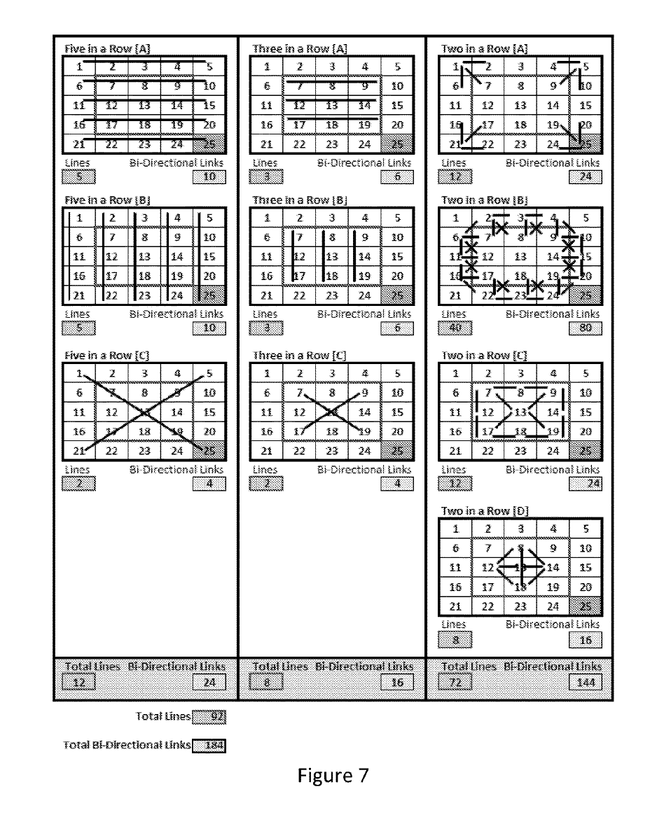

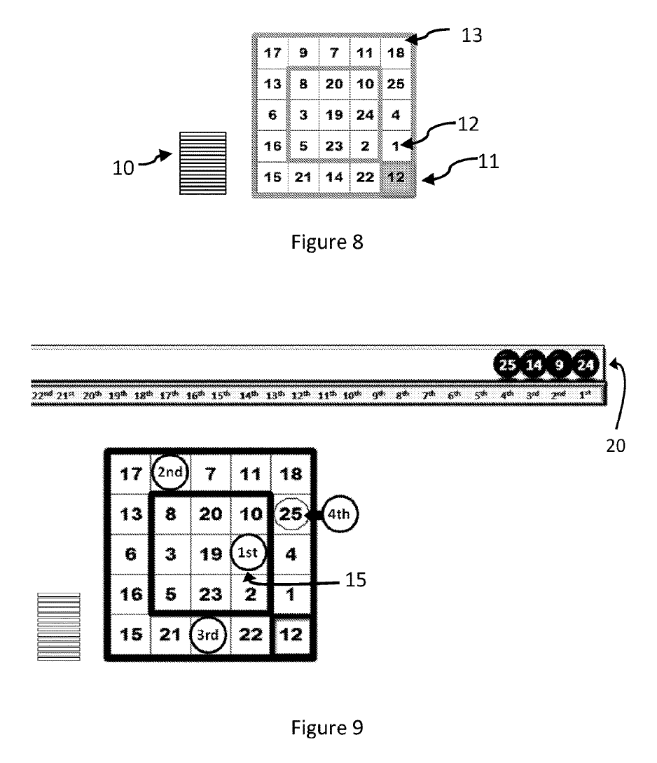

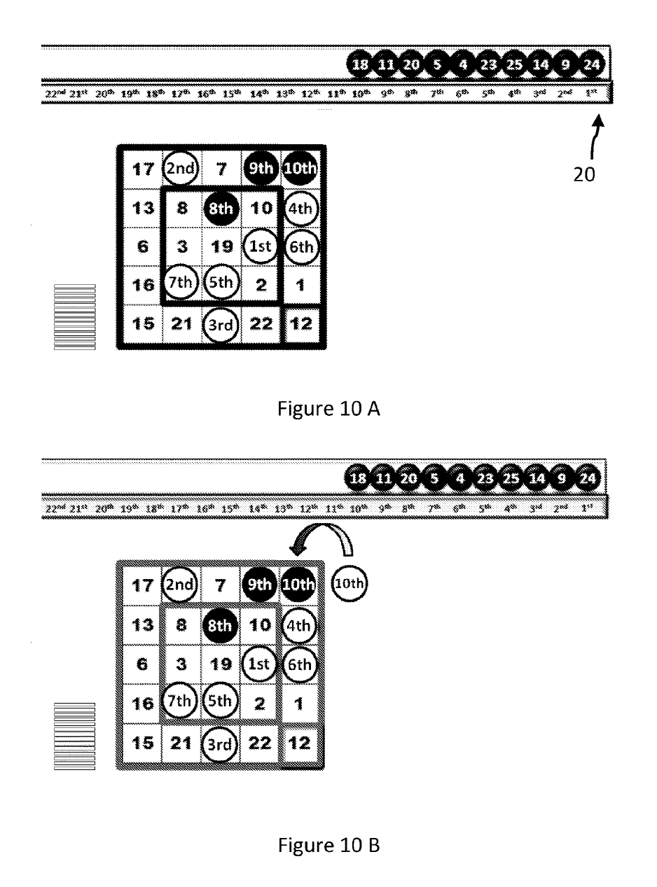

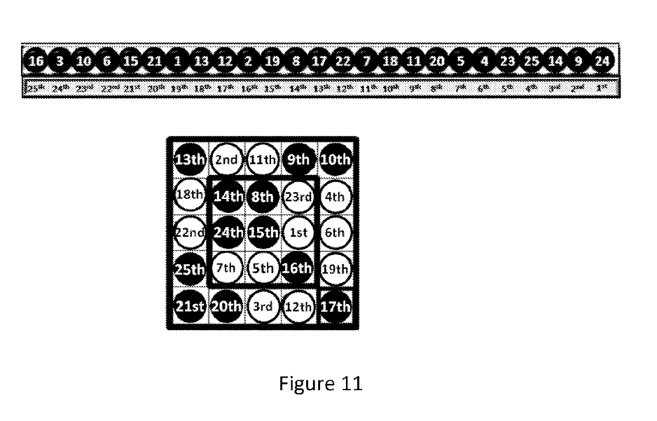

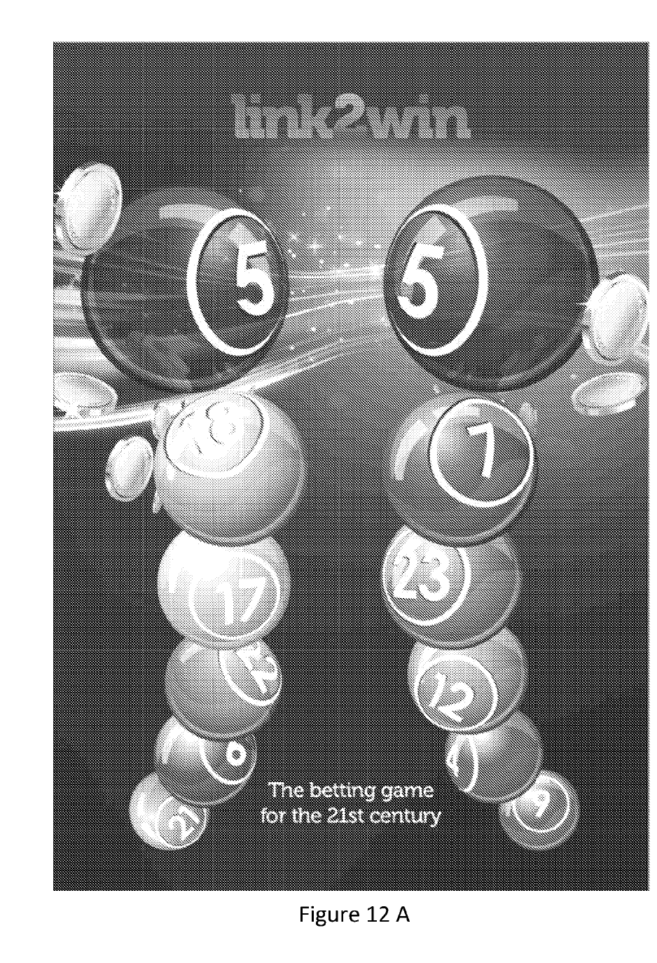

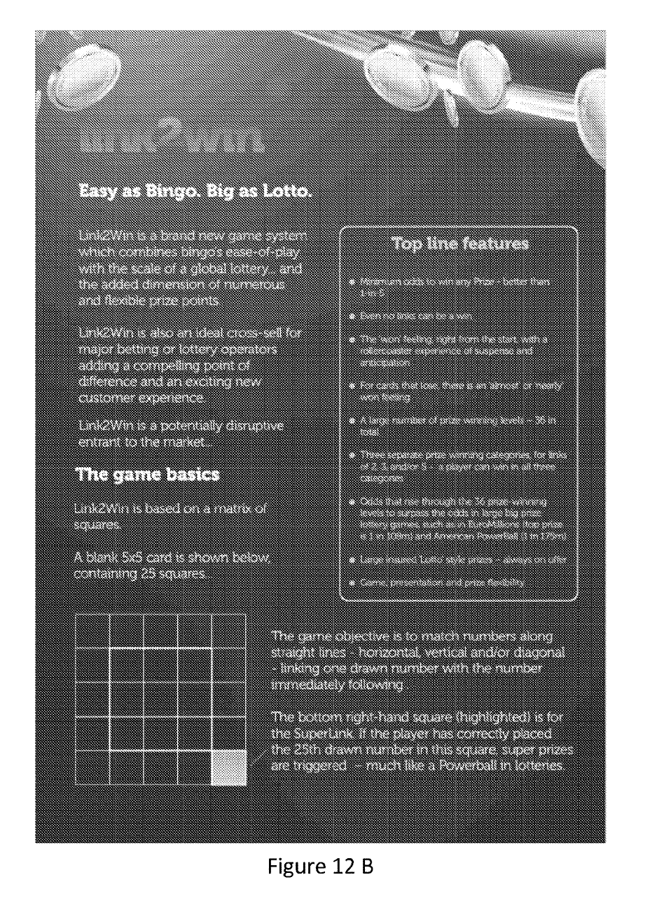

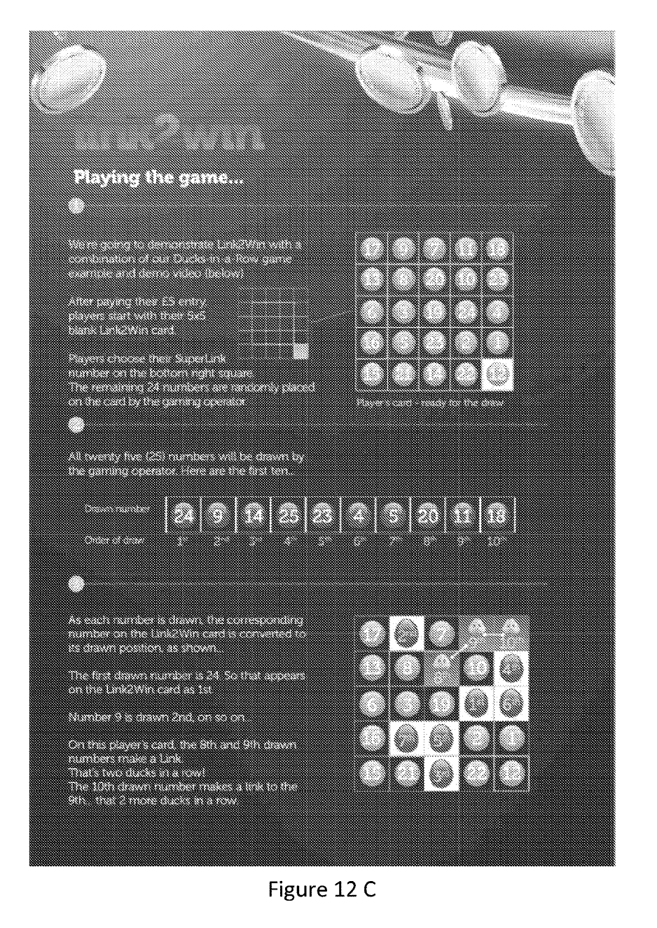

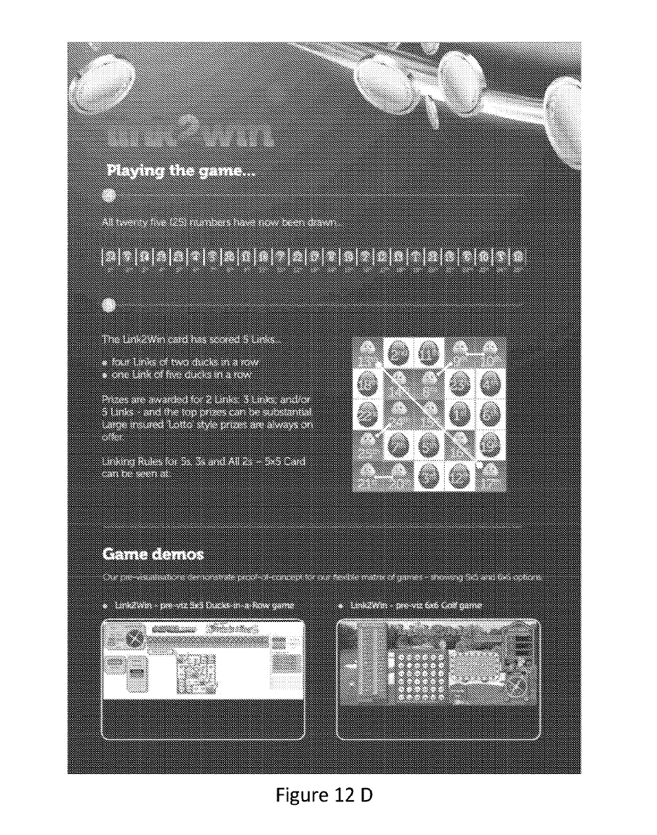

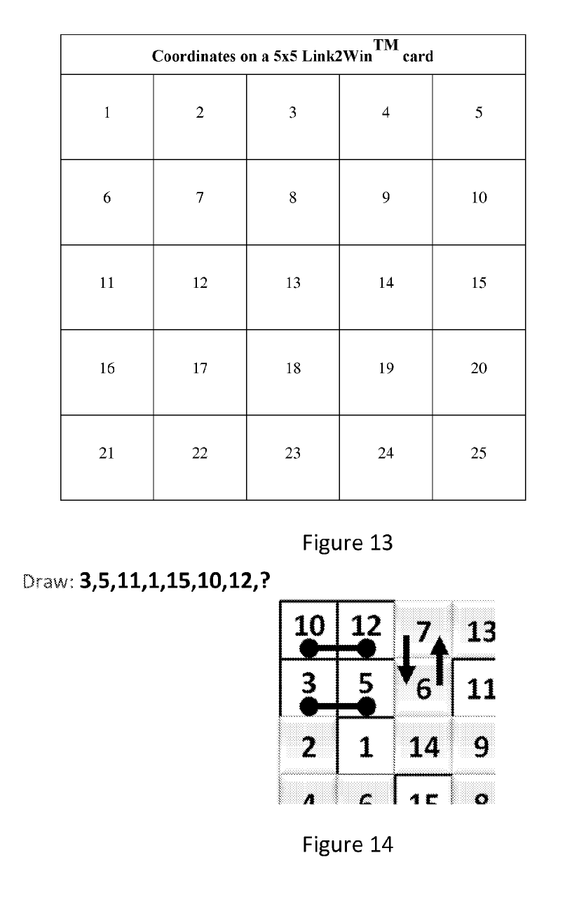

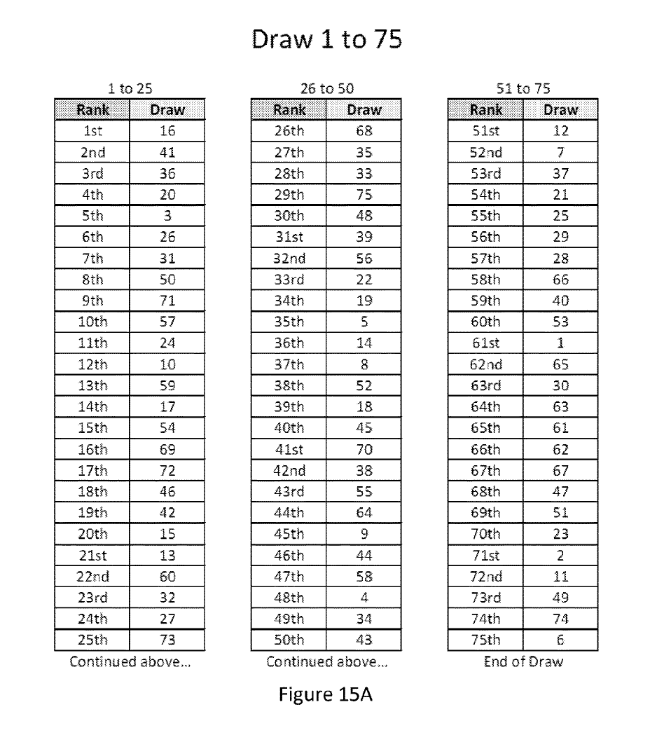

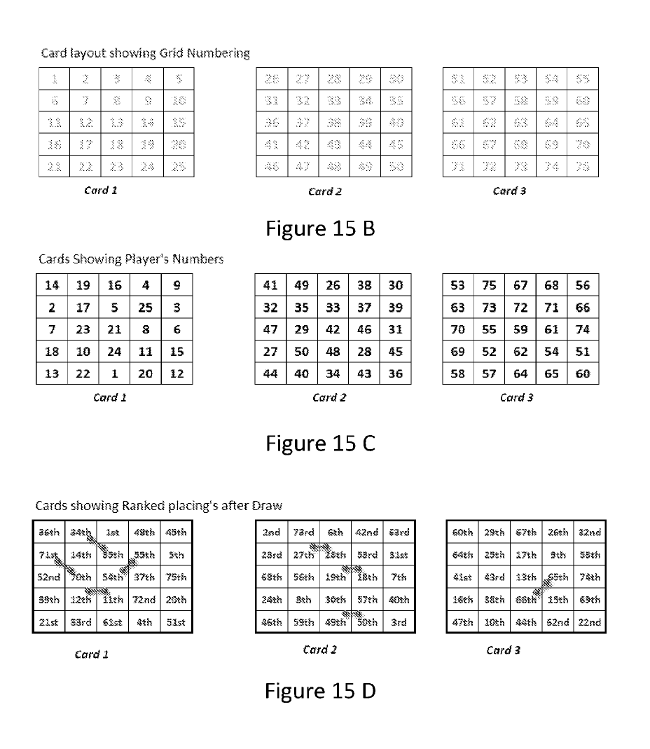

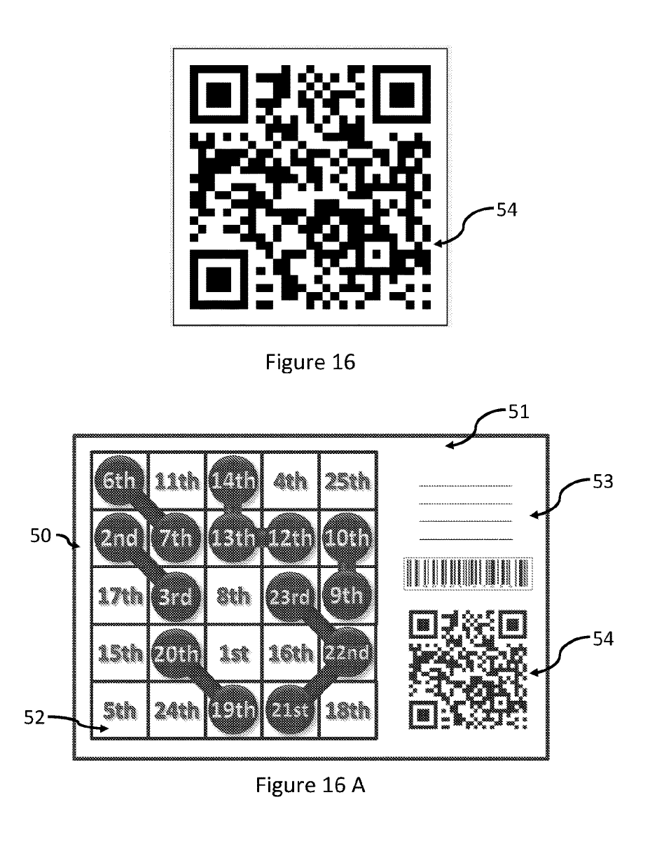

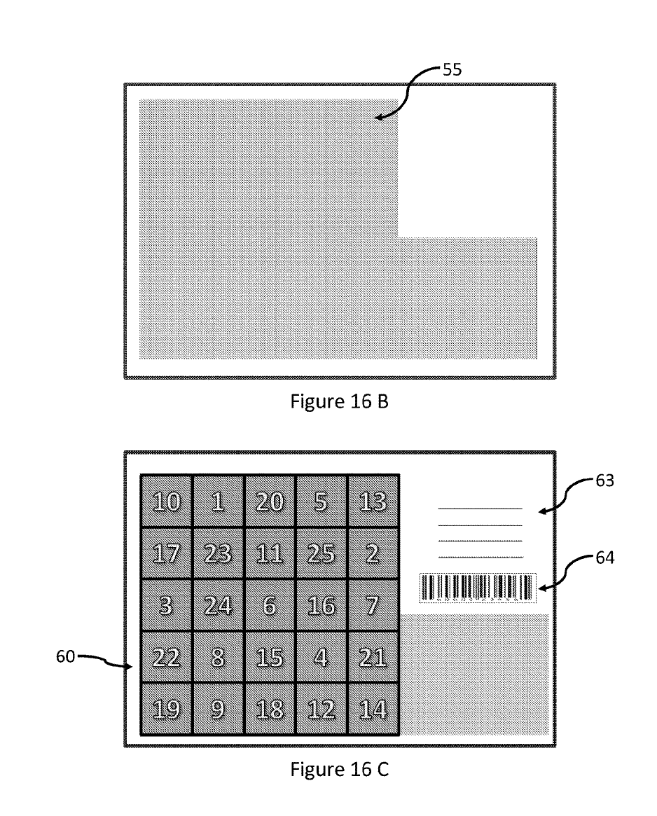

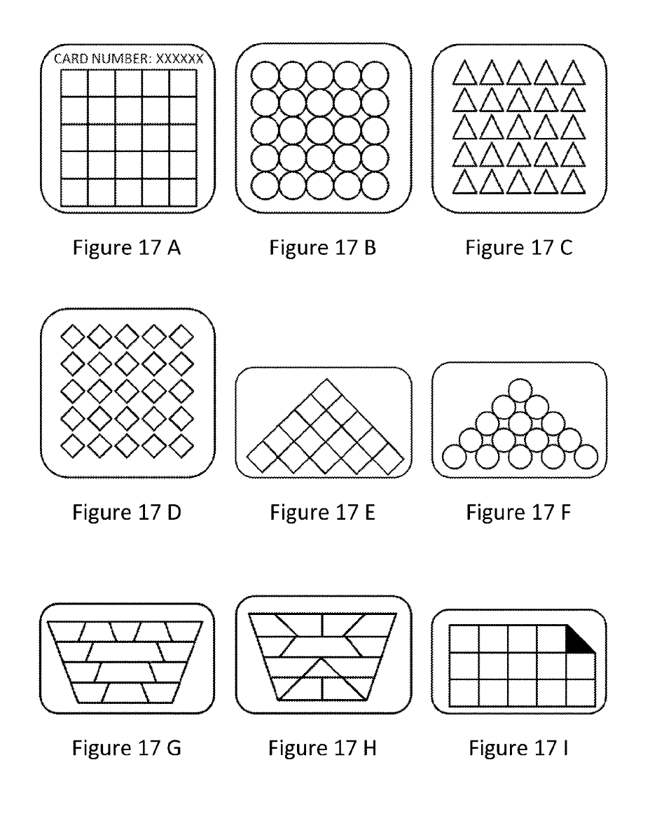

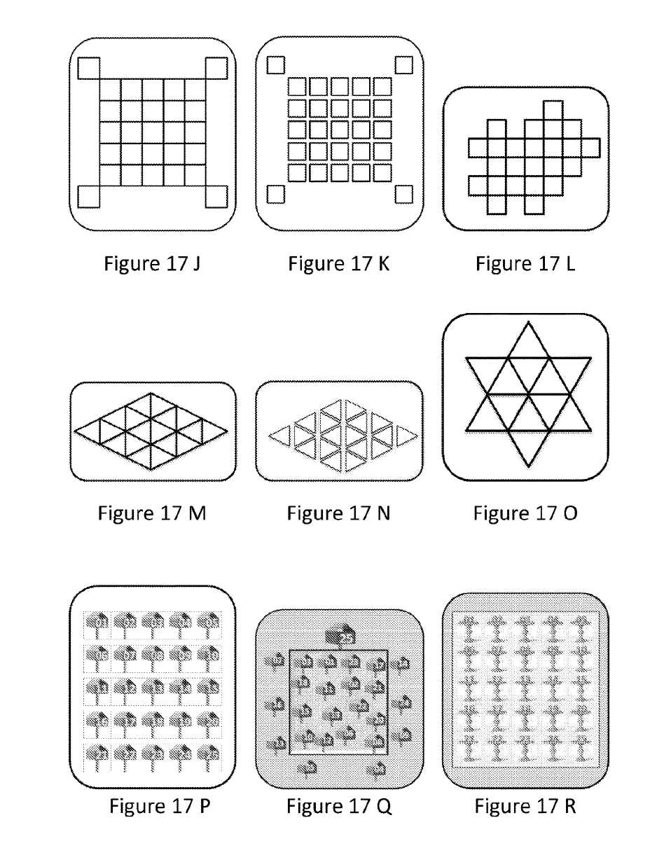

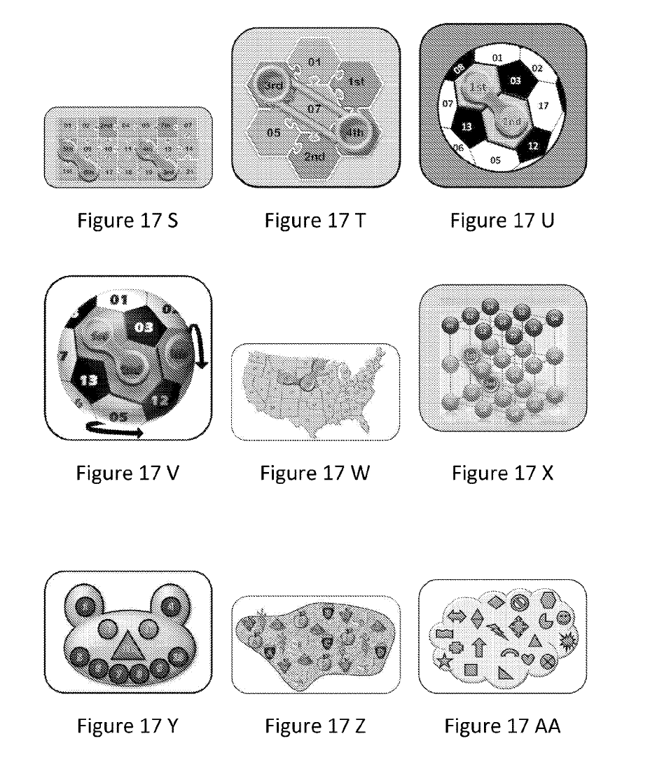

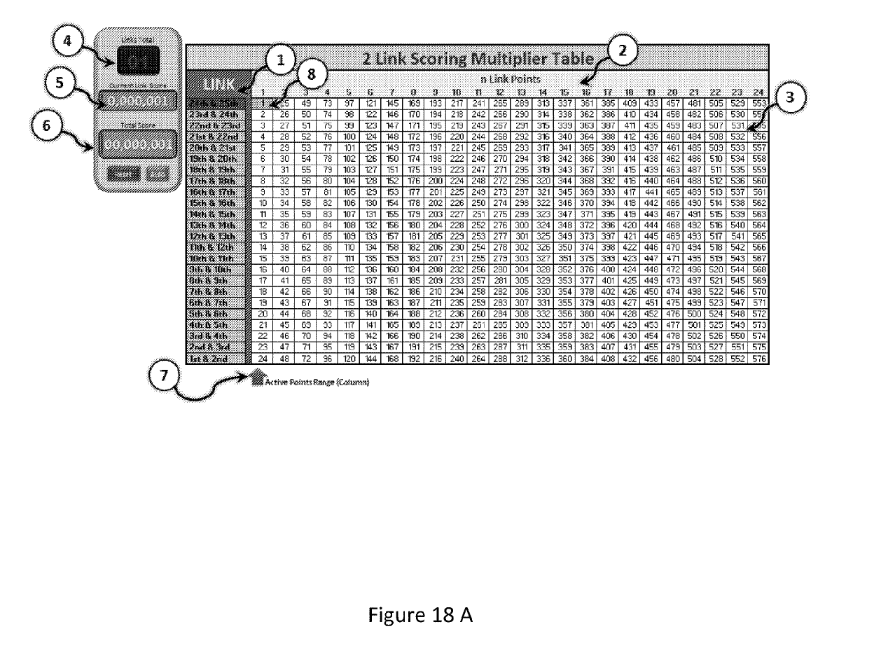

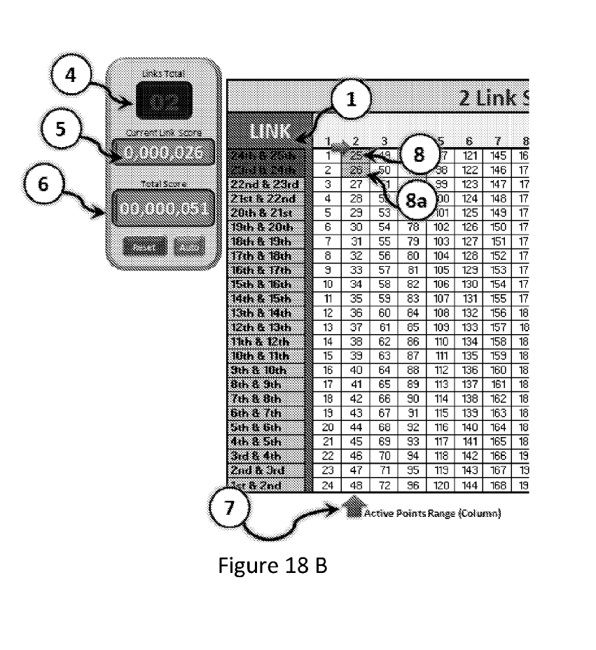

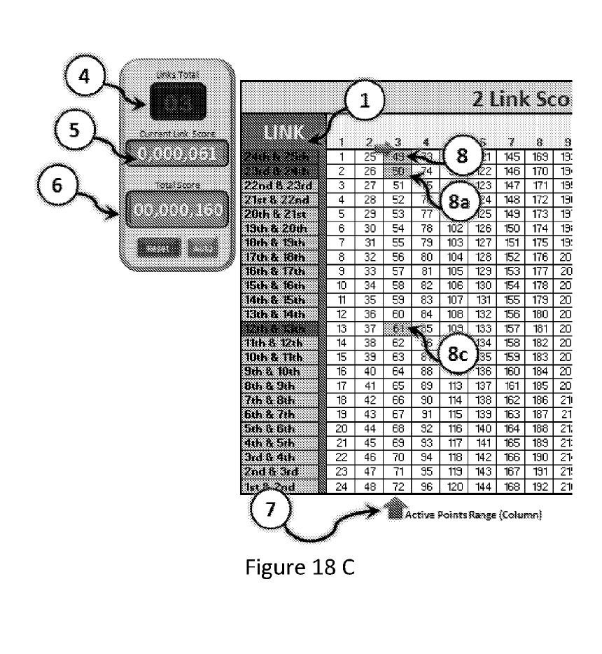

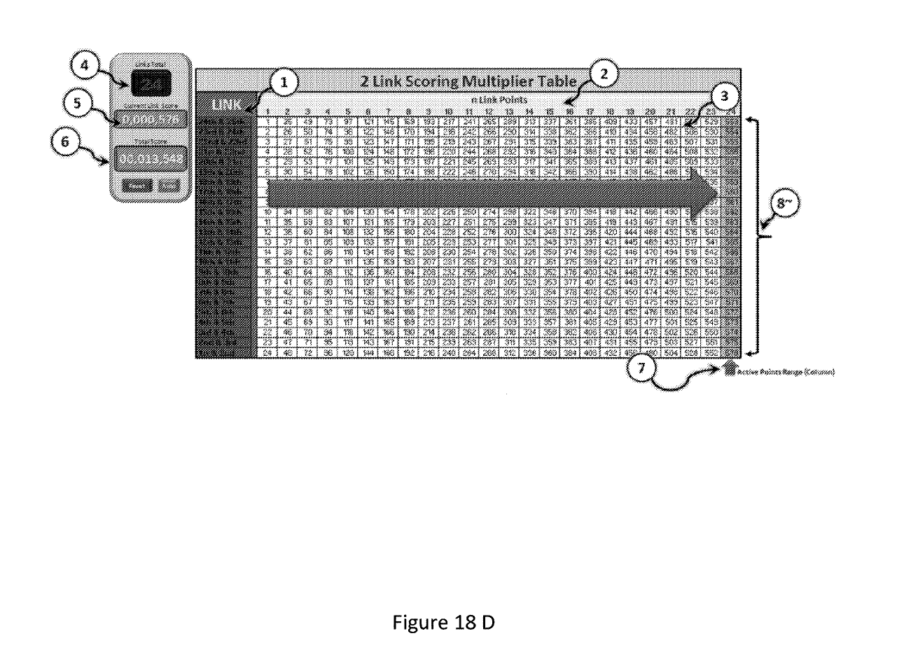

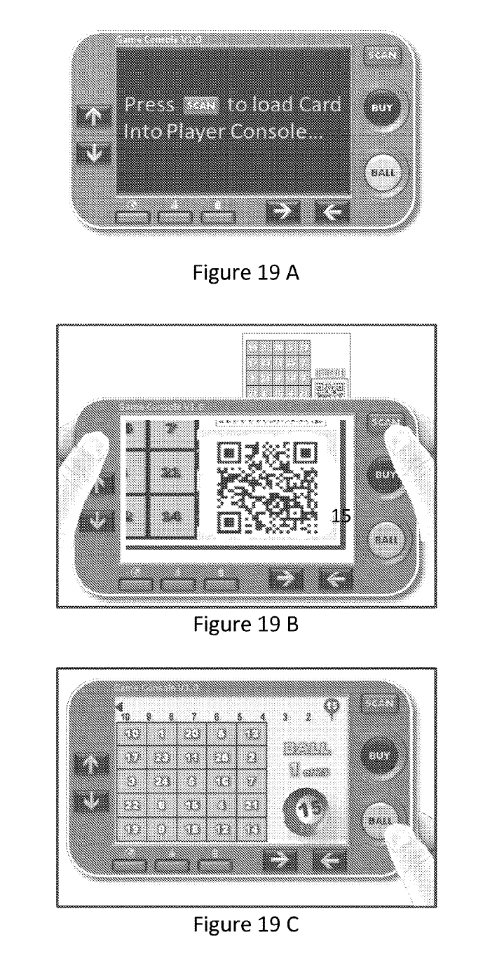

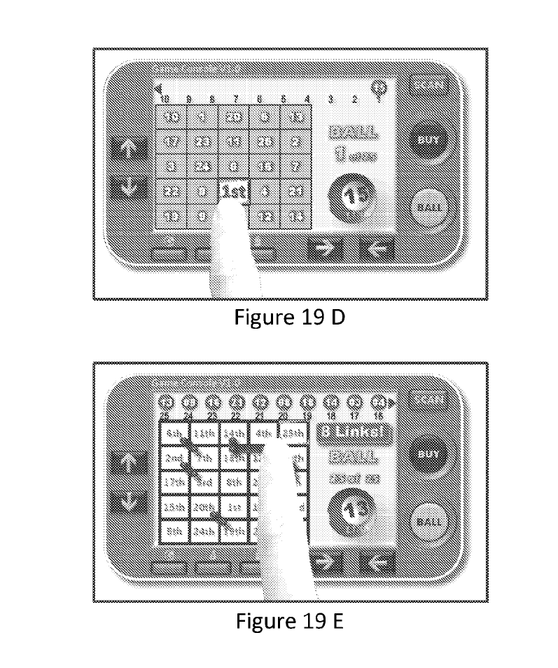

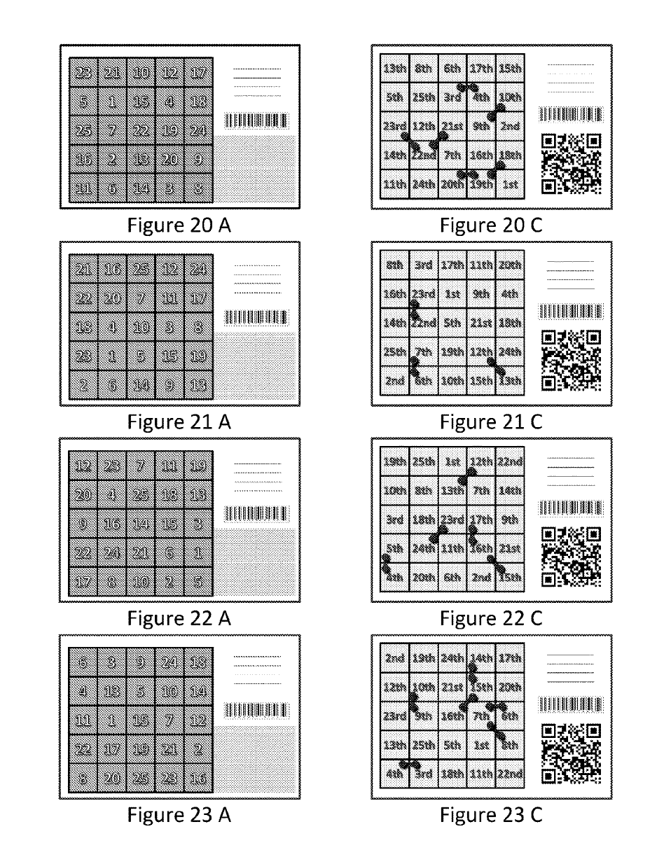

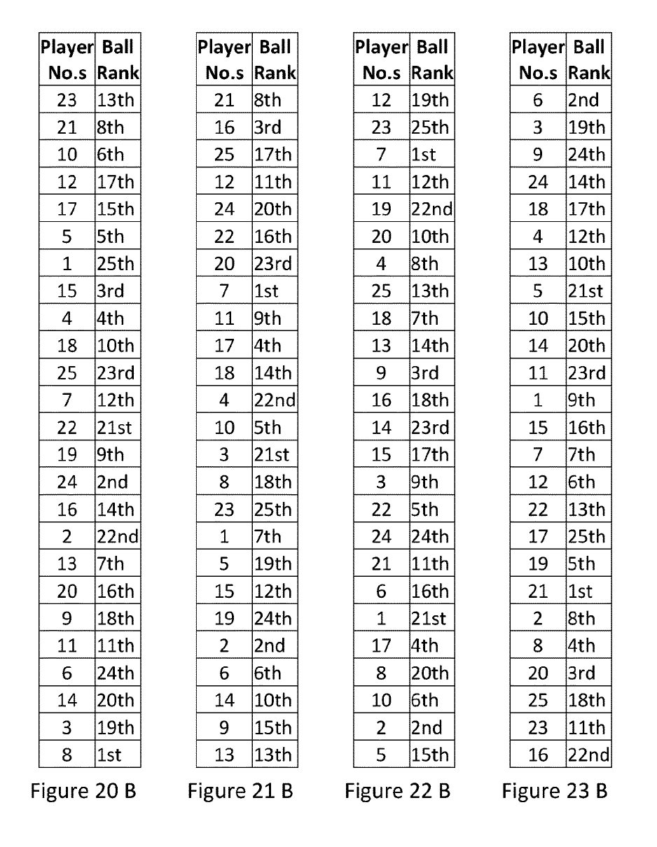

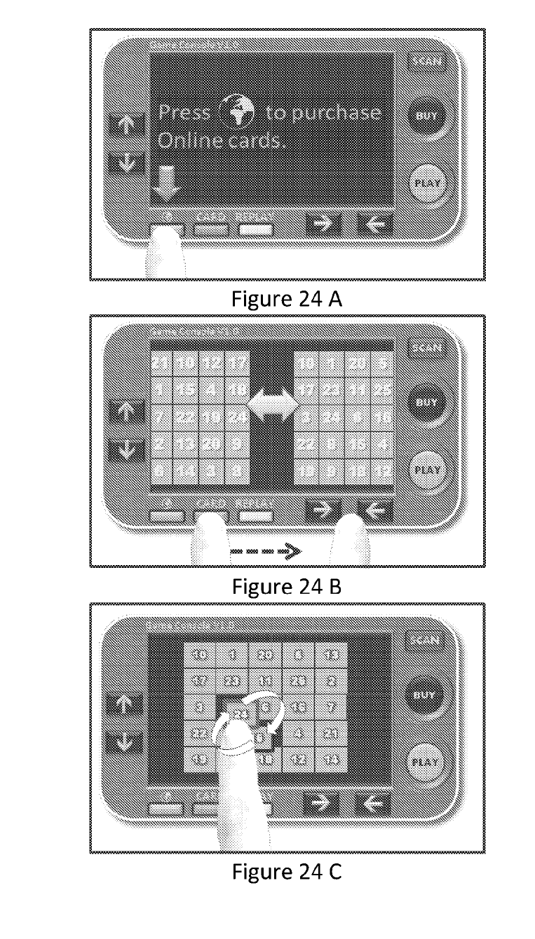

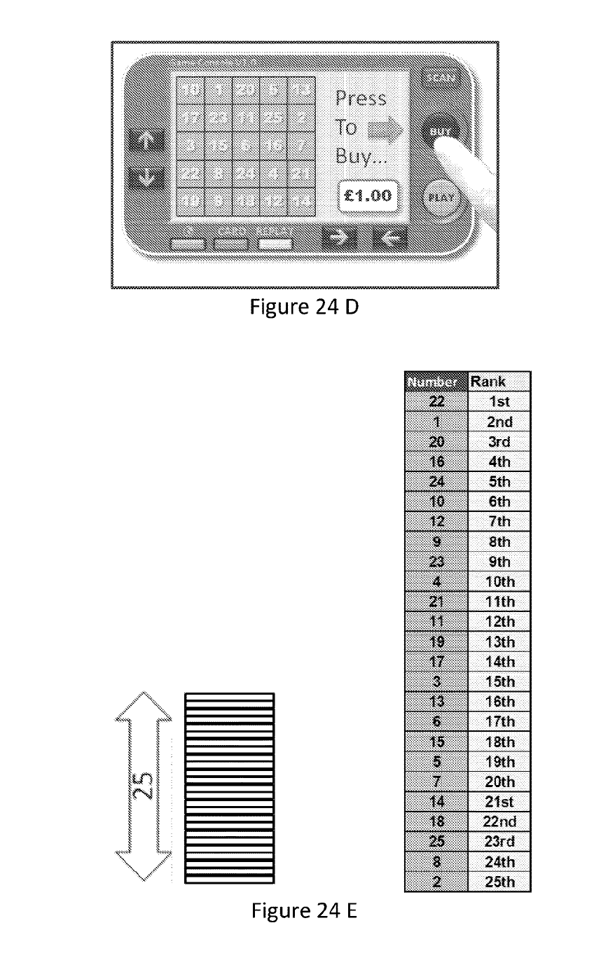

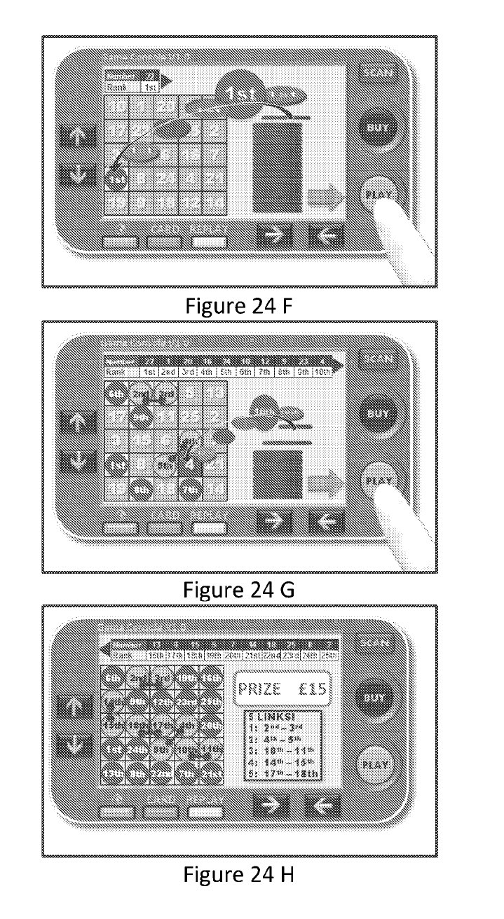

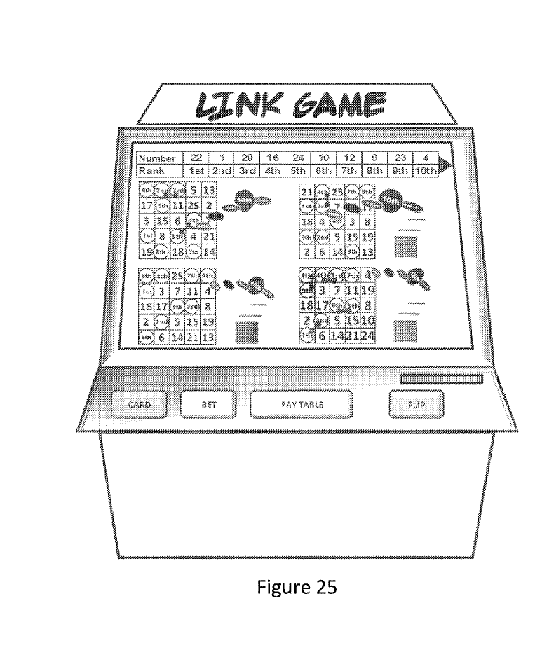

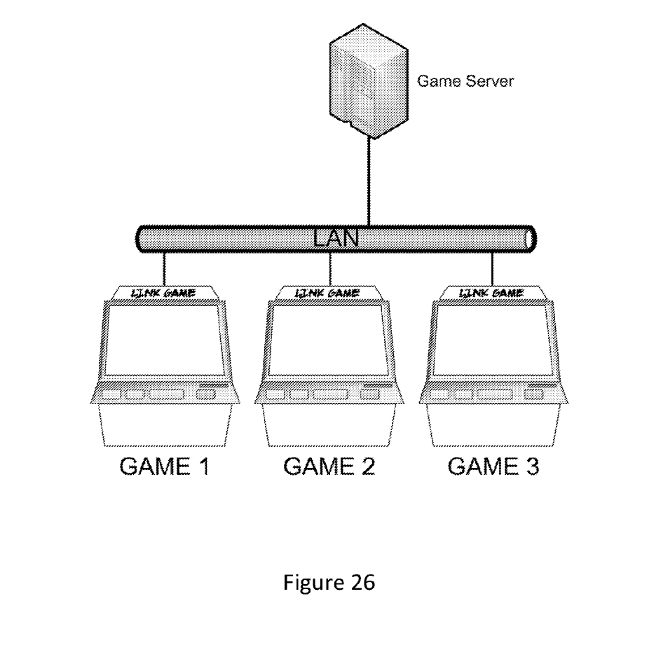

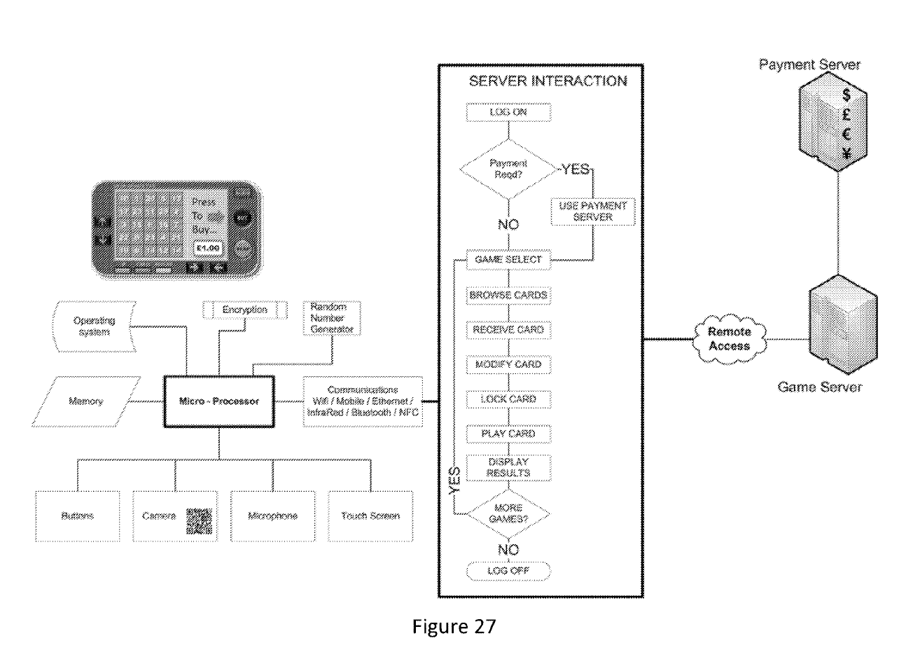

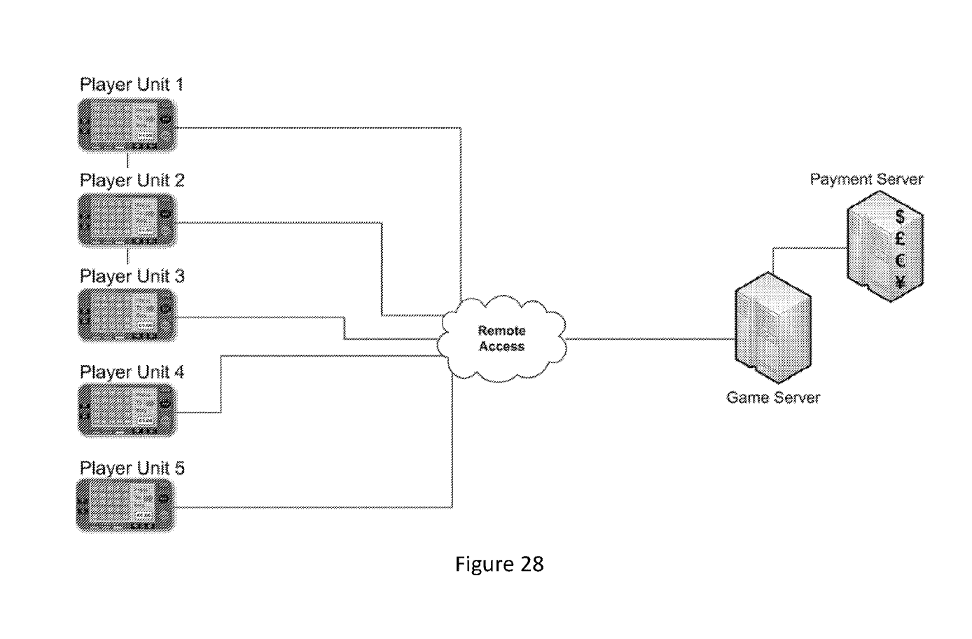

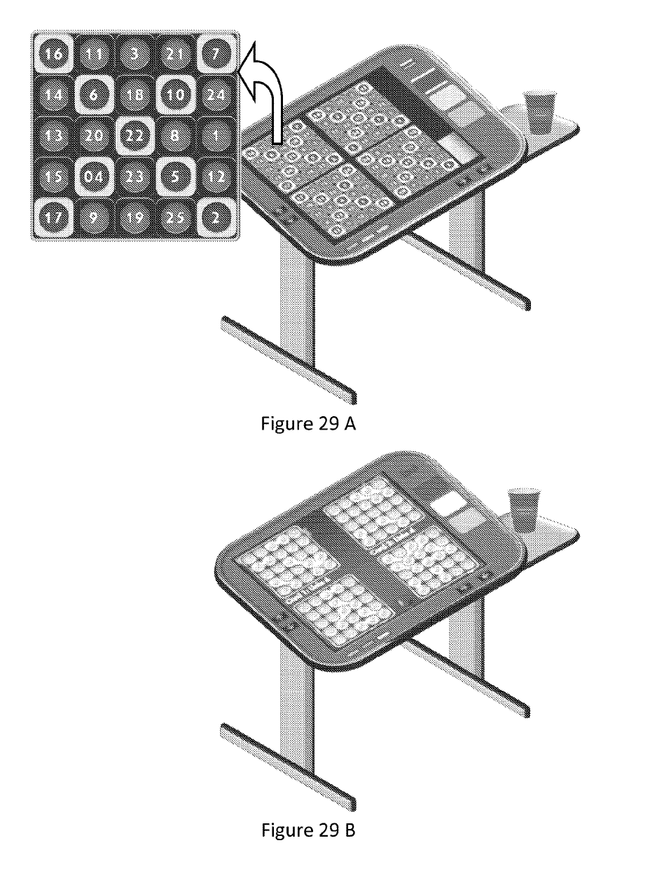

FIG. 1 shows a blank Link2Win™ card, and it is a 5×5 card, containing 25 squares. The players have 25 numbers (1-25). These numbers are placed by the player on the Link2Win™ card, one number per square (or randomly placed by the gaming Operator). An example of a completed Link2Win™ card ready to play (ready for the game draw) is shown in FIG. 2. A skilled person will appreciate that a Link2Win™ card can be either a printed (hard copy) card or can be transient imagery that is displayed during the course of a game on the screen of a Visual Display Unit of a device such as terminal (either smart or dumb), special purpose gaming machines or Casino machines, personal computers (PCs), tablets or smart phones and the like.

The objective in this example of the game is to match patterns on the cards. In the examples the patterns are defined as straight lines, being horizontal, vertical and/or diagonal, as set out in FIG. 7. This is achieved by creating Links. (Straight lines are easier to see where the matrix is rectangular, though curved linkages are a possibility with other patterns of cells).

Links are formed by a number on the Link2Win™ card being linked to an adjacent number on the card, with this linking being determined by rules set around an associated ranking (typically by way of a random draw) of a set of 25 numbers, in this case the rule is that numbers are linked by the immediate following ranked number, in a ranking of the set of 25 numbers, and so on. This is set out in FIGS. 3 and 4, and FIGS. 5 and 6. Prizes and lottery costs are given by way of example to illustrate odds involved. The games can be played for real money in countries where lotteries are legal, or can be played for virtual money or scored where gambling is not permitted. The use of monetary symbols such as the £ or $ signs is purely illustrative.

### EXAMPLES

| | |
|---|---|
| Example 1A | 5 × 5 Matrix Game - 5 × 2 Links with £Nil prizes |
| Example 2 | 5 × 5 Matrix Game - 1 × 2 Link with £Nil prizes |
| Example 3 | Link2Win ™ for State Lotteries - Pooled Games |
| Example 4 | Link2Win ™ for State Lotteries - Single Play Games |
| Example 5 | Link2Win ™ for State Lotteries - Instant Link2Win ™ |
| | Scratch Card Application and having Console |
| Example 6 | Multiple Concurrent Games |
| Example 7 | Terminal displaying Virtual Cards and Virtual Tokens |
| Example 8 | Player Interaction - Rejecting Drawn Numbers |
| Example 9 | Player Interaction - Relocating or Shuffling Numbers |
| Example 10 | Player Interaction - Competition involving a Pool of Players |
| Example 11 | Player Interaction - Competition involving a Player |
| | competing against a computer |
| Example 12 | Variations - 2 Link Prize Profile |
| Example 13 | Killer Squares |
| Example 14 | Side Bets |
| Example 15 | Hand held Online Gaming Console |
| Example 16 | Market Literature |
| Example 17 | Casino Machines |
| Example 18 | Online Gaming Machines |
| Example 19 | VDU Desks for Bingo Halls |

By “layout” of the symbols we mean that the location of some or all of the symbols may differ from card to card. In some cases a particular symbol may appear at the same cell location on more than one card but the totality of symbol locations making up the layout will in most cases be different throughout the set of cards as there is a very large number of permutations of potential card layouts where 25 symbols are located in a 5×5 matrix of cells.

If all possible card layouts are used then the total number of permutations allows for in excess of 1 trillion. We have calculated this number of permutations to be 1.93890×10²⁴ unique layouts (refer Example 1.12—Technology) without including the further possibility of KILLER SQUARES or SUPERLINKS (described elsewhere in this specification).

In most cases sets of cards will be generated by some form of random or pseudo random process allocating the cell numbers to the cells in the matrix, however this is not essential. For example, the cards may optionally be systematically created so that each card within a set is unique (it will be noted that this does not involve the random creation of layouts, though the delivery of one of these many cards to a player may well be a random selection).

From the player's perspective it is whether they perceive their card layout to be different from the other players' cards that matters, not whether the card layout was the result of a random process. Indeed many players may prefer to play each game with their own choice of layout of the cell symbols. In some examples we describe how the players can move their symbols on their card layouts before “locking it in” prior to the start of the game. In the case of pre-printed cards for use in a “Bingo Hall” the players could be given the opportunity to custom print their own layouts prior to the start of a game.

### Example 1.0—Set of Bingo-Type Cards

FIGS. 8-11 show a preferred form of design of the 25 tokens 10 for use with pre-printed bingo cards 11 of the present invention. The cards and tokens are designed for group of players playing “Bingo” or “Housie” in a Bingo Hall, where the players are allocated one or more cards and numbers are called out, or displayed on screen, or both, as they are selected.

The promoter of the Bingo Game will supply (1) a set of pre-printed cards labelled 11 in FIG. 8, (2) a set of tokens 10 for each card to be played, (3) a number selection process, and (4) a caller and/or visual presentation of numbers drawn.

Each card 11 is a matrix of pre-printed numbers or symbols, typically in a 5×5 matrix. The matrix is made up of 25 cells labelled 13 in FIG. 8, and each cell contains a cell number labelled 12 in FIG. 8, typically in a random or pseudorandom configuration, so that each card has or is likely to have a unique “geographic arrangement” of the cell numbers 12 within the 5×5 matrix. In this example we refer to the numbers (symbols) 1-25 (as bingo players are used to listening to the numbers being called out by the caller and to matching the “numbers drawn” to the “cell numbers”, i.e. the location of the corresponding numbers 12 on their cards).

We will use “cell number” for the numbers printed on the card, “token number” for the ranking numbers on the tokens, and “drawn number” for each number as it is called out.

Each player is provided with a set of tokens 10 for each card 11 played, the number of tokens per card matching number of cells being played on the matrix. With a 5×5 a player will have a set of 25 tokens 10 ranked from 1 to 25. Each token 10 is of a size and shape to fit within the confines of a cell and cover the cell number.

Each of the tokens 1 to 25 is double sided and of the same label, but with a different colour on opposite faces of the token. In this example, the tokens 1 to 25 have a label on both sides with the same ranking/placing text. For example token one 15, will be labelled “first” on both sides—with one side showing red and the other side showing black. We prefer to use the red/black as background colours with the label (i.e. sequence number appearing in white as shown in FIG. 11). The subsequent tokens would have the same colour scheme (in this set all tokens would have one red side and one black side) but be labelled with each subsequent sequence number, e.g. 2nd, 3rd, 4th, 5th . . . 25th. Ideally the tokens would be supplied to each player stacked in sequence order prior to game start—see FIG. 8. Otherwise players would be advised to place their tokens in sequence order for ease of access during play.

Typically the caller would supervise the selection of the numbers to be drawn during the course of the game. Whatever processes is adopted, it should reassure the players that the selection is random or pseudorandom. It could be as simple as selecting numbers from a container such as a hat, but in its most preferred form makes use of a sorting drum in which 25 separately numbered balls are tumbled during rotation of the drum and then guided into a chute so that they can be read one at a time by the caller. Alternatively an electronic random number generator could be used to select the numbers in a random or pseudo-random sequence.

The caller would then identify each drawer number with its ranking, e.g. number 24 is ranked first, number 9 is ranked 2^{nd}, number 14 is ranked 3^{rd} (and so on) see for example FIGS. 8 and 9 which show the start of a game and the first numbers selected in selection order in the chute (FIG. 9). The completed section is shown in the full chute at the top of FIG. 11.

As a numbers are drawn and announced and/or displayed visually, each player can place the corresponding token that represents the ranking (or sequence number) of that particular drawn number on the relevant card. As each player will have a card containing all 25 numbers, each player will need to collect the appropriate ranking token each time a number is drawn. The only difference is that when for example the number two is drawn as save the 18th ranked number, the location of that cell number two on each card is likely to be in a different location, given that there are 25 different locations on the card with a number to may have been printed. For example the festival number we covered with the “first” token. The second call number will be covered with the “second” token and so on until tokens have been used—see FIG. 9.

The tokens would initially be placed with the same coloured side showing (e.g. all of the tokens we placed with the red side uppermost). As players study their cards they are likely to see that some adjoining tokens have adjoining rankings, so that if a player sees that two adjoining tokens are ranked 8^{th} and 9th he will realise that he has “two in a row” and at this point he or she can flip over the 8^{th} and 9^{th} tokens to display that the 8th and 9th ranked tokens adjoin one another. The contrasting colour will then make it easier for the links to “stand out” as in FIGS. 10B and 11. Hopefully that player can find three in a row, i.e. three adjoining tokens having adjoining rankings and so on.

Players do not do this during the course of play may prefer to look for adjoining rankings at the end of play, before prizes are determined.

FIGS. 10A and 10B show some of the tokens flipped over to make the linkages visually distinct. Even though the same ranking text is displayed by the tokens the fact that some of the tokens have been flipped over enables the links to clearly stand out because of the contrasting colours.

The odds on finding links on a card is discussed elsewhere but in practice the black (contrasting colour) will stand out against the background of the remaining unlinked red tokens.

When the draw is complete all links can easily be identified. In the case of two links meeting (such as a three link and a two link being connected (appearing as four in a row) the organiser will need to apply the rules for determining prices. In the example just described there may be no four in a row link or prize allocation for that card.

In a simple form of the game, the player with the most links will identify themselves to the organiser and have their card checked.

To speed gameplay, and allow repetitive use of a set of printed cards, each card can be printed with its own unique ID, e.g. a human readable code, or more preferably a machine readable code such as a bar code, a QR code or the like. This enables the people checking a player's claim that their card is a winning card by inputting the unique ID of that card into a checking computer—this can easily be done by using a barcode scanner to read the barcode of that card. By saving the configuration of each card matrix in a checking computer, and linking it to its unique ID, the checking computer can quickly display the rankings of each cell number for that card and then compute the links to verify the accuracy of the players claim. In this version of the game, the checking computer need only check those cards were players have claimed that they have winning cards.

The immediately following examples describe cards displayed on at least one visual display unit (VDU), typically on hand held or mobile devices.

### Example 1.1-5×5 Matrix Game—5×2 Links with £Nil Prizes

### Exampled Game Profile

£5 entry per card
SUPERLINK is played by those players that correctly get the 25th drawn number (as the bottom right number in the Link2Win™ card—see example in FIG. 2), and
SUPERLINK is played by approximately 1/25th of all players, as there is a 1 in 25 chance of correctly choosing the SUPERLINK number.
For clarification: SUPERLINK operates to increase the prizes for 2 Links and 3 Links only.

### Example 1.2—The Random Game Draw

The 25 numbers are randomly drawn by the gaming operator. As each number is drawn, the corresponding number on the Link2Win™ card on the VDU is converted to its ordinal ranking. For example, the first drawn number is number 24, and number 24 on the Link2Win™ card is converted to 1st. This process is overviewed in FIGS. 3-6. Ordinal numbers make it easier for the players to see linkages. Alternatively, players may be given the option to identify the Links themselves, with prize levels dependent on each player's identification process.

FIGS. 4 and 6 demonstrate the winning process. The Link2Win™ card in FIG. 6 has 5 links: four links of 2; and one link of 5.

FIG. 7 shows for this example of the game the patterns that need to be linked. In this example of the game there are 92 possible links per Link2Win™ card. These are for 5, 3 and 2 in a row as identified in FIG. 7.

### Example 1.3—Example Game Play

The game frequency can be set as desired by the gaming operator, for example, every 5-10 minutes, if the game is played by a pool of players, or instantly if it is to be played as an instant play by a single player of the relevant game.
Players place their 25 numbers (1-25) onto the 25 squares, placing one number per square. Usually, a player will chose his or her SUPERLINK number, and most if not all of the remaining numbers will be randomly placed on the Link2Win™ card by a computer process using a random number generator.

### Example 1.4—Scoring the Link2Win™ Card

In this example of the game, it can be played by a pool of players, or as an instant play by a single player. Each card will be scored as follows:
2 Links: If two numbers drawn consecutively are located in adjacent cells (horizontal, vertical or diagonal) on the player's card, they score a 2 Link.

Three numbers drawn consecutively (if they do not qualify as a 3 Link) form 2×2 Links that are joined with a common number.
3 Links: If three numbers drawn consecutively are located on the player's card in adjacent cells in a straight line (horizontal, vertical or diagonal) within the inner 9 cells as shown in FIG. 1 (and FIG. 7, central columns) they score a 3 Link.

Note: a 3 Link will always start as a pair and this pair will be removed from the score sheet when it qualifies and becomes a 3 Link.

Further, five (5) drawn numbers drawn consecutively all inside the middle square can form 2×3 Links that are joined with a common number, e.g. in a “L” shape.

Seven (7) drawn numbers drawn consecutively all inside the middle square can form 3×3 Links that are joined with two common numbers, in a “Z” shape, or in a “U” shape.
5 Links: If five numbers drawn consecutively are located on the player's card in adjacent cells in a straight line (horizontal, vertical or diagonal) they score a 5 Link.
   Note in this example, a 5 will always start as a 2-link, followed by a second 2-link. This is because a 3 Link can only occur within the inner 9 cells and the 5 Link must start from one of the outside squares. Whichever scored items lead to the 5 Link, they will all be removed from the scorecard from the straight line as the 5 Link is completed.

Nine (9) drawn numbers drawn consecutively can form 2×5 Links that are joined with a common corner number, e.g. in an “L” shape.

Thirteen (13) drawn numbers drawn consecutively can form 3×5 Links that are joined with two common corner numbers, in a “Z” shape, or in a “U” shape.

Note: In this example of the game, there are no 4 Links. 4 consecutive drawn numbers appearing in a straight line (horizontal, vertical or diagonal) will count as:
Three 2 Links, if all outside the inner 9 cells; or
One 2 Link and one 3 Link, if any part of the 4 consecutively drawn numbers are in the inner 9 cells (of which there will be the one 3 Link).

### Example 1.5—Ranking of Top Cards in Multi-Card Draws

An application to rank the top cards in a multi-play of the game is also part of this exampled game. This allows for a first place winning card to be identified, as well as other placements as deemed desirable (such as 2^{nd} and 3^{rd}), in order that a winning card for part or all of any pari-mutuel prize fund can be determined. The rules to rank the top card are summarized below:
That card that has the most 5 Links is the Link2Win™ winner.

### Example 1.6—Tie Breaking Rules

In the event that there are tied cards equal with the most 5 Links, then the following rules apply to separate those tied cards;
The card that has the best 5 Link is then the winner, e.g. 1^{st}, 2^{nd}, 3^{rd}, 4^{th}, 5^{th} drawn numbers will beat 2^{nd}, 3^{rd}, 4^{th}, 5^{th}, 6^{th} drawn numbers and so on;
In the event that there are still tied cards equal with best 5 Links, then the next best 5 Link is considered until a winning card emerges;
In the event that there are still tied cards remaining that all have equally ranked 5 Links, then the following further rule applies to separate those remaining tied cards;
Of the remaining tied cards, that card that has the most 3 Links is the winner;
In the event that there are still tied cards equal with the most 5 Links and 3 Links, then the following further rule applies to separate those remaining tied cards;
The card that then has the best 3 Link is then the winner, e.g. 1^{st}, 2^{nd}, 3^{rd} drawn numbers will beat 2^{nd}, 3^{rd}, 4^{th} drawn numbers and so on;
In the event that there are still tied cards equal with the best 3 Links, then the next best 3 Link is considered until the tie is broken and a winning card emerges;
In the event that there are still tied cards remaining that all have equally ranked 5 Links and 3 Links, then the process is repeated using 2 Links;
In the event that there are still tied cards remaining that all have equally ranked 5 Links, 3 Links and 2 Links, then the following and final elimination process is used to separate the final remaining tied cards;
The card that has the SUPERLINK number is declared the winner. If there are two or more cards tied with the SUPERLINK number, then the prize is shared;
If none of the remaining tied cards have the SUPERLINK number (the 25^{th} drawn as their 25^{th} number), then the winning card is that card that has as its selected SUPERLINK number, the number that was drawn closest to the 25^{th} drawn SUPERLINK number—24^{th} drawn will beat 23^{rd} drawn and so on.
If after the completion of the above processes there remains cards that are still tied, then the prize/s are shared.

If there are no cards with 5 Links at all, then the process commences at the 3 Link level, or the 2 Link level if there are also no cards with any 3 Links. Detailed rankings of all 5 Links, 3 Links and 2 Links are set out below.

### Example 1.7—Number Combinations to Rank Cards

The Ranking Order Rules for 5, 3, and 2 Links are set out in Tables 1-3 below.

The ranking follows the order of draw, with 5s being first, 3s second then 2s.

Like Poker, in this example the rules are that a 5 Link always beats one or more 3 Links, and a 3 Link always beats one or more 2 Links.

In each case, the same ranking is given to numbers that are drawn in the exact reverse.

TABLE 1
Ranking Order - 5 Links

| | | | 5 in reverse |
|---|---|---|---|
| | 5 in order | | order |
| Ranking | of random draw | | of random draw |
| Order | in a Row | Joint = | in a Row |
| 1^{st} | 1^{st}-5^{th} | & | 5^{th}-1^{st} |
| 2^{nd} | 2^{nd}-6^{th} | & | 6^{th}-2^{nd} |
| 3^{rd} | 3^{rd}-7^{th} | & | 7^{th}-3^{rd} |
| 4^{th} | 4^{th}-8^{th} | & | 8^{th}-4^{th} |
| 5^{th} | 5^{th}-9^{th} | & | 9^{th}-5^{th} |
| 6^{th} | 6^{th}-10^{th} | & | 10^{th}-6^{th} |
| 7^{th} | 7^{th}-11^{th} | & | 11^{th}-7^{th} |
| 8^{th} | 8^{th}-12^{th} | & | 12^{th}-8^{th} |
| 9^{th} | 9^{th}-13^{th} | & | 13^{th}-9^{th} |
| 10^{th} | 10^{th}-14^{th} | & | 14^{th}-10^{th} |
| 11^{th} | 11^{th}-15^{th} | & | 15^{th}-11^{th} |
| 12^{th} | 12^{th}-16^{th} | & | 16^{th}-12^{th} |
| 13^{th} | 13^{th}-17^{th} | & | 17^{th}-13^{th} |
| 14^{th} | 14^{th}-18^{th} | & | 18^{th}-14^{th} |
| 15^{th} | 15^{th}-19^{th} | & | 19^{th}-15^{th} |
| 16^{th} | 16^{th}-20^{th} | & | 20^{th}-16^{th} |
| 17^{th} | 17^{th}-21^{st} | & | 21^{st}-17^{th} |
| 18^{th} | 18^{th}-22^{nd} | & | 22^{nd}-18^{th} |
| 19^{th} | 19^{th}-23^{rd} | & | 23^{rd}-19^{th} |
| 20^{th} | 20^{th}-24^{th} | & | 24^{th}-20^{th} |
| 21^{st} | 21^{st}-25^{th} | & | 25^{th}-21^{st} |

TABLE 2
Ranking Order - 3 Links

| | | | 3 in reverse |
|---|---|---|---|
| | 3 in order | | order |
| | of random draw | | of random draw |
| Ranking Order | in a Row | Joint = | in a Row |
| 1^{st} | 1^{st}-3^{rd} | & | 3^{rd}-1^{st} |
| 2^{nd} | 2^{nd}-4^{th} | & | 4^{th}-2^{nd} |
| 3^{rd} | 3^{rd}-5^{th} | & | 5^{th}-3^{rd} |
| 4^{th} | 4^{th}-6^{th} | & | 6^{th}-4^{th} |
| 5^{th} | 5^{th}-7^{th} | & | 7^{th}-5^{th} |
| 6^{th} | 6^{th}-8^{th} | & | 8^{th}-6^{th} |
| 7^{th} | 7^{th}-9^{th} | & | 9^{th}-7^{th} |
| 8^{th} | 8^{th}-10^{th} | & | 10^{th}-8^{th} |
| 9^{th} | 9^{th}-11^{th} | & | 11^{th}-9^{th} |
| 10^{th} | 10^{th}-12^{th} | & | 12^{th}-10^{th} |
| 11^{th} | 11^{th}-13^{th} | & | 13^{th}-11^{th} |
| 12^{th} | 12^{th}-14^{th} | & | 14^{th}-12^{th} |
| 13^{th} | 13^{th}-15^{th} | & | 15^{th}-13^{th} |
| 14^{th} | 14^{th}-16^{th} | & | 16^{th}-14^{th} |
| 15^{th} | 15^{th}-17^{th} | & | 17^{th}-15^{th} |
| 16^{th} | 16^{th}-18^{th} | & | 18^{th}-16^{th} |
| 17^{th} | 17^{th}-19^{th} | & | 19^{th}-17^{th} |
| 18^{th} | 18^{th}-20^{th} | & | 20^{th}-18^{th} |
| 19^{th} | 19^{th}-21^{st} | & | 21^{st}-19^{th} |
| 20^{th} | 20^{th}-22^{nd} | & | 22^{nd}-20^{th} |
| 21^{st} | 21^{st}-23^{rd} | & | 23^{rd}-21^{st} |
| 22^{nd} | 22^{nd}-24^{th} | & | 24^{th}-22^{nd} |
| 23^{rd} | 23^{rd}-25^{th} | & | 25^{th}-23^{rd} |

TABLE 3
Ranking Order - 2 Links

| | | | 2 in reverse |
|---|---|---|---|
| | 2 in order | | order |
| | of random draw | | of random draw |
| Ranking Order | in a Row | Joint = | in a Row |
| 1^{st} | 1^{st}-2^{nd} | & | 2^{nd}-1^{st} |
| 2^{nd} | 2^{nd}-3^{rd} | & | 3^{rd}-2^{nd} |
| 3^{rd} | 3^{rd}-4^{th} | & | 4^{th}-3^{rd} |
| 4^{th} | 4^{th}-5^{th} | & | 5^{th}-4^{th} |
| 5^{th} | 5^{th}-6^{th} | & | 6^{th}-5^{th} |
| 6^{th} | 6^{th}-7^{th} | & | 7^{th}-6^{th} |
| 7^{th} | 7^{th}-8^{th} | & | 8^{th}-7^{th} |
| 8^{th} | 8^{th}-9^{th} | & | 9^{th}-8^{th} |
| 9^{th} | 9^{th}-10^{th} | & | 10^{th}-9^{th} |
| 10^{th} | 10^{th}-11^{th} | & | 11^{th}-10^{th} |
| 11^{th} | 11^{th}-12^{th} | & | 12^{th}-11^{th} |
| 12^{th} | 12^{th}-13^{th} | & | 13^{th}-12^{th} |
| 13^{th} | 13^{th}-14^{th} | & | 14^{th}-13^{th} |
| 14^{th} | 14^{th}-15^{th} | & | 15^{th}-14^{th} |
| 15^{th} | 15^{th}-16^{th} | & | 16^{th}-15^{th} |
| 16^{th} | 16^{th}-17^{th} | & | 17^{th}-16^{th} |
| 17^{th} | 17^{th}-18^{th} | & | 18^{th}-17^{th} |
| 18^{th} | 18^{th}-19^{th} | & | 19^{th}-18^{th} |
| 19^{th} | 19^{th}-20^{th} | & | 20^{th}-19^{th} |
| 20^{th} | 20^{th}-21^{st} | & | 21^{st}-20^{th} |
| 21^{st} | 21^{st}-22^{nd} | & | 22^{nd}-21^{st} |
| 22^{nd} | 22^{nd}-23^{rd} | & | 23^{rd}-22^{nd} |
| 23^{rd} | 23^{rd}-24^{th} | & | 24^{th}-23^{rd} |
| 24^{th} | 24^{th}-25^{th} | & | 25^{th}-24^{th} |

### Example 1.8—Sole First Ranked Card is Substantially Certain

The odds that arise from the configuration and interplay of the linking features of the 2, 3 and 5 Links, together with the tie breaking rules set out above, mean that it is substantially certain that a sole first place or ranked Link2Win™ card will almost always occur. This avoids the first place game prize being subject to dilution, which would occur as a consequence of there being 2 or more first place joint winners.

### Example 1.9—Visual Representation of Draw, Links and Prizes

The results draw will appear on a screen of a computer device (including mobile smart phones) as numbers, or as an animated sequence of numbers timed such that the cards are scored as each number or cluster of numbers appears. A list of the prize entries for 2 Links, 3 Links and 5 Links should appear on the screen against each card. When the SUPERLINK number is correctly selected there will be strong visual effects and prize draw updates to heighten player awareness.

Important Feature:

A card can win in up to 3 prize categories: in 2 Links; in 3 Links; and or in 5 Links. All cards will start with a loaded prize credit being displayed prior to the first number being drawn in the results draw. This displayed prize credit is what the card will win in the 2 Link prize category if that card stays at zero 2 Links following the completion of the results draw. That displayed prize credit will then be won, irrespective of whether or not the card also has 3 Link and/or 5 Link prizes, which will be additional prizes.

### Example 1.10—2 Link Prize Profile

In this example, that starting displayed prize (for zero 2 Links) is set at £15. This £15 starting prize will:
initially go down in monetary value during the draw as the card gets one to three 2 Links;
go to a zero monetary amount once the card gets to, four to eight 2 Links;
At nine 2 Links, the displayed prize for 2 Links will go positive again and rise increasingly further as the card gets ten or more 2 Links—see Tables 10 and 11.
If the exact profile of this 2 Link prize decline, then increase, can be varied. Additional prizes will also appear as 3 Links and or 5 Links are achieved on the card.

### Example 1.11—Periodic Draws Involving Previously Played Cards

All legally entered cards may be retained by the gaming system/operator. There may be feature draws around key holidays or other globally recognised occasions when all cards received since the last such event will be entered into a free-to-enter draw.

These Link2Win™ games will be significantly larger, with the draw capable of being scheduled over a number of days to facilitate the scoring of a much larger number of cards.

Note: the scoring animations for these draws will still need to execute on the player's computer device, together with a display of that cards ranking. In this example of the game, and for the purpose of player interaction and suspense, the ranking is to be twofold, and in two stages:
Firstly: to first appear after the draw of the 15^{th} number recording whether or not the card is in the top 25% of all cards, and to be continually updated as each following number is drawn; and
Secondly: for a placement ranking to appear after the draw of the 20^{th} number, e.g. 1^{st} place or 999,999^{th} place, and to be continually updated as each following number is drawn.

### Example 1.12—Technology

Each player's card is almost virtually certain to be different, as the placement of the 25 numbers on the 25 cells of the 5×5 card will almost certainly be different. The chances that the same 25 number sequence will appear more than once in any game is extremely remote.

To calculate the odds of this occurring, the calculation starts with the odds of 1 against the calculation of getting 25 numbers in correct order of a random draw of the 25 numbers.

That starting calculation is odds of 1 in: 25×24×23×22×21×20×19×18×17×16×15×14×13×12×11×10×9×8×7×6×5×4×3×2×1.

This equals odds of 1 in 1.551121×10²⁵.

Then, the above odds of 1 in 1.551121 to the power of 25, needs to be adjusted (enhanced or made better) because there is more than one position on the card where 25 numbers can appear in order of draw on a 5×5 card matrix with every other drawn number also remaining in the same pattern relevant to all other numbers. The required adjustment is by making an allowance for the number of starting sequences that allow the same pattern of 25 numbers in order of draw to appear on the card—so that the same patterns of all linkages between numbers on the card when the card is rotated in ¼ turns, or viewed in reverse (i.e. a mirror image) are identical. On the basis that there are 4 corners, and allowing for the mirror image effect, or alternatively, the reverse order of draw, the required adjustment is believed to be by a division of the calculated number of 1.551121×10²⁵ by a division factor of 8.

This results in odds of 1 in 1.93890×10²⁴.

In full, the adjusted odds are 1 in 1,938,900,000,000,000,000,000,000.

The odds of there being two cards with the exact same 25 number sequence, in order of a random draw of 25 numbers, is therefore in excess of 1 in a trillion.

We asked mathematicians and actuaries to compute the odds of achieving different numbers if links on a randomly drawn set of 25 numbers displayed on a 5×5 matrix and we were told that it was not possible to compute this in a finite time.

Instead we were recommended to run computer simulations and count the number of links generated. These simulations are described at Examples 1.14 and 1.15, using a run of 82.958 billion. Each run corresponds to a draw of 25 numbers and a count of the number of 2 links per matrix, then the number of 3 links per matrix and so on. We have more simulations than can be usefully displayed in this patent specification. However the resultant odds are described in Example 1.15.

In order to process any game involving such a vast array of possibilities and outcomes, and where outcomes must be processed extremely quickly, the only practical way to do so is by using computer technology, equipment and programs designed to meet those needs, including software programs written to cover all outcomes as required by the rules of the game. Assuming an annual prize draw occurred, and that it involved 1 Billion Link2Win™ cards (being the number of cards played during a 1 year period), and assuming the computer processing from the results of the random draw, cards at a rate of 250,000 cards a second, then the computer processing would take at least 67 minutes.

Further, because each player's card is almost virtually certain to have the order of placement of its 25 numbers different to all other cards, the scoring functionality and visual representation relating to each card and its outcome or position in the game must, or should take place on the player's own computer device. The scoring on each player's computer device is for display purposes, as the main computer system operated by the Gaming Operator will have already scored the card.

Further the system should be capable of operating with a central Link2Win™ Game Operator. When this occurs, this operator will not know, or is unlikely to know, the player details. This operator will receive from a number of gaming operators' entries and the relevant player's unique identification code. The central operator will feed back the draw and the results to the gaming operators for them to feed to their respective players.

Various hardware configurations to implement the game are possible. For instance, the Link2Win™ game could be played online using a client-server model in which a server entity is used to process the game data and then transmit the output to one or more client machines. The client-server model could also be implemented using one or more game terminals as clients, such as terminals using touch screens. These hardware and software requirements are described and claimed in our co-pending patent application entitled “Apparatus for Mapping and Converting Multiple Matrices”.

The virtual imagery of the Link2Win™ card/board and the numbers are displayed on the display means of the device (such as PC, tablets, Smartphone, PDA etc) and the participants will be able to click onto their identified number and see the number convert to its ordinal placing. Alternatively, this process could be automatically done for the player by the gaming operator's system.

The draw of 25 numbers can be very fast, or it can be slower, like a traditional bingo game draw, one number at a time in a fairly slow sequence (see also the real time example using printed cards). In this later event, players could be given a time to identify their number on the card that corresponds to the drawn number, click on it and see the number covert to its ordinal placing. Ideally, there will be a set time for participants/players to match their number with the drawn number. A failure by a player to identify a match may result in lost winnings relevant to that failure. So this can be used to set a challenge to the player. However, such set time for participants to match their number with the drawn number is purely optional as there may be situations that might adversely affect some players and not others, such as lost connections, internet crashes etc.

The graphic interface of the game does not have to be the same in all devices, and the representation of the events, despite being formally equivalent, can be represented by distinct graphics. Part of the task of representation of the game sequence and the events of the game would either fall locally, or on each individual electronic device, on the game room servers or on the management servers, depending on the nature of the task involved in the event or game sequence.

### Example 1.13—Software Requirements and Processes

In order to provide a usable platform to run the Link2Win™ application in this example of the game, the software must be designed to ensure complete randomness of number generations, and should also be designed to run as efficiently as possible. There are a number of critical code areas to achieve this. We believe the following method provides an efficient running of the software.

Entry into the Game

The drawing of the 25 numbers for placement on a player's card will generally be by way of a random request. In many games of LOTTO, the majority of entries involve a random request for numbers, generally less than 8 in total. In this example of the game, there are 25 numbers. It is therefore believed that most entries into a game will be by random number request. Players can be given the choice to select their SUPERLINK number.

The request for the creation and supply of random game cards, especially when many players are playing the game, could see a large number of requests arrive in a very short period of time, such as a second. This will be more so as the game entry period comes to an end. Accordingly the software code needs to be as efficient as possible, and able to handle these surges.

### The Algorithm to Draw Card Numbers Ready for the Game

The numbers are stored in an array the size of the card. In this example of a 25 matrix (5×5) card, the array is of 25 numbers.

We believe that the following process is the most efficient way to handle and process this exampled game:

First, a 25 element array is created and loaded with the following numbers in order: |1|2|3|4|5|6|7|8|9|10|11|12|13|14|15|16|17|18|19|20|21|22|23|24|25|

Second, create a random number between 1 and 25. The number returned is used as an index to select the first item. The item selected is swapped with the 25^{th} element.

So if 10 was chosen you would have |1|2|3|4|5|6|7|8|9|25|11|12|13|14|15|16|17|18|19|20|21|22|23|24|10|

Third, then create a random number sourced from between index 1 to 24, and swap the selected index content with the 24^{th} element.

So if 4 is chosen you would get: |1|2|3|24|5|6|7|8|9|25|11|12|13|14|15|16|17|18|19|20|21|22|23|4|10|

Fourth, this is repeated in a loop until the final action where you create a number from the last two remaining indexes, 1 and 2, to decide the 2^{nd} element. The 1^{st} element is the remainder.

In Summary, The loop draws 24 random numbers and fills in the card with just 24 random swap operations (with the last number automatically filling the 25^{th} placement).

This process allows for cards to be generated very quickly.

### Scoring a Card

It is important that after closure of the game and then during and/or following the random draw to determine the results for each card, that cards can be scored very quickly. Further, all game cards must be processed before the game result can be displayed. Further, as game cards can be stored to participate in an end of year draw (or some other periodic event), a very large number of cards may have to be processed (in this example, a full year of entries) and ordered as quickly as possible for the end of year draw.

### The Algorithm to Score Each Card as Quickly as Possible

Assume that the separate results draw of the 25 numbers is: |6|20|23|25|10|15|7|18|8|2|22|19|12|13|14|5|17|21|24|3|16|4|9|11|1|

Assume that the game card is: |13|7|12|17|18|8|5|22|10|19|15|25|16|24|21|2|1|20|11|14|9|23|3|4|6|

First, the computer software checks to see if the last drawn number in the results draw matches the players number in the bottom right hand square of the card, i.e. the 25^{th} position of the game card. If so the computer program will record the relevant card as a SUPERLINK card.

Second, the computer software then loops through each player's game card and creates a list of the relevant links on or in each game card, where a number drawn in the results draw links with the immediately prior drawn number, as those numbers are positioned on the player's card.

This is processed for all numbers giving the following list of coordinates (The “coordinate list”): |25|18|22|12|9|11|2|5|6|16|8|10|3|1|20|7|4|15|14|23|13|24|21|19|17|

From the above list of coordinates:
First number drawn was 6; and it is in position 25 on the card
Second number drawn was 20, its at position 18 on the card
Third number drawn was 23, and it is at position 22 on the card
And so on.

The coordinates describe the path of the draw across the card and can be used by the computer program to calculate the direction of travel for each step.

The table below shows the coordinates which we have assigned to each square on the 5×5 Matrix. This is also set out in FIG. 13.

Coordinates on a 5 × 5 Link2Win ™ card

| | | | | |
|---|---|---|---|---|
| 1 | 2 | 3 | 4 | 5 |
| 6 | 7 | 8 | 9 | 10 |
| 11 | 12 | 13 | 14 | 15 |
| 16 | 17 | 18 | 19 | 20 |
| 21 | 22 | 23 | 24 | 25 |

Third, in this example of the game, mid-size links (3 long on a 25 matrix card) are only valid in the centre elements of the card. These are coordinates 7, 8, 9, 12, 13, 14, 17, 18, 19. Accordingly, alongside the processed list the computer program identifies and stores whether each mid-size link is in the centre region or not by reference to the coordinates.

This can be done by looping through each position in the processed list and creating a list which is set to ‘1’ if in the middle section, and ‘0’ if not.

For this example, this would create the centre list as follows: 0|1|0|1|1|0|0|0|0|0|1|0|0|0|1|0|0|1|0|0|1|1

Fourth, following the completion of the coordinate list, the computer program tests if each step forms a link to an adjacent location (horizontally, vertically, and diagonally).

This can be done by stepping through the coordinate list in turn, testing each location, and its immediate next location, in all directions, to see if there are any relevant adjacent links. This can be done quickly by the computer program storing the adjacency rules in a two dimensional array. The first dimension is the current point, and the second dimension is the next point.

The array result provides the vector for each link found on the card. For the example card this would be: |0|0|0|0|0|0|0|0|0|0|0|0|0|0|7|0|0|6|0|0|0|0|0|0|0|

This exampled card has just 2 adjacent sets of links.

The values that have been used are:
0. The points are NOT adjacent.
1. Vertical up.
2. Diagonal up, left.
3. Horizontal left.
4. Diagonal down, left.
5. Vertical down.
6. Diagonal down, right.
7. Horizontal right.
8. Diagonal up right.

Fifth, the final stage is for the computer software to work through the vector list and to find and calculate how many of the links are:
Long Links (5 long)
Mid Links (3 long) and
Short Links (2 long).

This is achieved by the computer software looping through the vectors. From each position a check is first made for a valid Long Link (5 long), then a valid Mid Link in the centre area using the centre list (3 long), and then a valid Short Link (2 long).

A total of each type of link is stored, which provides the card score, with prize-winning opportunities in all 3 categories.

During the scoring a Link List is generated. This is similar to the vector list, but each link only has one entry. The link length is coded such that the first digit indicates the length of the link and the second link shows the link direction as follows:
01-08 Short Link (2 long)
11-18 Mid Link (3 long)
21-28 Long Link (5 long)

The example card only has Short Links and so the Link list is exactly the same as the Vector list.

If the vector list has a set of links forming a long link such as |2|2|2|2|2| this would become |22|0|0|0|0|

The Link List provides the number and type of links on each matrix card. The total for each link type is calculated by counting the links of each size and is stored.

### Delivery of Results

To allow the game draw to be animated on each player's computer device, the following information is stored by the gaming operator's computer software for each card:
The Card's 25 numbers and their positions of placement on each card.
The processed list. This is used to animate the numbers in order.
The Link List. This is used to draw the lines on the card during the draw and provide the score animation.

### Example 1.14—Above Methods Followed

The above described computer processing methods were used when processing a simulated 82.958 billion card run and its results, the results of which are set out in Tables 4-8 below.

A skilled person will appreciate from the simulation results set out in Tables 4-8 below that the computer is an integral part of the present invention.

### Example 1.15—Odds, Stats from the Process of an 82.958 Billion (5×5) Card Run

### 2 Links

TABLE 4
2 Links - Excluding SUPERLINK

| | | | Percentage |
|---|---|---|---|
| | Number | | From |
| | From | Simulated | 82.958 Billion |
| No. of | 82.958 Billion | Odds¹ | Card Run % |
| 2 Links | Card Run | 1 in . . . | (to 5 decimal places) |
| 0 | 92,339,829 | 898.4 | 0.11131 |
| 1 | 754,593,803 | 109.9 | 0.90961 |
| 2 | 2,904,311,049 | 28.5 | 3.50094 |
| 3 | 7,010,631,386 | 11.8 | 8.45082 |
| 4 | 11,920,509,234 | 6.9 | 14.36933 |
| 5 | 15,199,948,853 | 5.4 | 18.32246 |
| 6 | 15,104,963,648 | 5.5 | 18.20796 |
| 7 | 12,000,571,487 | 6.9 | 14.46584 |
| 8 | 7,755,756,398 | 10.7 | 9.34902 |
| 9 | 4,127,286,456 | 20.1 | 4.97515 |
| 10 | 1,822,984,542 | 45.5 | 2.19748 |
| 11 | 671,719,387 | 123.5 | 0.80971 |
| 12 | 207,007,065 | 400.7 | 0.24953 |
| 13 | 53,340,465 | 1,555.2 | 0.06430 |
| 14 | 11,467,371 | 7,234.2 | 0.01382 |
| 15 | 2,047,975 | 40,507.3 | 0.00247 |
| 16 | 301,979 | 274,714.4 | 0.00036 |
| 17 | 36,032 | 2,302,342.2 | 0.00004 |
| 18 | 3,380 | 24,543,788.0 | 0.00000 |
| 19 | 266 | 311,872,192.0 | 0.00000 |
| 20 | 14 | 5,925,571,854.0 | 0.00000 |
| 21 | 1 | 82,958,000,000.0 | 0.00000 |
| 22 | | | 0.00000 |
| 23 | | | 0.00000 |
| 24 | | | 0.00000 |
| Totals | 79,639,820,620 | | |

¹From 82,958,000,000 Card Run Simulation

TABLE 5
2 Links - with SUPERLINK

| | | | Percentage |
|---|---|---|---|
| | Number | | From |
| | From | Simulated | 82.958 Billion |
| No. of | 82.958 Billion | Odds² | Card Run % |
| 2 Links | Card Run | 1 in . . . | (to 5 decimal places) |
| 0 | 3,267,260 | 25,390.7 | 0.00394 |
| 1 | 27,488,602 | 3,017.9 | 0.03314 |
| 2 | 108,889,762 | 761.8 | 0.13126 |
| 3 | 270,382,769 | 306.8 | 0.32593 |
| 4 | 472,896,860 | 175.4 | 0.57004 |
| 5 | 620,058,043 | 133.8 | 0.74744 |
| 6 | 633,606,355 | 130.9 | 0.76377 |
| 7 | 517,548,281 | 160.3 | 0.62387 |
| 8 | 343,972,242 | 241.1 | 0.41463 |
| 9 | 188,258,101 | 440.6 | 0.22693 |
| 10 | 85,567,880 | 969.5 | 0.10315 |
| 11 | 32,466,718 | 2,555.1 | 0.03914 |
| 12 | 10,298,080 | 8,055.6 | 0.01241 |
| 13 | 2,739,461 | 30,282.6 | 0.00330 |
| 14 | 607,334 | 136,593.7 | 0.00073 |
| 15 | 112,166 | 739,600.2 | 0.00014 |
| 16 | 17,191 | 4,825,664.5 | 0.00002 |
| 17 | 2,047 | 40,526,624.0 | 0.00000 |
| 18 | 206 | 402,708,736.0 | 0.00000 |
| 19 | 19 | 4,366,210,560.0 | 0.00000 |
| 20 | 2 | 41,479,000,064.0 | 0.00000 |
| 21 | 1 | 82,958,000,000.0 | 0.00000 |
| 22 | | | 0.00000 |
| 23 | | | 0.00000 |
| 24 | | | 0.00000 |
| Totals | 3,318,179,380 | | |

²From 82,958,000,000 Card Run Simulation

### 3 Links

TABLE 6
3 Links - Excluding SUPERLINK

| | | | Percentage |
|---|---|---|---|
| | Number | | From |
| | From | Simulated | 82.958 Billion |
| No. of | 82.958 Billion | Odds³ | Card Run % |
| 3 Links | Card Run | 1 in . . . | (to 5 decimal places) |
| 0 | 77,540,364,059 | 1.07 | 93.46941 |
| 1 | 2,087,032,877 | 39.75 | 2.51577 |
| 2 | 12,404,278 | 6,687.85 | 0.01495 |
| 3 | 19,406 | 4,274,863.50 | 0.00002 |
| Totals | 79,639,820,620 | | |

³From 82,958,000,000 Card Run Simulation

TABLE 7
3 Links - With SUPERLINK

| | | | Percentage |
|---|---|---|---|
| | Number | | From |
| | From | Simulated | 82.958 Billion |
| No. of | 82.958 Billion | Odds⁴ | Card Run % |
| 3 Links | Card Run | 1 in . . . | (to 5 decimal places) |
| 0 | 3,222,810,622 | 25.74 | 3.88487 |
| 1 | 94,746,581 | 875.57 | 0.11421 |
| 2 | 621,080 | 133,570.56 | 0.00075 |
| 3 | 1,097 | 75,622,608.00 | 0.00000 |
| Totals | 3,318,179,380 | | |

⁴From 82,958,000,000 Card Run Simulation

### 5 Links

TABLE 8
5 Links - All Cards

| | | | Percentage |
|---|---|---|---|
| | | | From |
| | Number | | 82.958 Billion |
| | From | Simulated | Card Run |
| No. of | 82.958 Billion | Odds ⁵ | % |
| 3 Links | Card Run | 1 in . . . | (to 5 decimal places) |
| 0 | 82,951,439,471 | 1.00 | 99.99209 |
| 1 | 6,560,331 | 12,645.40 | 0.00791 |
| 2 | 198 | 418,979,808.00 | 0.00000 |
| 3 | | | |
| 4 | | | |
| 5 | | | |
| Totals | 82,958,000,000 | | |

⁵ From 82,958,000,000 Card Run Simulation

Important Note:

SUPERLINK does not (in this example) apply to 5 Links. Accordingly, the above numbers from Table 8 comprise all of the Cards in the run of 82,958,000,000. The reasons for this are that some 5 links will contain the SUPERLINK number, and accordingly there is no multiplying effect on the odds for those 5 Links. Further, the odds of 2×5 Links are already at 1 in 418,979,808. Finally, it makes for a simple rule for players to understand that SUPERLINK only applies to the 2 and 3 Link prizes in this Example 1.

### Example 1.16—Prize Winning Chances

Each Link2Win™ card in this Example 1 has overall winning chances for any prize of:
24.01%, or
odds of 1 in 4.15

### Example 1.17—Use of Entry Fee

TABLE 9
Game Entry Fee Allocations - Overview

| | Allocation of | | |
|---|---|---|---|
| For | £5 Entry Fee | Percentage | Comment |
| Standard game | £2.230759 | 44.61% | Inclusive of Insured |
| | | | Prize Costs |
| SUPERLINK game | £0.613381 | 12.27% | Inclusive of Insured |
| | | | Prize Costs |
| Contingency + | £0.655860 | 13.12% | A Base contingency |
| Yearly Draw | | | of at least 10% is |
| | | | proposed. |
| | | | Each Link2Win ™ |
| | | | card is also entered |
| | | | into a yearly or other |
| | | | periodic draw, |
| | | | Prizes in this |
| | | | example are pari- |
| | | | mutuel prizes, paid |
| | | | to Top 3 Ranked |
| | | | Link2Win ™ cards: |
| | | | determined by |
| | | | Most/best 5s, or if |
| | | | none or there are |
| | | | ties, then by |
| | | | reference to |
| | | | Most/best 3s, and so |
| | | | on. |
| Sub Total | £3.500000 | 70% | |
| Operator/Link2Win ™ | £1.500000 | 30% | |
| | £5.000000 | 100% | |

### Example 1.18—Prizes and Odds, and Prize Costing

TABLE 10
Standard Game (excluding SUPERLINK)
Link2Win ™, excluding SUPERLINK

| Match | | | | | | |
|---|---|---|---|---|---|---|
| Prizes | | | | | | |
| in order | | | | | | |
| or | Base Prize * | | | | | Insurance |
| reverse | Insured | | | | Total % | % Cost |
| Diagonal | Prize | | | Number of | Cost | @2.5× |
| Horizontal, | “BC” = | | Odds | expected | Per each | Risk |
| or | £5 Bonus | Odds: | From | entries from | Original | Per each |
| Vertical | Card | 1 in . . . | Simulation | 1 Entry⁶ | £5 entry | £5 entry |
| 5 Link | | | | | | |
| Prizes | | | | | | |
| 2+ | £25,000,000* | 418,979,808 | Sim | 0.000000002 | £0.149172 | £0.149172 |
| 1 | £1,000 | 12,645 | Sim | 0.000079083 | £0.079083 | |
| | | | | | £0.228255 | |
| 3 Link | | | | | | |
| Prizes | | | | | | |
| 3 | £10,000 | 4,274,863 | Sim | 0.000000234 | £0.002340 | |
| 2 | £100 | 6,687 | Sim | 0.000149544 | £0.014955 | |
| 1 | £10 (incl. | 39.7 | Sim | 0.025188917 | £0.251890 | |
| | BC) | | | | | |
| | | | | | £0.269185 | |
| 2 Link | | | | | | |
| Prizes | | | | | | |
| 18+ | £500,000* | 22,659,928⁷ | Sim | 0.000000044 | £0.055164 | £0.055164 |
| 17 | £50,000* | 2,302,342 | Sim | 0.000000434 | £0.054293 | £0.054293 |
| 16 | £10,000 | 274,714 | Sim | 0.000003640 | £0.036402 | |
| 15 | £1,000 | 40,507 | Sim | 0.000024687 | £0.024687 | |
| 14 | £100 | 7,234 | Sim | 0.000138236 | £0.013824 | |
| 13 | £50 | 1,555 | Sim | 0.000643087 | £0.032154 | |
| 12 | £25 | 401 | Sim | 0.002493766 | £0.062344 | |
| 11 | £10 (incl. | 123 | Sim | 0.008130081 | £0.081301 | |
| | BC) | | | | | |
| 10 | £8 (incl. | 45 | Sim | 0.022222222 | £0.177778 | |
| | BC) | | | | | |
| 9 | £6 (incl. | 20.1 | Sim | 0.049751244 | £0.298507 | |
| | BC) | | | | | |
| 8 | £0 | 10.7 | Sim | 0.093457944 | £0.000000 | |
| 7 | £0 | 6.9 | Sim | 0.144927536 | £0.000000 | |
| 6 | £0 | 5.5 | Sim | 0.181818182 | £0.000000 | |
| 5 | £0 | 5.4 | Sim | 0.185185185 | £0.000000 | |
| 4 | £0 | 6.9 | Sim | 0.144927536 | £0.000000 | |
| 3 | £6 (incl. | 11.8 | Sim | 0.084745763 | £0.508475 | |
| | BC) | | | | | |
| 2 | £8 (incl. | 28.5 | Sim | 0.035087719 | £0.280702 | |
| | BC) | | | | | |
| 1 | £10 (incl. | 109.9 | Sim | 0.009099181 | £0.090992 | |
| | BC) | | | | | |
| 0 | £15 | 898.4 | Sim | 0.001113090 | £0.016696 | |
| | | | | | £1.733319 | |

| | |
|---|---|
| Total Scenario A | £2.230759 |
| The Overall Target is £3.00 (60%) (based on SUPERLINK costs in | £2.386619 |
| Table 11 of £0.613381), so this Table 10's Target is: | |
| Difference is: which goes to extra prizes or added to the 10% | £0.155860 |
| contingency | |

⁶Calc: 1 Entry (1) divided by the odds
⁷See Table 1: Add the number of cards for 18 × 2 Links and above; 3,380 + 266 + 14 + 1 = 3,661. Then divide the total cards of 82.958 Billion by 3,661 = 22,659,928.98

TABLE 11
SUPERLINK
SUPERLINK

| Match | | | | | | |
|---|---|---|---|---|---|---|
| Prizes | | | | | | |
| in order | Base Prize * | | | | | |
| or | Insured | | | | | Insurance |
| reverse | Prize | | | Number of | Total % Cost | % Cost |
| Diagonal | “BC” = | | Odds | expected | Per each | @2.5× Risk |
| Horizontal, | £5 Bonus | Odds: | From | entries from | Original | Per each |
| or Vertical | Card | 1 in . . . | Simulation | 1 Entry⁸ | £5 entry | £5 entry |
| 3 Link | | | | | | |
| Prizes | | | | | | |
| 3 | £1,000,000* | 75,622,608 | Sim | 0.000000013 | £0.033059 | £0.033059 |
| 2 | £1,000 | 133,570 | Sim | 0.000007487 | £0.007487 | |
| 1 | £100 | 875 | Sim | 0.001142857 | £0.114286 | |
| | | | | | £0.154832 | |
| 2 Link | | | | | | |
| Prizes | | | | | | |
| 18+ | £10,000,000* | 363,850,877⁹ | Sim | 0.000000003 | £0.068710 | £0.068710 |
| 17 | £500,000* | 40,526,624 | Sim | 0.000000025 | £0.030844 | £0.030844 |
| 16 | £25,000 | 4,825,644 | Sim | 0.000000207 | £0.005181 | |
| 15 | £5,000 | 739,600 | Sim | 0.000001352 | £0.006760 | |
| 14 | £500 | 136,593 | Sim | 0.000007321 | £0.003661 | |
| 13 | £125 | 30,282 | Sim | 0.000033023 | £0.004128 | |
| 12 | £100 | 8,055 | Sim | 0.000124146 | £0.012415 | |
| 11 | £50 | 2,555 | Sim | 0.000391389 | £0.019569 | |
| 10 | £40 | 969 | Sim | 0.001031992 | £0.041280 | |
| 9 | £35 | 440 | Sim | 0.002272727 | £0.079545 | |
| 8 | £0 | 241 | Sim | 0.004149378 | £0.000000 | |
| 7 | £0 | 163 | Sim | 0.006134969 | £0.000000 | |
| 6 | £0 | 131 | Sim | 0.007633588 | £0.000000 | |
| 5 | £0 | 133 | Sim | 0.007518797 | £0.000000 | |
| 4 | £0 | 175 | Sim | 0.005714286 | £0.000000 | |
| 3 | £25 | 306 | Sim | 0.003267974 | £0.081699 | |
| 2 | £50 | 761 | Sim | 0.001314060 | £0.065703 | |
| 1 | £100 | 3,017 | Sim | 0.000331455 | £0.033146 | |
| 0 | £150 | 25,390 | Sim | 0.000039386 | £0.005908 | |
| | | | | | £0.458549 | |

| | |
|---|---|
| Total Scenario A | £0.613381 |

⁸Calc: 1 Entry (1) divided by the odds
⁹See Table 2: Add the number of SUPERLINK cards for 18 × 2 Links and above; 206 + 19 + 2 + 1 = 228. Then divide the total cards of 82.958 Billion by 228 = 363,850,877.2

Variations to Prizes:

There are many variations that are possible. For example, the following variation could be achieved: Table 10: The top prize of 5 Link x 2+ could be increased to £100 million. The extra cost would be £0.447576. This could be fully funded by eliminating the “2 Link×3” prize of £6 for example, and still leaving from that one prize elimination an extra surplus savings. The odds to win a prize would increase, from 1 in 4.15, to c. 1 in 6.5.

### Example 1.19—Overall Probability of Winning

In this Example 1, there are 36 Prize Tiers in each Link2Win™ Game, with each card having the chance to win in 3 separate prize categories, one in each of the 2, 3 and 5 Link categories. This Table 12 is organized based on the odds in Column 3.

TABLE 12
Odds

| Prize Categories | | | | | |
|---|---|---|---|---|---|
| Need to Match . . . | | | | | |
| Standard | SUPERLINK | Column 3 | Average Prize | | Return on |
| Game | Game | Odds 1 in . . . | (set) | Entry Cost | Entry Cost |
| 5 Links × 2+ | | 418,979,808 | £25,000,000 | £5 | ×5,000,000 |
| | 2 Links × 18+ | 363,850,877 | £10,000,000 | £5 | ×2,000,000 |
| | 3 Links × 3 | 75,622,608 | £1,000,000 | £5 | ×200,000 |
| | 2 Links × 17 | 40,526,624 | £500,000 | £5 | ×100,000 |
| 2 Links × 18+ | | 22,659,928 | £500,000 | £5 | ×100,000 |
| | 2 Links × 16 | 4,825,644 | £25,000 | £5 | ×5,000 |
| 3 Links × 3 | | 4,274,863 | £10,000 | £5 | ×2,000 |
| 2 Links × 17 | | 2,302,342 | £50,000 | £5 | ×10,000 |
| | 2 Links × 15 | 739,600 | £5,000 | £5 | ×1,000 |
| 2 Links × 16 | | 274,714 | £10,000 | £5 | ×2,000 |
| | 2 Links × 14 | 136,593 | £500 | £5 | ×100 |
| | 3 Links × 2 | 133,570 | £1,000 | £5 | ×200 |
| 2 Links × 15 | | 40,507 | £1,000 | £5 | ×200 |
| | 2 Links × 13 | 30,282 | £125 | £5 | ×25 |
| | No 2 Links | 25,390 | £150 | £5 | ×30 |
| 5 Links × 1 | | 12,645 | £1,000 | £5 | ×200 |
| | 2 Links × 12 | 8,055 | £100 | £5 | ×20 |
| 2 Links × 14 | | 7,234 | £100 | £5 | ×20 |
| 3 Links × 2 | | 6,687 | £100 | £5 | ×20 |
| | 2 Links × 1 | 3,017 | £100 | £5 | ×20 |
| | 2 Links × 11 | 2,555 | £50 | £5 | ×10 |
| 2 Links × 13 | | 1,555 | £50 | £5 | ×10 |
| | 2 Links × 10 | 969 | £40 | £5 | ×8 |
| No 2 Links | | 898 | £15 | £5 | ×3 |
| | 3 Links × 1 | 875 | £100 | £5 | ×20 |
| | 2 Links × 2 | 761 | £50 | £5 | ×10 |
| | 2 Links × 9 | 440 | £35 | £5 | ×7 |
| 2 Links × 12 | | 401 | £25 | £5 | ×5 |
| | 2 Links × 3 | 306 | £25 | £5 | ×5 |
| 2 Links × 11 | | 123 | £10 | £5 | ×2 |
| 2 Links × 1 | | 109.9 | £10 | £5 | ×2 |
| 2 Links × 10 | | 45 | £8 | £5 | ×1.6 |
| 3 Links × 1 | | 39.7 | £10 | £5 | ×2 |
| 2 Links × 2 | | 28.5 | £8 | £5 | ×1.6 |
| 2 Links × 9 | | 20.1 | £6 | £5 | ×1.2 |
| 2 Links × 3 | | 11.8 | £6 | £5 | ×1.2 |

Overall Odds of winning a prize in Link2Win ™ are 1 in 4.15
Plus every Card is also in the annual Draw
Top 3 Cards win the prize pool established from the 10% Contingency

### Example 1.14—Looking at the ODDS

We set out below the EuroMillions and PowerBall odds and prizes, so that a comparison can be made with the example of the Link2Win™ game set out in this Example 1, at Table 12.

### EuroMillions

There are 13 prize tiers in each EuroMillions draw and the estimated jackpot is published prior to the draw. The exact prize value of each tier, including the jackpot*, is calculated according to how many tickets are sold in a particular draw and how many winning tickets there are in any given prize tier.

EuroMillions involves picking numbers from 2 set of numbers:
Pick 5 from 50 (always the first reference), and then 2 from 11.

TABLE 13
EuroMillions

| Prize | | | | |
|---|---|---|---|---|
| Categories | | | | |
| Need to | | | | Return on |
| Match | Odds | | Entry | Entry |
| . . . | 1 in . . . | Average Prize | Cost | Cost |
| 5 + 2 | 116,531,800 | [symbol] 52,000,000 | E2 | ×26,000,000 |
| 5 + 1 | 6,473,989 | [symbol] 420,000 | E2 | ×210,000 |
| 5 | 3,236,995 | [symbol] 70,000 | E2 | ×35,000 |
| 4 + 2 | 517,920 | [symbol] 4,700 | E2 | ×2,350 |
| 4 + 1 | 28,774 | [symbol] 212 | E2 | ×106 |
| 4 | 14,487 | [symbol] 105 | E2 | ×53 |
| 3 + 2 | 11,771 | [symbol] 64 | E2 | ×32 |
| 2 + 2 | 882 | [symbol] 21 | E2 | ×11 |
| 3 + 1 | 654 | [symbol] 15 | E2 | ×7 |
| 3 | 327 | [symbol] 12 | E2 | ×6 |
| 1 + 2 | 157 | [symbol] 11 | E2 | ×5 |
| 2 + 1 | 46 | [symbol] 8 | E2 | ×4 |
| 2 | 23 | [symbol] 4 | E2 | ×2 |

### American PowerBall

The Basic game involves:
The minimum Powerball bet is $2.
In each game, players select five numbers from a set of 59 white balls and one number from 35 red Powerballs.
The number chosen from the red Powerballs may be the same as one of the numbers chosen from the white balls.

TABLE 14
American PowerBall
Payouts after Jan. 19, 2014 are:

| | | | Power Play | | | |
|---|---|---|---|---|---|---|
| | | Power Play | 3× (1 in | Power Play | Power Play | Odds of |
| Matches | Prize | 2× (1 in 2) | 3⅓) | 4× (1 in 10) | 5× (1 in 10) | winning[19] |
| Only | $4 | $8 | $12 | $16 | $20 | 1 in 55.41 |
| Powerball | | | | | | |
| 1 | $4 | $8 | $12 | $16 | $20 | 1 in 110.81 |
| number | | | | | | |
| plus PB | | | | | | |
| 2 | $7 | $14 | $21 | $28 | $35 | 1 in 706.43 |
| numbers | | | | | | |
| plus PB | | | | | | |
| 3 | $7 | $14 | $21 | $28 | $35 | 1 in 360.14 |
| numbers; | | | | | | |
| no PB | | | | | | |
| 3 | $100 | $200 | $300 | $400 | $500 | 1 in 12,244.83 |
| numbers | | | | | | |
| plus PB | | | | | | |
| 4 | $100 | $200 | $300 | $400 | $500 | 1 in 19,087.53 |
| numbers; | | | | | | |
| no PB | | | | | | |
| 4 | $10,000 | $20,000 | $30,000 | $40,000 | $50,000 | 1 in |
| numbers | | | | | | 648,975.96 |
| plus PB | | | | | | |
| 5 | $1,000,000 | $2,000,000† | $2,000,000† | $2,000,000† | $2,000,000† | 1 in |
| numbers; | | | | | | 5,153,632.65 |
| no PB | | | | | | |
| 5 | Jackpot | Jackpot†† | Jackpot†† | Jackpot†† | Jackpot†† | 1 in |
| numbers | | | | | | 175,223,510.00 |
| plus PB | | | | | | |

*California's prize amounts are variable as state law requires prizes to be pari-mutuel. Powerplay is not offered in California.
†The Power Play Match 5 stays fixed at $2,000,000 since Jan. 15, 2012.

### Example 2.0-5×5 Matrix Game—1×2 Link with Prizes

This Example 2 of the game is a similar 5×5 game to that set out in Example 1. This Example 2 has the same entry fee structure (E5) and linking rules. The key difference is the profile of the 2 Link prizes.

In addition, some adjustments have been made to the top prizes, increasing them, and to the retained percentage of the Gross Gaming Revenue retained by the Gaming Operator/Link2Win™- to demonstrate the flexibility of this invention.

### Number of Link2Win™ Card Simulations

In this Example 2 of the game, we ran a Link2Win™ Card simulation that comprised 139.828 Billion card run. The simulated odds correlate with those simulated odds set out in Example 1. For example, compare Example 1.18, Table 10 with Example 2.4, Table 16.

### Example 2.1-2 Link Prize Profile

In this Example 2, only one (1) set of a 2 Link has a £nil prize.

(Note: Example 1 had 5 sets of a 2 Link with a £nil prize, see Example 1.18 and Tables 10 and 11.)

In this Example 2, the initial starting prize credit for the 2 Link prizes will:
Initially go down in monetary value during the draw as the card gets one to four 2 Links;
Go to a zero monetary amount once the card gets to five 2 Links;
At six 2 Links, the displayed prize for 2 Links will go positive again, and rise increasingly further as the card gets seven or more 2 Links—see Tables 16 and 17.

### Example 2.2—Prize Winning Chances

In this Example 2 of the Link2Win™ game, each Link2Win™ card has overall winning chances for any prize of:
81.5%, or
odds of 1 in 1.27.

Note:

In Example 1, the chances of winning any prize was 24.01%, or odds of 1 in 4.15—see Example 1.16. The reason why the overall winning chances have increased in this Example 2 is primarily because of the changes made to the 2 Link prize profile, as set out in Example 2.1 above.

### Example 2.3—Use of Entry Fee

TABLE 15
Entry Fee Allocations

| | Allocation of | | |
|---|---|---|---|
| For | £5 Entry Fee | Percentage | Comment |
| Standard game | £2.741106 | 54.82% | Inclusive of Insured |
| | | | Prize Costs |
| SUPERLink game | £1.167933 | 23.36% | Inclusive of Insured |
| | | | Prize Costs |
| Contingency | £0.090961 | 1.82% | |
| Sub Total | £4.00 | 80% | |
| Operator/Link2Win ™ | £1.00 | 20% | |
| | £5.00 | 100% | |

### Example 2.4—Prizes and Odds, and Prize Costing

TABLE 16
Standard Game (excluding SUPERLink)
Link2Win ™, excluding SUPERLink

| | | | | | | |
|---|---|---|---|---|---|---|
| | | | Odds | Number of | Total % Cost | |
| | Base Prize * | | Estimate | expected | Per each | Insurance % |
| Match | Insured | Odds: | Or From | entries from | Original | Cost |
| Prizes | Prize | 1 in . . . | Simulation | 1 Entry¹⁰ | £5 entry | @2.5× Risk |

5 Link Prizes

| | | | | | | |
|---|---|---|---|---|---|---|
| 2+ | £25,000,000* | 452,517,799.4 | Sim | 0.000000002 | £0.138116 | £0.138116 |
| 1 | £1,000 | 13,197.0 | Sim | 0.000075775 | £0.075775 | |
| | | | | | £0.213891 | |

3 Link Prizes

| | | | | | | |
|---|---|---|---|---|---|---|
| 3 | £100,000 | 4,253,582.0 | Sim | 0.000000235 | £0.058774 | £0.058774 |
| 2 | £100 | 6,687.7 | Sim | 0.000149529 | £0.014953 | |
| 1 | £10 | 39.7 | Sim | 0.025157724 | £0.251577 | |
| | | | | | £0.325304 | |

2 Link Prizes

| | | | | | | |
|---|---|---|---|---|---|---|
| 18+ | £1,000,000* | 22,531,098.9 | Sim | 0.000000044 | £0.110958 | £0.110958 |
| 17 | £50,000* | 2,299,651.3 | Sim | 0.000000435 | £0.054356 | £0.054356 |
| 16 | £10,000 | 275,111.2 | Sim | 0.000003635 | £0.036349 | |
| 15 | £1,000 | 40,538.4 | Sim | 0.000024668 | £0.024668 | |
| 14 | £100 | 7,233.7 | Sim | 0.000138241 | £0.013824 | |
| 13 | £50 | 1,555.0 | Sim | 0.000643090 | £0.032154 | |
| 12 | £25 | 400.8 | Sim | 0.002495181 | £0.062379 | |
| 11 | £15 | 123.5 | Sim | 0.008097439 | £0.121462 | |
| 10 | £10 | 45.5 | Sim | 0.021974646 | £0.219746 | |
| 9 | £5 | 20.1 | Sim | 0.049750955 | £0.248755 | |
| 8 | £3 | 10.7 | Sim | 0.093490599 | £0.280472 | |
| 7 | £2 | 6.9 | Sim | 0.144657184 | £0.289314 | |
| 6 | £1 | 5.5 | Sim | 0.182079687 | £0.182080 | |
| 5 | £0 | 5.4 | Sim | 0.183223966 | £0.000000 | |
| 4 | £1 | 7.0 | Sim | 0.143694104 | £0.143694 | |
| 3 | £2 | 11.8 | Sim | 0.084508301 | £0.169017 | |
| 2 | £3 | 28.6 | Sim | 0.035009732 | £0.105029 | |
| 1 | £10 | 109.9 | Sim | 0.009095818 | £0.090958 | |
| 0 | £15 | 898.4 | Sim | 0.001113038 | £0.016696 | |
| | | | | | £2.201911 | |

| | | |
|---|---|---|
| Total Standard Game | £2.741106 | £0.362204 |

¹⁰Calc: 1 Entry (1) divided by the odds

TABLE 17
SUPERLink
SUPERLink

| | | | | | | |
|---|---|---|---|---|---|---|
| | | | | | Total % | |
| | | | Odds | Number of | Cost | Insurance |
| | Base Prize * | | Estimate | expected | Per each | % Cost |
| Match | Insured | Odds: | Or From | entries from | Original | @2.5× |
| Prizes | Prize | 1 in . . . | Simulation | 1 Entry | £5 entry | Risk |

5 Link Prizes

| | | | | | | |
|---|---|---|---|---|---|---|
| 2+ | £25,000,000* | See note¹¹ | Sim | 0.0000000001 | £0.006258 | £0.006258 |
| 1 | £10,000 | 303,925.7 | Sim | 0.000003290 | £0.032903 | |
| | | | | | £0.039161 | |

3 Link Prizes

| | | | | | | |
|---|---|---|---|---|---|---|
| 3 | £5,000,000* | 76,534,209.1 | Sim | 0.000000013 | £0.163326 | £0.163326 |
| 2 | £1,000 | 133,566.9 | Sim | 0.000007487 | £0.007487 | |
| 1 | £100 | 875.6 | Sim | 0.001142022 | £0.114202 | |
| | | | | | £0.285015 | |

2 Link Prizes

| | | | | | | |
|---|---|---|---|---|---|---|
| 18+ | £10,000,000* | 350,446,115.3 | Sim | 0.000000003 | £0.071338 | £0.071338 |
| 17 | £500,000* | 39,905,251.1 | Sim | 0.000000025 | £0.031324 | £0.031324 |
| 16 | £25,000 | 4,838,339.1 | Sim | 0.000000207 | £0.005167 | |
| 15 | £5,000 | 740,500.7 | Sim | 0.000001350 | £0.006752 | |
| 14 | £500 | 136,649.9 | Sim | 0.000007318 | £0.003659 | |
| 13 | £125 | 30,284.9 | Sim | 0.000033020 | £0.004127 | |
| 12 | £100 | 8,050.7 | Sim | 0.000124214 | £0.012421 | |
| 11 | £50 | 2,555.2 | Sim | 0.000391355 | £0.019578 | |
| 10 | £40 | 969.4 | Sim | 0.001031556 | £0.041262 | |
| 9 | £35 | 440.7 | Sim | 0.002269360 | £0.079428 | |
| 8 | £30 | 241.2 | Sim | 0.004146380 | £0.124391 | |
| 7 | £20 | 160.3 | Sim | 0.006238781 | £0.124776 | |
| 6 | £10 | 130.9 | Sim | 0.007637771 | £0.076378 | |
| 5 | £0 | 133.8 | Sim | 0.007474627 | £0.000000 | |
| 4 | £10 | 175.4 | Sim | 0.005700396 | £0.057004 | |
| 3 | £25 | 306.8 | Sim | 0.003259459 | £0.081486 | |
| 2 | £50 | 761.8 | Sim | 0.001312685 | £0.065634 | |
| 1 | £100 | 3,017.9 | Sim | 0.000331354 | £0.033135 | |
| 0 | £150 | 25,394.5 | Sim | 0.000039379 | £0.005907 | |
| | | | | | £0.843758 | |

| | | |
|---|---|---|
| Total SUPERLink | £1.167933 | £0.272245 |

¹¹SUPERLink does not apply to increase the prizes for 2 × 5 Links, so the odds are left the same as the standard game for these occurrences - but the costs relevant to providing for this occurrence has not been provided for in Table 16. This cost is contained in this SUPERLink Table 17.

### Example 2.5—Overall Probability of Winning

In this Example 2, there are 45 Prize Tiers in each Link2Win™ Game, with each card having the chance to win in 3 separate prize categories, one in each of the 2, 3 and 5 Link categories. This Table 18 is organized based on the odds in Column 3.

TABLE 18
Overview of Combined Prizes for Standard and SUPERLink Games

| Prize Categories | | Column 3 | |
|---|---|---|---|
| Standard | SUPERLink | Odds | Prize |
| Game | Game | 1 in . . . | (set) |
| 5 Links × 2+ | | 432,930,831¹² | £25,000,000 |
| | 2 Links × 18+ | 350,446,115 | £10,000,000 |
| | 3 Links × 3 | 76,534,209 | £5,000,000 |
| | 2 Links × 17 | 39,905,251 | £500,000 |
| 2 Links × 18+ | | 22,531,098 | £1,000,000 |
| | 2 Links × 16 | 4,838,339 | £25,000 |
| 3 Links × 3 | | 4,253,582 | £100,000 |
| 2 Links × 17 | | 2,299,651 | £50,000 |
| | 2 Links × 15 | 740,500 | £5,000 |
| 2 Links × 16 | | 275,111 | £10,000 |
| | 2 Links × 14 | 136,650 | £500 |
| | 3 Links × 2 | 133,567 | £1,000 |
| 2 Links × 15 | | 40,538 | £1,000 |
| | 2 Links × 13 | 30,285 | £125 |
| | No 2 Links | 25,395 | £150 |
| 5 Links × 1 | | 13,197 | £1,000 |
| | 2 Links × 12 | 8,051 | £100 |
| 2 Links × 14 | | 7,234 | £100 |
| 3 Links × 2 | | 6,688 | £100 |
| | 2 Links × 1 | 3,018 | £100 |
| | 2 Links × 11 | 2,555 | £50 |
| 2 Links × 13 | | 1,555 | £50 |
| | 2 Links × 10 | 969 | £40 |
| No 2 Links | | 898 | £15 |
| | 3 Links × 1 | 875 | £100 |
| | 2 Links × 2 | 762 | £50 |
| | 2 Links × 9 | 441 | £35 |
| 2 Links × 12 | | 401 | £25 |
| | 2 Links × 3 | 307 | £25 |
| | 2 Links × 8 | 241 | £30 |
| | 2 Links × 4 | 175 | £10 |
| | 2 Links × 7 | 160 | £20 |
| | 2 Links × 6 | 131 | £10 |
| 2 Links × 11 | | 123 | £15 |
| 2 Links × 1 | | 110 | £10 |
| 2 Links × 10 | | 45 | £10 |
| 3 Links × 1 | | 40 | £10 |
| 2 Links × 2 | | 29 | £3 |
| 2 Links × 9 | | 20 | £5 |
| 2 Links × 3 | | 12 | £2 |
| 2 Links × 8 | | 11 | £3 |
| 2 Links × 4 | | 7 | £1 |
| 2 Links × 7 | | 7 | £2 |
| 2 Links × 6 | | 5.5 | £1 |

¹² The recorded odds from our simulation of 139.828 Billion card run in the SUPERLink Game for a 2 × 5 Link is 9,987,714,285. Take this FIGURE and divide by the recorded odds in the standard game. This = 22.07. Add in the one occurrence in the SUPERLink, then this = 23.07. Then divide 9,987,714,285 by 23.07 = 432,930,831. Overall Odds of winning a prize in Link2Win ™ are 1 in 1.27

### Example 3.0—Link2Win™ for State Lotteries—Pooled Games

### Example 3.1—Background

For some State Lotteries around the world, online gambling is either not adopted, or it is illegal and therefore not offered. In particular, it is illegal for many of the US State Lotteries. Alternatively, if offered, it is likely to be in its infancy, with small online sales. Further, almost all State Lotteries around the world have a significant investment in their existing sales infrastructure, which includes their important relationships with their POS retail outlets. Further still, many of these POS retail outlets have built and supported their State Lottery over many years, and they provide an important personalised service with front line assistance for the customers of the lottery.

In some cases, POS lottery retailers have become very reliant on their State Lottery Operator for their viability. For example in the US, some retailers have lottery sales that comprise 25% or more of their total turnover.

There has developed over the years an important partnership/relationship between State Lotteries and their POS retail outlets. While online gaming is an increasing way for players to play, and this will continue, it poses both an opportunity and a threat or problem for many State Lotteries.
The opportunity is to bring new and exciting games to their customers, which many customers want.
The threat or problem is that the significant investment by State Lotteries in their existing POS retailer network may be adversely affected by moving to online gaming. For example, a move to online gaming may adversely affect the level of lottery sales made by the relevant State Lottery's POS retail outlets, and therefore adversely affect their earnings.

Link2Win™ is an invention of a new gaming system. This invention is best suited to an online gaming environment, or at least an environment that provides for computer graphics—as the results are best animated, displayed or played out on special terminals, as well as mobile, tablet or personal computing devices. So in respect of an online gaming operator offering Link2Win™, a player enters the game and purchases an entry from the online gaming operator by undertaking an online payment transaction, the player later obtains access to the draw and results online, and collects his winnings, again via an online payment transaction.

As mentioned above, for some State Lotteries around the world, online gambling is still in its infancy, or it is illegal. And most or all State Lotteries will harbour concerns relating to the potential adverse impact that moving to online gaming may have on their POS lottery retailers.

These disadvantages can be overcome when a State Lottery Operator uses certain aspects of this invention described herein.

### Example 3.2—No Online Transaction

In a further aspect of this invention, Link2Win™ can be offered for play by most or all of the world's State Lottery Operators using their existing POS retail infrastructure without players undertaking any online payment transaction to enter the Link2Win™ game.

Entries into a Link2Win™ game would be transacted by players purchasing tickets from the relevant State Lottery Operator's POS retailers in the same way as they would purchase a typical LOTTO ticket. After tickets sales close, the State Lottery Operator would then undertake the random draw. Winning Link2Win™ players would go back to a POS retailer with their original entry ticket to confirm and collect their winnings using the original Link2Win™ ticket that was purchased as the ‘proof of entry’, in the same way as they would go to the POS retailer to confirm and collect winnings in a typical LOTTO game. We set this out more fully below.

### Example 3.3—For State Lotteries—Pooled Game

We now describe a method involving a pooled Link2Win™ game. This involves a number of players that each undertake a conventional transaction with a State Lottery organisation through its existing POS lottery retailers, but without losing the excitement and anticipation that the players can experience of the Link2Win™ game when the results are to be animated, displayed or played out on a mobile, tablet or personal computer device.

### Example 3.4—Key Elements for the Pooled Game

In this example, the key elements are:
1. The players and the State Lottery Operator do not make any transaction online.
2. The rules can state that players can only enter into a pooled Link2Win™ game by purchasing an entry ticket from a POS lottery retailer. Note: when referring to an entry ticket, this includes any entry card that is issued.
3. The only valid ‘evidence’ of entry is the original ticket that is issued by the POS lottery retailer to the player at the time of purchase.
4. Winning tickets are presented by players to a POS lottery retailer, who process the tickets in the same way as they would process a traditional winning LOTTO ticket—e.g. confirm the ticket as valid and as a winning ticket; pay-out small prizes directly, refer big prize winners to the relevant State Lottery for processing by them.
5. Any ticket can be presented to any relevant POS lottery retailer in order to confirm whether it is a winning or losing ticket.

### Example 3.5—Further Explanation of the Methods

By way of further explanation of the method described in this example:
A player buys a Link2Win™ ticket/card at a POS lottery retail outlet, in exactly the same way as if the player was purchasing an entry into a typical LOTTO draw from the POS lottery retailer.
The ticket purchased contains a visual representation of a 5×5 matrix, with the ticket showing the placement of the 25 numbers in or on the 25 squares.
The ticket purchased has printed on it a Quick Response (QR) Code.
The QR Code contains: (a) the 25 ticket or card numbers (there are 25 of them on the 5×5 matrix). These numbers are ordered in a 25 number sequence based on the position of each number on the 5×5 matrix; (b) a unique game ID; and (c) the date and time of the draw in a common time reference to allow for a draw to take place simultaneously in several different time zones.
The ticket purchased may also have a separate bar code on it that is used by the retailer, scanning it to: (a) at the time of sale, verify to the State Lottery Operator that the ticket has been sold and the entry fee received, and/or (b) after the draw, whether or not it is a winning ticket, including the amount of any winnings.

An example of a QR code is shown in FIG. 16.

The QR Code contains: (a) the 25 ticket or card numbers (there are 25 of them on the 5×5 matrix). These numbers are ordered in a 25 number sequence based on the position of each number on the 5×5 matrix; (b) a unique game ID; and (c) the date and time of the draw in a common time reference to allow for a draw to take place simultaneously in several different time zones.

QR Data (split with ‘,’ to show fields)

Numbers all stored as double digits thus first 50 characters, ID=7 characters, Date=remaining 20 characters

Numbers:

06,10,15,04,11,19,14,03,25,01,17,12,09,22,08,18,02,23,16,13,07,21,24,05,20

Unique game ID:

001234567

Date/Time/Zone:

2015,03,05, 20,00,00,GMT+04
In this Example 3, a free Link2Win™ mobile app is provided for all platforms—mobile, tablet or personal computer devices. For those players who wish to play Link2Win™ and who wish to experience and see the animated draw, they would download the free app onto their relevant device as a one-time download event.
Players then use the Link2Win™ app to scan the QR Code that is contained on their ticket. This loads the Link2Win™ ticket onto their mobile, tablet or personal computer device, along with the draw identifier (i.e. which draw), and the draw timing.
Similar to LOTTO, entries close at a set time prior to the State Lottery Operator undertaking the draw.
The State Lottery Operator undertakes the draw for the relevant Link2Win™ game in the same way as the operator would do a typical LOTTO draw. The State Lottery Operator would undertake the random draw of all 25 numbers involved in this example of the Link2Win™ game.
During or after the Link2Win™ draw, the draw can be announced in the same way as a typical LOTTO draw. It can be live or delayed. It can be via broadcast media, showing and or broadcasting the random draw of the 25 numbers. However, it is also important to be able to animate the Link2Win™ draw on a player's mobile, tablet or personal computer device so that the excitement and anticipation of the Link2Win™ game can be experienced by each player—should they wish to view the draw this way instead of watching it as a draw of 25 numbers on a broadcast medium, such as through a TV broadcast.
Animating the Link2Win™ draw on a player's mobile, tablet or personal computer device in this example is achieved by the downloaded app automatically downloading to the player's device, the results of the 25 number draw from the State Lottery Operator. This may be done in real time as the draw is happening, or it may be done shortly after the draw has been concluded. The app would be programmed to notify the player of this event.
The App would then, on command by the player, animate the draw on the player's personal computer device, and it would score their Link2Win™ ticket and identify prizes. Note: This play-out on the player's personal computer device is not a confirmation of any winnings or entry. It is the original ticket that was purchased that is the ONLY valid confirmation.
The player takes his or her original ticket to a relevant POS lottery retailer to confirm whether or not it is a winning ticket, and as relevant, to be paid his or her winnings.

### Example 3.6—Comparison of a Typical Transaction: LOTTO Vs Link2Win™

Table 19 below sets out a comparison of the ‘operational mechanics’ between:
a State Lottery Operator selling a typical LOTTO entry through a POS Lottery retailer and then undertaking the draw and paying winners; and
that same operator selling a typical Link2Win™ entry through the same POS Lottery retailer and then undertaking the draw and paying winners.

TABLE 19
Comparison Table of ′Operational Mechanics′

| Event | Typical LOTTO Entry | Link2Win ™ Entry |
|---|---|---|
| Purchase of Tickets | At POS retailer | At POS retailer |
| Valid Tickets | Original Ticket | Original Ticket |
| Closure of Entries | Say 1 hour before draw | Say 1 hour before draw |
| Draw | By State Lottery | By State Lottery Operator |
| | Operator | Live, by TV |
| | Live, by TV | Live, by Internet and/or |
| | Live, by Internet | By live or delayed |
| | | streaming to personal |
| | | computer devices |
| Publishing | Various Media | Various Media Channels |
| Results | Channels | Newspapers |
| | Newspapers | Radio |
| | Radio | Website |
| | Website/Internet | By streaming to personal |
| | | computer devices |
| Paying Valid | By POS retailer | By POS retailer |
| Winnings | Big winnings paid by | Big winnings paid by State |
| | State Lottery Operator | Lottery Operator |

### Example 3.7—Many Variations

As will be obvious to a person skilled in the art, there will be many ways to achieve the intended outcomes as we have described above.

### Example 3.8—Variations to Receive the Draw Information

Further there are also alternate ways to retrieve the results of the 25 number draw in order that a personal computer device can play out in animated form the results of a Link2Win™ game. For example, the results of the 25 number draw can be obtained:
From a State Lottery Operator's website, which displays a QR Code containing the draw information;
From a TV screen or similar display monitor, which displays a QR Code containing the draw information;
Manually, by typing into the player's personal computer device that has the free Link2Win™ app downloaded, the order of the 25 number draw obtained via a media release, although this is least preferred as among other things, it is cumbersome and very error prone.

### Example 3.9—Advantages

This Example 3 provides a number of advantages, including:

### For the Player:

It provides the excitement of an on-line gaming experience with all its visual effects.
It avoids potential exposure to online risks. For example it avoids potential risks associated with giving third parties over the internet access to banking information, such as credit card details.
It gives the player direct access to personal assistance and explanations, available via the POS lottery retailer outlet.

### For State Lottery Operators:

It uses and relies upon each operator's existing POS retailer network and logistics capabilities.
It maintains and enhances the important relationships that State Lottery Operators have with their POS retail outlets.
The transactions by which a player purchases a Link2Win™ entry ticket and cashes any winnings are the same as the current methods used by State Lottery Operators in respect of their existing transactions involving their typical LOTTO sales.
It should retain some players that might otherwise have migrated to other gaming operators in search of more visually exciting games to play.
Importantly, it ensures a greater control over preventing underage gambling, as the POS lottery retailers can use existing identification and verification methods to better guard against tickets being sold to underage players when compared to normal online gaming.

### Example 3.10—Link2Win™ Free App No Bearing on Game Results

It will be appreciated by a person skilled in the art that the animations and information enabled by the free download app are not essential to the relevant Link2Win™ game play and have no affect on the game's results. Its only purpose is to provide a useful means to display the results of a draw in an exciting and convenient way.

### Example 3.11—Variation Using ‘Other’ Lottery Games

It will further be appreciated by a person skilled in the relevant art that the use of certain aspects of this invention can be used by State Lottery Operators to provide a useful means to animate other lottery games in the same or similar way as described in this example, in which the results are to be animated, displayed or played out on a mobile, tablet or personal computer device, but where the other lottery games are offered for play by State Lottery Operators using their existing POS retail infrastructure and without players undertaking any online payment transaction to enter the other lottery games, or in the collection of their winnings.

Examples of other lottery games that would or could be suitable, include:
Virtual racing games e.g. virtual horse racing; virtual dog racing; virtual car racing.
Virtual competition or team games e.g. virtual soccer; virtual tennis; virtual NFL.
Casino type games.
Slot machine type games.
LOTTO games.
Scratch Card Games.

### Example 4.0—Link2Win™ for State Lotteries—Single Play Games

### Example 4.1—Background

The above Example 3 focuses on a Link2Win™ game that is sold over a set period of time by a State Lottery Operator to numerous players in what we refer to as a pooled game. This following Example 4 sets out the above previously described Example 3, but adapted for an instant game application, played by one player in a single play of the Link2Win™ game. We refer to this as the Single Play Game.

### Example 4.2—Key Elements of the Single Play Game

In this Example 4, the key elements are:
1. The single player and the State Lottery Operator do not make any transaction online.
2. The rules can state that the single player can only enter into the Link2Win™ game by purchasing a ticket from a POS lottery retailer.
3. The only valid ‘evidence’ of entry is the original ticket that is issued or given by the POS lottery retailer to the player at the time of purchase.
4. A winning ticket is presented by the player to the relevant POS lottery retailer, who then processes the ticket—e.g. confirm the ticket is valid and is a winning ticket; pay-out small prizes directly, refer big prize winners to the relevant State Lottery for processing by them.

### Example 4.3—Further Explanation of the Methods

By way of further explanation:
A player buys a Link2Win™ single play ticket at a POS lottery retailer outlet, in exactly the same way as if the player was purchasing a typical LOTTO ticket from the POS lottery retailer.
The POS lottery retailer issues the ticket following an online request to the State Lottery Operator, or following the relevant request to the computer equipment installed at the retailer's premises.
The issued ticket contains visible on its face a visual representation of a 5×5 matrix, with the ticket showing the placement of 25 numbers in the 25 squares. These placements of the 25 numbers may be all randomly placed on the 5×5 matrix by the gaming operator, or the player may select one or more numbers for placement in selected squares, with all other numbers randomly placed.
The issued ticket also contains visible on its face:
1. A random draw of 25 numbers, this being a unique and individual random draw for the Link2Win™ Single Play ticket. This random draw is printed on the ticket at the time of purchase, in a manner where the player only becomes aware of the order of the random draw after purchase of the ticket.
2. A Quick Response (QR) Code.
The Random Draw: This allows a player to review the order of the random draw and or to review the order of draw and based on that order, to manually search for links on the Link2Win™ Single Play ticket—if the player wishes to undertake this manual method to locate links and to identify winnings.
The QR Code: This QR Code contains:
   the positional placement on the 5×5 matrix of the 25 numbers on the issued ticket, being those 25 numbers that are displayed on the 5×5 matrix, all of which is displayed on the face of the issued ticket.
   The ticket's unique ID.
   The unique random draw of 25 numbers, and it is the order of this unique draw that will provide the outcome of the Link2Win™ single play game.
The issued ticket may also have a separate bar code that is used by the POS retailer, scanning it when it is presented by a player who wants to check it, or who claims it to be a winning ticket. The scan will confirm whether or not it is a winning ticket, including the amount of any winnings, and scanning it will provide the required advice to, and or to receive the required confirmations from, the State Lottery Operator.

An example of QR code is shown in FIG. 16.
In this Example 4, a free Link2Win™ mobile app is provided for all platforms—mobile, tablet or personal computer devices. For those players who wish to play the Link2Win™ Single Play Games and who also wish to experience and see the animated draw, they would download the free app onto their relevant device as a one-time download event.
Players would then use the Link2Win™ app to scan the QR Code. This loads the Link2Win™ Single Play ticket onto their mobile, tablet or personal computer device.
It also loads at the same time the random draw of all 25 numbers that is to be used to play-out the results of the game.
The App would then animate the draw on the player's personal computer device, and it would identify links on the Link2Win™ 5×5 matrix card and identify prizes. Note: This play-out on the player's personal computer device is not a confirmation of winnings or entry. It is the ticket that was originally purchased that is the ONLY valid confirmation.
The player takes his or her original ticket to the relevant POS lottery retailer to confirm whether or not it is a winning ticket, and as relevant, to be paid his or her winnings.

### Example 4.4—Many Variations

As will be obvious to a person skilled in the art, there will be many ways to achieve the intended outcomes as we have described above. This will include variations in respect of how to present the random draw on the ticket, which may be done by printing the draw on the underside of the ticket.

### Example 4.5—Advantages

This Example 4 provides a number of advantages, including:

### For the Player:

It provides the excitement of an on-line gaming experience with all its visual effects.
It provides the player with an instant game, by way of a single player game, and instant results.
It avoids potential exposure to online risks. For example it avoids potential risks associated with giving third parties over the internet access to banking information, such as credit card details.
It gives the player direct access to personal assistance and explanations, available via the POS lottery retailer outlet.

### For State Lottery Operators:

It uses and relies upon each operator's existing POS retailer network and logistics capabilities.
It maintains and enhances the important relationships that State Lottery Operators have with their POS retail outlets.
The transactions by which a player purchases a Link2Win™ Single Play entry and cashes any winnings are in all material respects the same as the current methods used by State Lottery Operators in respect of their existing LOTTO type transactions.
It should retain some players that might otherwise have migrated to other gaming operators in search of more visually exciting games to play, or in search of instant games.
Importantly, it ensures a greater control over preventing underage gambling, as the POS lottery retailers can use existing identification and verification methods to better guard against tickets being sold to underage players when compared to normal online gaming.

### Example 4.6—Link2Win™ Free App No Bearing on Game Results

It will be appreciated by a person skilled in the art that the animations and information enabled by the free download app are not essential to the relevant Link2Win™ game play and have no affect on the game's results. Its only purpose is to provide a useful means to display the results of a draw in an exciting and convenient way.

### Example 4.7—Variation Using ‘Other’ Lottery Games

It will further be appreciated by a person skilled in the relevant art that the use of certain aspects of this invention can be used by State Lottery Operators to provide a useful means to animate other lottery games in the same or similar way as described in this example, in which the results are to be animated, displayed or played out on a mobile, tablet or personal computer device, but where the other lottery games are offered for play by State Lottery Operators using their existing POS retail infrastructure and without players undertaking any online payment transaction to enter the other lottery games, or in the collection of their winnings.

Examples of other lottery games that would or could be suitable, include:
Virtual racing games e.g. virtual horse racing; virtual dog racing; virtual car racing.
Virtual competition or team games e.g. virtual soccer; virtual tennis; virtual NFL.
Casino type games.
Slot machine type games.
LOTTO games.
Scratch Card Games.

### Example 5.0—Link2Win™ for State Lotteries—Instant Link2Win™ Scratch Card Game

### Example 5.1—Background

Example 3 focuses on a Link2Win™ game that is sold over a set period of time by a State Lottery Operator via its POS retail network to numerous players in what we refer to as a pooled game. Example 4 describes a single play of the game.

This Example 5 sets out another example of an instant Link2Win™ game, but this time using scratch cards. We refer to this as the Link2Win™ Scratch Card Game. Scratch cards have information printed on a layer which is hidden by being overprinted with an opaque scratchable layer, and which becomes visible when the scratchable layer is scratched off.

### Example 5.2—Key Elements of the Link2Win™ Scratch Card Game

In this Example 5, the key elements are:
The single player and the State Lottery Operator do not make any transaction online.
The rules can state that the single player can only enter into the Link2Win™ game by purchasing a Scratch Card from a POS lottery retailer.
The only valid ‘evidence’ of entry is the original Scratch Card that is issued or given by the POS lottery retailer to the player at the time of purchase.
Winning Scratch Cards are presented by players to a POS lottery retailer, who process the Scratch Cards in the same way as they process a traditional scratch card—e.g. confirm the Scratch Card is valid and is a winning card; pay-out small prizes directly, refer big prize winners to the relevant State Lottery for processing by them.
Any Scratch Card can be presented to any relevant POS lottery retailer in order to confirm whether it is a winning or loosing Scratch Card.

### Example 5.3—Further Explanation of the Methods

By way of further explanation:
A player buys a Link2Win™ Scratch Card at a POS lottery retailer outlet, in exactly the same way as if the player was purchasing a typical scratch card from the POS lottery retailer.
The Scratch Card contains on its face a visual representation of a 5×5 matrix, with the Scratch Card showing the random placement of 25 numbers in the 25 squares.
The Link2Win™ Scratch Card has two hidden features printed on it, which are revealed by a player scratching those features clear. These hidden features are:
1. A random draw represented by the numeral 50 in the drawing of FIG. 16A. This being a unique and individual random draw of 25 numbers for that Link2Win™ Scratch Card.
2. A machine readable code 54 such as a Quick Response (QR) Code.

FIGS. 16A to 16C shows different stages in the printing of a preferred scratch card. FIG. 16 is an enlarged view of a QR code 54 that can be hidden on the card underneath a scratchable layer. FIG. 16A shows the random draw (50) of the 25 numbers printed on the base layer 51 of the card 52. Since this is a sequence of numbers it is shown as 6^{th}, 11^{th}, 14^{th}, 25^{th} (reading along the top line). A QR code 54 is printed in one corner of the card (see FIG. 16 and description below) and explanatory text 53 may be included on this layer.

The next stage is the overprinting of the base layer with an opaque scratchable layer 55 (typically a latex ink) that can be scratched off easily whilst resistant to normal abrasion. This stage is shown in FIG. 16B with the entire surface covered with the scratchable layer (although the text area 53 may remain uncovered).

Preferably the opaque scratchable layer is adapted to be overprinted with additional information as shown in FIG. 16C so that the finished scratch card shows the random placement 60 of the 25 numbers on its surface as well as text 63 and a bar code 64. The area covering the QR code 54 may also be overprinted with the Provider's logo or other information (not shown).

Not shown is another way of playing scratch cards. In this variation the player purchases a scratch card and scratches off the removable layer to reveal a matrix of numbers laid out in the matrix specified by the rules (e.g. a 5×5 matrix). The scratch card can also contain the QR code to identify details of the card. The hidden layer contains only symbols not links, as the draw can take place after the cards have been printed with the symbols using the numbers 1 to 25 within the matrix, each card having a different layout (i.e. a map of the locations of the numbers within its matrix). Once the numbers layout has been revealed the player can then compare the card batch ID to the relevant draw which may be broadcast in the media, or available from a website, or available at the vendor's kiosk, or in some other way.

By comparing the matrix to the draw the player can then identify links between sequentially drawn numbers and count how many there are on the card. In this situation it is preferable that the hidden layer is similar to the design of FIG. 6 in that the hidden layout is made up of the initial set of numbers printed in smaller type in one portion of each cell so that the there is room for the player to write in the ranking of that number and make to easier to identify links.

If he or she thinks they have enough for a prize they can have the card checked by the vendor reading the QR card and using his computer terminal to verify if a prize is available for that card layout.

In another variant, the hidden layer could have a number layout similar to that shown in the matrix of FIG. 16C, this time it is not a top layer and no numbers would be shown on the top layer. When the matrix is revealed by scratching the rules of the game may be that the links are formed or identified using consecutive numbers. The hidden numbers provide their own sequence or ranking as they are made up of the numbers from 1 to 25, hence it is easy to identify adjacent sequential numbers. In this case there would be 3×2 links on the matrix shown in FIG. 16C comprising the adjacent numbers (8 and 9), (23 and 24) and (15 and 16).

FIGS. 20 to 23 show a number of different scratch cards each with its own unique draw. As scratch cards from a single print batch will most likely be distributed widely it is desirable that the risk of collusion between players is minimized—hence the need for a unique draw on each card. FIGS. 20B to 23B show the different rankings applied to the cards, each ranking being a one-off ranking for that card.

In another example the player may be required to scratch and reveal the hidden numbers then pair up number sequences, 6 with 7 or 5, 11 with 10 or 12, etc. FIGS. 20C to 23C show the top/visible layer of the scratch cards whereas FIGS. 20C to 23C show the hidden layer containing the rankings and the links. This layer is covered by an opaque scratch-off layer as previously described. FIGS. 20B to 23B show the different rankings applied to each card so that for example the ranking shown in FIG. 23B is applied to card 23A to produce the hidden layer 23C with its resulting seven links.
The Random Draw: The random draw 50 of 25 numbers is hidden and can be revealed by scratching it clean. This allows a player to review the order of the random draw and or to follow the order of draw and based on that order, to manually search for links on the Link2Win™ Scratch Card—if the player wishes to undertake this manual method to locate links and to identify winnings. (Optionally, the links may also be printed on one of the layers (or the base layer) but covered by at least one scratchable layer). However we consider that this is unnecessary and best shown on the mobile app described below.
The QR Code: This QR Code is also hidden and can only be revealed by the player scratching it clean. This QR Code contains:
   the positional placement on the 5×5 matrix of the 25 numbers on the Link2Win™ Scratch Card, being those 25 numbers that are displayed on the 5×5 matrix, all of which is displayed on the face of the Scratch Card.
   The Scratch Card's unique ID.
   The Scratch Card's unique random draw of 25 numbers, and it is the order of this unique draw that will provide the outcome of the Link2Win™ Scratch Card game.
The Link2Win™ Scratch Card may also have a separate bar code (64) that is used by the POS retailer, scanning it to: (a) at the time of sale, verify to the State Lottery Operator that the Scratch Card has been sold and the entry fee received and/or (b) when presented by the player following its scratching, whether or not it is a winning Scratch Card, including the amount of any winnings.

An example of the QR code is shown in FIG. 16.
In this Example 5, a free Link2Win™ mobile app is provided for all platforms—mobile, tablet or personal computer devices. For those players who wish to play the Instant Link2Win™ Scratch Card Games and who also wish to experience and see the animated draw, they would download the free app onto their relevant device as a one-time download event. (A gaming console will also be described with reference to FIGS. 19A-C).
Once the QR Code that is contained on the Scratch Card has been scratched and is revealed, players would then use the Link2Win™ app to scan the QR Code. This loads the Link2Win™ Scratch Card onto their mobile, tablet or personal computer device.
It also loads at the same time the random draw of all 25 numbers that is to be used to play-out the results of the game.
The App would then animate the draw on the player's personal computer device, and it would identify links on the Link2Win™ Scratch Card and identify prizes. Note: This play-out on the player's personal computer device is not a confirmation of winnings or entry. It is the Scratch Card that was originally purchased that is the ONLY valid confirmation.
The player takes his or her original Scratch Card to a relevant POS lottery retailer to confirm whether or not it is a winning Scratch Card, and as relevant, to be paid his or her winnings.

### Example 5.4—Comparison of a Typical Transaction: State Lottery Scratch Card Vs Link2Win™ Scratch Card

Table 20 below sets out a comparison between:
a State Lottery Operator selling a typical State Lottery Scratch Card through a POS Lottery retailer and then paying winners; and
That same operator selling a typical Link2Win™ Scratch Card through the same POS Lottery retailer and then paying winners.

TABLE 20
Comparison Table of ′Operational Mechanics′

| | Typical State Lottery Scratch | |
|---|---|---|
| Event | Card | Link2Win ™ Scratch Card |
| Purchase of Scratch Card | At POS retailer | At POS retailer |
| Valid Scratch Cards | Original scratch card | Original scratch card |
| Closure of Entries | n/a - Instant Game | n/a - Instant Game |
| Draw or Outcome | Contained on the card. | Contained on the card. |
| | Revealed by Scratching | Revealed by Scratching |
| Identifying Winnings | Achieved by: | Achieved by: |
| | Player initially identifies | Player can initially identify |
| | manually | manually, or |
| | POS retailer scanning scratch | Player can use free Link2Win ™ |
| | card to confirm winnings, or | app to allow personal |
| | POS retailer visually confirming | computer to assist player by |
| | winnings on scratch card | locating links and identifying |
| | | winnings |
| | | POS retailer scanning scratch |
| | | card to confirm winnings |
| Paying Valid Winning | By POS retailer | By POS retailer |
| Scratch Cards | Big winnings paid by | Big winnings paid by |
| | State Lottery Operator | State Lottery Operator |

### Example 5.5—Many Variations

As will be obvious to a person skilled in the art, there will be many ways to achieve the intended outcomes as we have described above.

### Example 5.6—Advantages

This Example 5 provides a number of advantages, including:

### For the Player:

It provides the excitement of an on-line gaming experience with all its visual effects.
It provides the player with an instant game.
It avoids potential exposure to online risks. For example it avoids potential risks associated with giving third parties over the internet access to banking information, such as credit card details.
It gives the player direct access to personal assistance and explanations, available via the POS lottery retailer outlet.

### For State Lottery Operators:

It uses and relies upon each operator's existing POS retailer network and logistics capabilities.
It maintains and enhances the important relationships that State Lottery Operators have with their POS retail outlets.
The transactions by which a player purchases a Link2Win™ entry Scratch Card and cashes any winnings are the same as the current methods used by State Lottery Operators in respect of their existing transactions involving their typical scratch card sales.
It should retain some players that might otherwise have migrated to other gaming operators in search of more visually exciting games to play.
Importantly, it ensures a greater control over preventing underage gambling, as the POS lottery retailers can use existing identification and verification methods to better guard against Scratch Cards being sold to underage players when compared to normal online gaming.

### Example 5.7—Link2Win™ Free App No Bearing on Game Results

It will be appreciated by a person skilled in the art that the animations and information enabled by the free download app are not essential to the relevant Link2Win™ game play and have no affect on the game's results. Its only purpose is to provide a useful means to display the results of a draw in an exciting and convenient way.

### Example 5.8—Variation Using ‘Other’ Lottery Games

It will further be appreciated by a person skilled in the relevant art that the use of certain aspects of this invention can be used by State Lottery Operators to provide a useful means to animate other lottery games in the same or similar way as described in this example, in which the results are to be animated, displayed or played out on a mobile, tablet or personal computer device, but where the other lottery games are offered for play by State Lottery Operators using their existing POS retail infrastructure and without players undertaking any online payment transaction to enter the other lottery games, or in the collection of their winnings.

Examples of other lottery games that would or could be suitable, include:
Virtual racing games e.g. virtual horse racing; virtual dog racing; virtual car racing.
Virtual competition or team games e.g. virtual soccer; virtual tennis; virtual NFL.
Casino type games.
Slot machine type games.
LOTTO games.
Scratch Card Games.

### Example 5.9

In this example a gaming console has a camera to read a QR code and optionally a wireless (e.g. cellular or Wi-Fi) capability to receive or transmit messages. In its simplest form it can scan a QR code to play the game on the console.

In FIG. 19A the gaming console 15 is turned on and a pre-programmed instruction appears as shown. The player having purchased a scratch card as in FIG. 16C and revealed the QR code can then scan it using the scan button in FIG. 19B. This loads the play matrix into the console as well as the ranking sequence for the symbols. (The “buy” button is not needed where the player has purchased a scratch card—typically in those jurisdictions where online gaming is not allowed but the sale of a scratch card can be used allow a player to initiate a game on a gaming machine. The “buy” button is optional and can be used in those jurisdictions where the player can purchase the right to play a game via an online supplier—see the Example described with reference to FIGS. 24A to 24H).

To increase player interest the gaming console has a “ball” button which can be pressed (as shown in 19C) to reveal the rankings, preferably one symbol at a time, as if one ball had been randomly selected as in a game of Lotto or similar, (this being a simulation displayed on the VDU screen, the draw having been determined and stored in the hidden information in the scratch card, so that each scratch card can have its own unique draw). In this example (as with the game played on the scratch card) the first press of the “ball” button will reveal in this case that symbol 15 has been ranked 1^{st} and at the same time the screen will show the ball number and the change of the symbol “15” in the matrix to the symbol “1^{st}” as shown in the transition from FIG. 19C to 19D. At the same time the colour of the symbols (yellow for the first set) can change for ease of recognition to a second clout as the rankings are displayed (in this case we use yellow to show the rankings). Note that the drawings originally prepared for this specification were prepared in colour to make the drawings easier to understand. By FIG. 19E all of the symbols have been ranked and replaced by the rankings and links between adjacent sequentially ranked symbols are displayed as dark blue bars without obscuring the rankings, and the number of links is also recorded—in this case the player has total of 8 links.

### Example 6.0—Multiple Concurrent Games

### Example 6.1—3 Card Game

In this example we use three (3) matrix cards, and in this example the 3 matrix cards are each of a 5×5 matrix. This game preferably makes use of cards displayed on one or more VDUs depending upon the number of plays or players involved.
Card 1 to contain numbers 1-25
Card 2 to contain numbers 26-50
Card 3 to contain numbers 51-75

This example of the game can comprise of a single play of the game, or a multi play pooled game.

### Example 6.2—One Draw

Each play of the game involves the 3 cards described above. One random draw of 75 numbers is used to determine the outcome of the game, with each number drawn going to the relevant card that has the drawn number. Any number drawn that is in the 1-25 range goes to Card 1, any number drawn that is in the range of 26-50 goes to Card 2, and any number drawn that is in the range of 51-75 goes to Card 3.

FIG. 15A shows the draw of the 75 numbers for a play of the game.

FIG. 15B shows the coordinates in each of the three (3) 5×5 matrix cards. Note: Card 1 is the same as that shown in FIG. 13.

FIG. 15C shows the actual drawn numbers allocated to each card: Card 1 contains numbers 1-25; Card 2 contains numbers 26-50; Card 3 contains numbers 51-75.

FIG. 15D shows the ordinal ranking of each of the drawn numbers on each of the cards, and the results of the game: Card 1 has 4×2 Links; Card 2 has 3×2 Links; Card 3 has 1×2 Links.

### Example 6.3—The Odds

The odds for each of the 3 Link2Win™ Cards can be the same/similar as a single play of a single 5×5 Card as set out in: Example 1, Tables 10-11; and Example 2, Tables 16-17, if the drawn numbers for each card are given an ordinal ranking of 1^{st} to 25^{th} as relevant to the card and the linking processes are based on those assigned ordinal rankings. In effect, it would be the same as a player purchasing 3 individual cards in the games exampled in Examples 1 and 2.

When played as a group of 3 cards that are governed by a random draw of 75 numbers with the drawn numbers each given an ordinal ranking of 1^{st} to 75^{th} and placed accordingly on the relevant card, with the linking processes based on those assigned ordinal rankings, then the odds will alter. The size of the alteration will depend on the rules set.

### Example 7.0—Token Design Concepts

FIGS. 8-11 show a preferred form of design of the 25 virtual tokens for use in a Link2Win™ game played on a VDU terminal. It replicates the game played in a Bingo Hall with printed cards as described in example 1.0.

In a preferred form, the virtual Tokens 1 to 25 could be used that are dual colour, double sided and of same label. In this example the Tokens 1 to 25 are labelled on both sides with the same placing text. For example Token 1, would be labelled “1^{st}” on both sides—One side Red and the other Black.

Ideally the virtual Tokens would be shown on the screen of the computing device of the player(s) stacked in placing order prior to game start-see FIG. 8.

As the numbers are drawn and announced or presented the player(s) would place the corresponding Token (using drag and drop or similar feature) that represents the placing of the drawn ball the player would locate that number on the virtual imagery of the matrix card and cover it. For example the first drawn number would be covered with the “1st” Token. The second called number would be covered with the “2nd” Token and so on until all Tokens were used—see FIG. 9.

The Tokens would initially be placed with the same coloured sided showing (e.g. all Red). As prize lines such as 2 in a Row, 3 in a Row are realised by the player they could simply flip the relevant Tokens over at any time (for example by clicking on it or by tapping on it if the user's interface is a touch screen) to the alternate coloured side—see FIGS. 10(a) and 10(b). The same Placing text would be prevalent but the links would now stand out due to the different colours.

When the draw is complete all links are easily identified. In the case of 2 links meeting (such as a 3 line and a 2 line being connected (appearing as 4 in a row) the player will need to apply the rules for determining prizes. In the example just described there may be no 4 in a row link or a prize.

It is expected that when prizes are claimed the rules would automatically declare the prizes that comply with the rules.

### Example 8.0—Player Interaction—Rejecting Drawn Numbers

### Example 8.1—Background

The Link2Win™ games as described in Examples 1-7 are all random games of chance that play out till the end.

But some or all of these games could have a player interaction that would introduce an element of excitement and participation into the game. It would also reduce the odds of some of the outcomes. The following is best implemented using cards displayed on VDUs.

### Example 8.2—Rejecting a Drawn Number/s 1=1 Joker/s

An example of such a game is one where the player may reject one or more drawn numbers, with any rejected drawn number converting into a “Joker” symbol—the Joker symbol can then be used as any number required to complete a 3 Link or 5 Link sequence.

### Example 8.3—An Overview

The allowance for the player to reject a drawn number, and for that rejected number to convert into a Joker symbol, provides the player with participation, and strategy decisions that enhance the player's experience of the game.

In this Example 8:
There are a maximum of 3 rejections from a 25 number draw (relating to a 25 square matrix).
Each rejection turns into a “Joker” symbol that is placed on the matric square to which it belongs.
If for example the 3^{rd} drawn number from the random draw is to be rejected by a player—and becomes a Joker symbol, then in this example the next drawn number is to be classed as the 3^{rd} drawn number.
Joker symbols can only be used to complete a 3 Link or a 5 Link (but not a 2 Link).
Only one (1) Joker symbol can be used to complete a 3 Link.
Up to two (2) Joker symbols can be used to complete a 5 Link.
No SuperLink: If a number is drawn for the SuperLink square (see FIG. 13, coordinate 25) and it is rejected and converts to a Joker symbol, then the card cannot qualify for any SuperLink prizes as a player will always be able to convert a drawn number for this square into a Joker.

### Example 8.4—Explaining by Way of an Example

An example of this can be explained with reference to FIG. 13.

The table in FIG. 13 shows the coordinates, which we have assigned to each square on the 5×5 Matrix.

Assume (for ease of understanding) that:
coordinate 1 has the 1^{st} drawn number
coordinate 2 has the 2^{nd} drawn number
that the 3^{rd} drawn number is drawn for coordinate 4, which in this example, breaks the linking sequence for a possible 5 Link. This number is rejected by the player and becomes a Joker on the coordinate 4 square.
A new 3^{rd} drawn number is drawn and it is drawn to be placed on the coordinate 3 square. By this time the player's card has the opportunity to complete a 5 Link on the top 5 coordinates of the Link2Win™ card.

The above example as described in Example 8.4 can be varied to achieve similar or varying outcomes. For example:
More or less Jokers may be allowed into play;
Rejected numbers may be recycled into the draw, or into the end of the draw in order of rejection;
Rejected numbers can be limited, but they may be limited to more or less than 3 rejections per play.
Optionally, players could be given the option to preselect a set number of Joker positions, although this is not believed to be as desirable.
The next drawn number after a Joker may remain as its correct order of draw (e.g. if the 3^{rd} drawn number is converted to a Joker, then the next drawn number is still recorded as the 4^{th} drawn number). Jokers are used to complete Link sequences in accordance with the relevant game rules.

### Example 9.0—Player Interaction—Relocating or Shuffling Numbers

### Example 9.1—Allowing Players to Relocate or Shuffle Numbers on the Card

This is another example of allowing player interaction.

FIG. 14 shows a partial view of a 5×5 Link2Win™ Card. In this example of the game, a player is allowed to relocate or shuffle one or more numbers on a Link2Win™ Card in the hope of gaining an advantage.
All numbers remain in play as per the draw.
Players can only move or shuffle numbers on the Link2Win™ Card that have not been drawn in the associated random draw.
Players could be limited to moving or shuffling numbers as between adjacent squares or rows.

As this example involves moving or shuffling undrawn numbers, there is no change in the games odds, or prizes. The benefit is that it gives a choice of placement to those players that wish to have the opportunity to do so. Numbers 6 and 7 can be shuffled as they have not been drawn at this stage of the game. The links between numbers 10 and 12, and between 3 and 5 show that they were drawn sequentially (the draw is shown at the top of this figure) so that they fulfil the requirement of being in adjacent cells and sequentially ranked. This figure also shows that without a display of the rankling on or in a cell makes it difficult for the player to identify the links.

### Example 10.0—Player Interaction—Competition Involving a Pool of Players

In this example of the game, a competition amongst a pool of players is held. Similar to a poker competition, the objective of the game is to become the sole winner, achieved either by way of a single play of the game by the pool of players, with one winner emerging, or by the survival of a series of plays involving eliminations, where one winner emerges at the end.

The key elements of this exampled competition game are:
A pool of players are each given the same 5×5 Link2Win™ Card.
One random draw of 25 numbers is undertaken.
Each player can make individual choices to reject drawn numbers as they occur, and turn those drawn numbers into Jokers in the same way as set out in Example 8.
Each player will be able to reject drawn numbers up to a set maximum number of rejections, say up to 10, or as otherwise set by the rules of the relevant competition game.
The Jokers can be used to create Links in the same way as set out in Example 8, or as otherwise stipulated by the rules of the relevant competition game.
The winner is the player with the best card, as determined by the rules set out in Examples 1.4-1.8, or as otherwise set by other rules of the relevant competition game.

### Example 11.0—Player Interaction—Competition Involving a Player Competing Against a Computer

In this example of the game, a competition involving a player competing against a computer is held. Similar to computer chess, the objective of the game is to beat the computer.

The key elements of this exampled competition game are:
The player and the computer are each given the same 5×5 Link2Win™ Card.
One random draw of 25 numbers is undertaken.
Each of the player and the computer can make individual choices to reject drawn numbers as they occur, and turn those drawn numbers into Jokers in the same way as set out in Example 8. The player will not know the computers choice at the time the player makes his/her choice. The computer would ignore the player's choice in its decision making processes.
Each of the player and the computer will be able to reject drawn numbers up to a set maximum number of rejections, say up to 10 for each of them, or as otherwise set by the rules of the relevant competition game, including that the computer may be set with a lower or higher amount of rejections as the player may wish to determine, depending on the skill level of the player.
The Jokers can be used to create Links in the same way as set out in Example 8, or as otherwise stipulated by the rules of the relevant competition game.
The winner is the player or the computer with the best card, as determined by the rules set out in Examples 1.4-1.8, or as otherwise set by other rules of the relevant competition game.

### Example 12.0-5×5 Matrix Game—Variations for 2 Link Prize Profile

In this Example 12 we set out three variations to the 2 Link prizes of a standard game that can be adopted or adapted for used in some or all of the above exampled games, in particular those games exampled in Example 1.18, Table 10, and Example 2.4, Table 16.

The following three variations further demonstrate the flexibility of the prize pay-out structure of this invention.

### Example 12.1—Three Variations

Table 21 below sets out three examples of how the 2 Link prize profile in a standard play of a game (based on an exampled £5 entry fee as used throughout) can be altered to suit the requirements of a Gaming Operator and/or its players.

TABLE 21
Standard Game (excluding SUPERLink)

| Number of | | | |
|---|---|---|---|
| 2 Links | Prize Variation 1 | Prize Variation 2 | Prize Variation 3 |
| 18+ | £1,000,000.00 | £1,000,000.00 | £1,000,000.00 |
| 17 | £50,000.00 | £50,000.00 | £50,000.00 |
| 16 | £10,000.00 | £10,000.00 | £10,000.00 |
| 15 | £1,000.00 | £1,000.00 | £1,000.00 |
| 14 | £100.00 | £100.00 | £100.00 |
| 13 | £50.00 | £50.00 | £50.00 |
| 12 | £25.00 | £25.00 | £25.00 |
| 11 | £10.00 | £10.00 | £10.00 |
| 10 | £5.00 | £7.50 | £7.50 |
| 9 | £3.00 | £0.00 | £0.00 |
| 8 | £2.00 | £5.00 | £5.00 |
| 7 | £1.75 | £0.00 | £0.00 |
| 6 | £1.50 | £5.00 | £4.00 |
| 5 | £1.25 | £0.00 | £0.00 |
| 4 | £1.00 | £5.00 | £3.00 |
| 3 | £0.75 | £0.00 | £0.00 |
| 2 | £0.50 | £5.00 | £2.00 |
| 1 | £0.25 | £0.00 | £0.00 |
| 0 | £0.00 | £15.00 | £15.00 |

### Example 12.2—Many Variations

In addition, a person skilled in the art will appreciate that there are many variations that can be made and that when making adjustments to one set of prizes (in this Example 12, we do this to the 2 Link prizes), other adjustments may need to be made to the other 3 and/or 5 Link prizes in order to maintain target pay out rates and the target percentage of the total gaming revenues to be retained by the Gaming Operator/Link2Win™.

### Example 13.0-5×5 Matrix Game—“2 Links” Only with “Killer” Squares

In this Example 13 we set out a variation where the rules of a game played on a 5×5 card only recognise the 2 Link category, and not the 3, or 5 Link categories as recognised in the games set out in Examples 1 and 2. This example also introduces a method to reduce winners based on the operation of an in game feature, which we refer to as “Killer” squares.

### Example 13.1—4 “Killer” Squares

In this example we use:
Links comprising 2 symbols/numbers, overlapping (as opposed to discrete);
4 “Killer” squares on the Game Play Area (a 5×5 card);
Prizes up to 19+ Links

In this example, a Killer square is operative if the last drawn number from the associated random draw of the 25 numbers lands on one of the Killer squares contained on the card. As the results of this exampled game are based on a random draw and are random, it makes no difference where on the 5×5 card the 4 Killer squares are positioned.

In the event that the last drawn number lands on a Killer square, some or all of the prizes that a player would otherwise have won, are lost. At 4 Killer squares, the operative effect is to only eliminate prizes from, on average, about 1 in 6 of all games. This is calculated as to 4 divided by 25.

This feature of “Killer” squares adjusts odds and outcomes of the relevant game and it adds to player engagement and suspense.

### Example 13.2—Odds and Prizes

Tables 22 and 23 below sets out the Odds, Prize award levels (up to 19+ Links) and the prizes for each award level for a Standard game and a SUPERLINK game.

In this example, A SUPERLINK Game is not affected by any operation of a Killer square and all prizes associated with a SUPERLINK game are won. The 4 Killer squares are located on squares other than the SUPERLINK square.

TABLE 22
Standard Game

| | | Example Prizes |
|---|---|---|
| No. of | | Standard Game |
| 2 Links | Odds: 1 in . . . | 4 Killer Squares |
| 19+ | 258,875,739.6 | £2,500,000 |
| 18 | 20,554,381.0 | £500,000 |
| 17 | 1,990,445.9 | £50,000 |
| 16 | 241,886.4 | £5,000 |
| 15 | 36,057.3 | £3,000 |
| 14 | 6,517.0 | £2,000 |
| 13 | 1,418.5 | £50 |
| 12 | 370.0 | £25 |
| 11 | 115.4 | £20 |
| 10 | 43.1 | £13 |
| 9 | 23.1 | £10 |
| 8 | 12.5 | £8 |
| 7 | 8.2 | £7 |
| 6 | 6.6 | £5 |
| 5 | 5.5 | — |
| 4 | 7.1 | — |
| 3 | 12.3 | — |
| 2 | 30.0 | — |
| 1 | 117.0 | — |
| 0 | 968.6 | — |

TABLE 23
SUPERLINK Game

| | | Example Prizes |
|---|---|---|
| | | SUPERLINK |
| No. of | | Game 5 |
| 2 Links | Odds: 1 in . . . | 4 Killer Squares |
| 19+ | 4,166,666,666.7 | £5,000,000 |
| 18 | 331,439,393.9 | £1,000,000 |
| 17 | 33,320,639.8 | £100,000 |
| 16 | 4,236,672.6 | £10,000 |
| 15 | 655,308.0 | £6,000 |
| 14 | 122,394.6 | £4,000 |
| 13 | 27,534.9 | £100 |
| 12 | 7,408.4 | £50 |
| 11 | 2,383.8 | £40 |
| 10 | 915.7 | £26 |
| 9 | 421.7 | £20 |
| 8 | 233.9 | £16 |
| 7 | 157.6 | £14 |
| 6 | 130.6 | £10 |
| 5 | 135.3 | £7 |
| 4 | 180.0 | £7 |
| 3 | 319.5 | £7 |
| 2 | 805.2 | £7 |
| 1 | 3235.9 | £7 |
| 0 | 27,628.0 | £7 |

### Example 13.3—The Killer Square Effect

Tables 24 below contains a summary of the 4 Killer square effect.

The reference to “Engagement %” in the table below is the percentage of players that are on a winning prize award before being reduced by the effect of the 4 Killer Squares (about a 1 in 6 reduction):

TABLE 24
4 Killer Squares Effect

| | Prize | | | | |
|---|---|---|---|---|---|
| | Steps | | | | |
| | affected | | | | Minimum |
| | by Killer | Engagement | Engagement | Minimum | Win |
| Example | Squares | % | Odds | Win as % | Odds |
| 1 | 3 | 55% | l in 1.82 | 48.25% | 1 in 2.07 |
| | (6-8 | | | | |
| | Links) | | | | |
| 2 | 4 | 55% | l in 1.82 | 47.39% | 1 in 2.11 |
| | (6-9 | | | | |
| | Links) | | | | |

### Example 13.4—Advantages of Killer Squares

One of the advantages for a gaming operator using the “Killer” squares method as exampled, is that more player engagement can be achieved both in respect of a player being closer to being on a prize award level and actually being on a prize award. Another advantage is that the final percentage of actual winners in a game can be fine-tuned by a gaming operator by increasing or decreasing the number of “Killer” squares to meet its desired results.

### Example 13.5—Many Variations

This example uses 4 Killer squares. But there could be more or less used.

The effect of “Killer” squares can be obtained in other ways. For example, the 5×5 card could contain no Killer squares and instead, the same effect can be achieved by use of the 25 random draw numbers, randomly giving 4 of those numbers a Killer colour. If the last drawn number is one that is a Killer colour, then the same outcomes can be achieved.

A person skilled in the art will appreciate that there are many variations that can be made.

### Example 14.0-5×5 Matrix Game—Variations for Additional Side Bets

In this Example 14 we set out an example of a further variation to a standard game that can be adopted or adapted for use in some or all of the above exampled games, in particular those games exampled in Example 1.18, Table 10, and Example 2.4, Table 16.

### Example 14.1—Additional Side Bets

In this example, a player would enter into a Link2Win game by purchasing a Card in one of the games set out in Examples 1 and 2, and the player would have the option to purchase at a cost of £1 for each extra bet purchased, one or more side bets in the same game.

Table 25 below sets out exampled side bets.

TABLE 25
Standard Game (excluding SUPERLink) - Side Bets on 2 Links

| | | Offered Odds: | | |
|---|---|---|---|---|
| | | A £1 side bet | | |
| | | offered against | | Prizes |
| Each Event | Actual Odds: | Each Event, | | Each |
| Number of | Each Event: 1 in . . . | one £1 bet per | | Event/Outcome |
| 2 Links | (Source: Table 16) | event | | Each £1 bet |
| 18+ | 22,531,098.9 | 7,500,000 | to 1 | £7,500,000 |
| 17 | 2,299,651.3 | 750,000 | to 1 | £750,000 |
| 16 | 275,111.2 | 100,000 | to 1 | £100,000 |
| 15 | 40,538.4 | 30,000 | to 1 | £30,000 |
| 14 | 7,233.7 | 5,000 | to 1 | £5,000 |
| 13 | 1,555.0 | 1,000 | to 1 | £1,000 |
| 12 | 400.8 | 300 | to 1 | £300 |
| 11 | 123.5 | 80 | to 1 | £80 |
| 10 | 45.5 | 30 | to 1 | £30 |
| 9 | 20.1 | 15 | to 1 | £15 |
| 8 | 10.7 | 7 | to 1 | £7 |
| 7 | 6.9 | 5 | to 1 | £5 |
| 6 | 5.5 | 4 | to 1 | £4 |
| 5 | 5.4 | 4 | to 1 | £4 |
| 4 | 7.0 | 5 | to 1 | £5 |
| 3 | 11.8 | 8 | to 1 | £8 |
| 2 | 28.6 | 20 | to 1 | £20 |
| 1 | 109.9 | 75 | to 1 | £75 |
| 0 | 898.4 | 600 | to 1 | £600 |

### Example 14.2—Many Variations for Side Bets

The above exampled 2 Link side bets are offered at odds that are set at circa. two-thirds of the actual odds, except for the very high odds where it is assumed for the purpose of this example that the side bets with the very high odds (16-18+2 Links) are offered as an insured prize offering. Further, the above exampled 2 Link side bet prizes can be increased or decreased in order to achieve certain target pay out rates (return to player (“RTP”)) as may be determined from time to time by a Gaming Operator.

A person skilled in the art will appreciate that there are many variations that can be made to any side bets and that the above side bets are set out by way of example only. For example side bets can be offered for 3 and/or 5 Links and/or SuperLink outcomes in respect of any of them.

### Achievement Scoring

FIGS. 18A through to 18D each show a simulator where points are awarded for achieving 2-Link connections while playing the game. The same process other than the point values shown in table [3] applies for acquiring larger links e.g. 3 & 5 links but are not shown here. Due to fewer permentations of larger 3 & 5 links there will be fewer columns and rows in the respective tables.

The reference numerals used on those figures denote the following:
1. Description of the Link (in this example all links are 2 placings)
2. Points achieved based on the number of links acquired during the game.
3. Overall table of achievable points.
4. Indicates the number of Links acquired as the game progresses.
5. The Points value of the current link as played.
6. The total accumulated points from all links acquired.
7. Indicates which column is being used to calculate the points.
8. Active Points being totaled as displayed by [6]

FIG. 18A shows that a link comprising 25^{th} & 24^{th} Placed numbers has been achieved and is highlighted in the LINK column [1]. As this is the First link obtained (as indicated in display [4], the points in column 1 [7] are used.

[5] shows that the value for this Link is currently 1 point. [6] indicates that the total points from all Links thus far is 1 point.

FIG. 18B shows that a 2^{nd} Link has be acquired as indicated in the Link Counter display [4].

The New Link is comprised of 23^{rd} & 24^{th} placed numbers as highlighted in the LINK column [1].

Because this is the second Link acquired the Active Point Range [7] now shifts to the 2^{nd} column. This new link has a Point value [8a] of 26. The previous Link (24^{th} & 25^{th}) [8] gets upgraded from 1 point to 25 Points.

The Total Score [6] is now 25+26=51 Points.

FIG. 18C show the result of a 3^{rd} Link (12^{th} & 13^{th}) being acquired. As a result the Points [8] are calculated on column 3.

The previous Link Points [8] & [8a] are upgraded to values in the 3^{rd} column and added to the new Link's 61 Points[8c] thus making the total score 160 Points [6].

The process as shown in the previous FIGS. 18A to 18C continues until the last link is obtained.

FIG. 18D shows the case where every possible 2-Link connection is achieved thus all points [8^{˜}] are summarised in the Last Column.

### Example 15—FIGS. 24A to 24H—Handheld Online Gaming Console

This gaming console will be described with reference to the FIGS. 24A to 24H, as follows.

FIG. 24A shows the Player presses the Web access button to access online game cards.

In 24B: Player presses the “CARD” button to start the selection of preset randomly generated cards. Player presses the Left-Right cursor buttons to scroll & view the card selection.

Player presses the Card button again to select the currently viewed card.

24C: The player has the option to rearrange the card numbers by sliding them around the screen. When a number is dragged from 1 location to another the numbers swap location as shown.
24D: Once the player is satisfied with the layout they press the BUY button (it can also be called the CONFIRM button where the player does not play for money) to purchase and lock the card to the game server. A stack of 25 tokens representing a random ranking draw is presented on screen.
24E: Table showing the draw from the server. This is preferably progressively presented to the player as the game is played. At this stage the player may only see the unlabelled stack of Tokens.
24F: Each press of the Play button will cause the Top token to spin towards the card and land on the predetermined number corresponding to the draw. E.g Number 22 was the first drawn number so the “1^{St}” token lands on card position 22.
24G: Subsequent presses of the Play button cause each token to be played. This image shows the card just prior to the 10^{th} Token landing on Number 4.

The card shows that 2 links have already been made between 2^{nd}-3^{rd} and 4^{th}-5^{th}.

Holding the play button down may cause the game to rapidly draw the tokens so that a game may only last 3-5 seconds if desired.

At the top of the screen a scrollable score table shows the draw progress thus far.

Tapping this table on the Blue arrow or the Use of the Left-Right Cursor keys will enable all currently drawn numbers to be viewed.

24H: The game is complete. 5 links have been created and a prize is awarded.
Pressing the Card button will give the option of playing further games. Pressing the blue Online button will close the online session. After several minutes of inactivity the device will log off. However the state of the game will be stored, so that any games on the VDU can recommence from the position where they left off, if games were not completed.
In all cases, the user is challenged by a username/Password authentication process when connecting to the online service.

### Example 16—An Example of Market Literature

FIGS. 12A, 12B, 12C and 12D are respectively the first, second, third and fourth pages of one example of a marketing literature (such as a pamphlet) that can be made available to potential gaming operators, investors or members of public in order to demonstrate the Link2Win™ game and a method of playing the game in a simple yet effective manner.

A screenshot of videos demonstrating the game is printed on page 4 of the marketing literature shown in FIG. 12D.

The demonstration videos can be uploaded on the internet and the web links/URL of the videos may be printed on the marketing literature so that the reader of the marketing literature can view the demonstration videos from the web link or the URL printed in the marketing literature.

The contents of the marketing literature shown of FIGS. 12A to 12D are self-explanatory and therefore need not be explained in further detail.

### Very Different to Bingo

A skilled person will realize that the Link2Win™ game of the present invention is very distinct from existing bingo games. Some of the differences between existing bingo games and the exampled Link2Win™ games of the present invention are that, in the exampled Link2Win™ games:
The matrix card player plays all the n numbers, in this case n is 25.
Every card achieves a “Blackout” as all n numbers are drawn and each player has positioned all n numbers on the Link2Win™ card.
Players/Participants number choices are converted to the ordinal number, recording each numbers ranking that arises from the separate but associated random draw of the n numbers.
Players/Participants must link their numbers to other numbers on their card based on rules (in this case the next drawn number) to match patterns (in this case straight lines, either vertical diagonal or horizontal).
In a pooled game, the game enables all winning cards of a prize to be ranked against each other so that the game produces with substantial certainty one single overall winner, or a set number of ranked winners (for example such as 1^{st} ranked to 10^{th} ranked) derived from the ranking system.
Numerous prize-winning events can occur, including from having no matches or links.
As exampled in Example 13, numerous side bet opportunities can occur as a consequence of the various outcomes generated within each play of the game.

It will be clear that a large number of variations exist and the above descriptions are by way of example only.

### Prize Information:

### ‘Bingo’ Style Applications of Link2Win

Although the game can be played without monetary prizes it will be understood that in most jurisdictions where Bingo or other games of chance are legal that the advantage of the game is that it can be played with a large number of players for very large monetary prizes.

The following examples explain how it can be played in a manner similar to Bingo but using the idea of links between adjacent cells. We have called this variant BINGO Link in the following description. The core structure of this example is as follows:

In each play of the BINGO Link game, a Player gets 4 cards and the entry fee for each play is £5.00.

Each card is of a 5×5 configuration, with each card having 25 numbers randomly placed on it—pre-printed when used physically in a BINGO Hall, electronically when played in e-gaming situations.

A Player can have multiple plays in each BINGO Link game, e.g. a player can have 1, 2, 3, or 4 or even more plays, with each play costing £5.00 and comprising 4 cards.

The results of the game are determined by a random draw. The 25 draw numbers are randomly drawn to record a Draw Order for each number drawn.

A player scores each of his 4 cards. The player counts or records the number of links scored on each card, or this can be done for the player when used in e-Gaming situations.

### The Pari-Mutuel Prize

In this example of the BINGO Link game, the entry fee is £5 per each play of the game (4 cards). £1.66 is set aside for the big prizes—as set out and computed in the table below.

This leaves £3.34, less the game operator's take, for accumulation in the Pari-Mutuel Prize Pool—to be won by a single winner of the BINGO Link game.

Player Pool Liquidity:

Each game is intended to be run every [5] minutes. To ensure game liquidity, the game operator/house underwrites a minimum number of entries say 100, and takes any shortfall. The house would participate as a player in any shortfall and it would win as if a player, but its winnings would not amount to any actual cash winnings. This is purely to create odds so that a minimum pari-mutuel prize is always on offer.

### Winning the Pari-Mutuel Prize is Simple

First Alternative: As the 25 number draw progresses, the player that first gets to a predetermined number of Links on their card/s wins. For example the first player to reach [10] Links on a card wins. This is like a race. The first player to reach 10 links can shout “Bingo”, or when online press the Bingo button. In the event no player reaches [10] links, if a guaranteed winner is desired, then the winner can be determined in accordance with the methods set out in the Second Alternative.

Second Alternative: After the full 25 draw numbers are randomly drawn, the player with the most number of Links on their card/s wins. The preferred way is best card (i.e. the card with the most Links) determines this, with ties between players sorted by reverting to a tied player's second, third and/or fourth card scores as necessary.

The Winner Scoops the Jackpot—being a pari-mutuel prize. The size of this prize depends on the number of player entries, and the price of each entry, less amounts held against guaranteed prize offerings (discussed below) and the rake by the game operator.

When a winner is determined part way through a draw (the First Alternative), the draw will still continue to determine any winners of the big prizes set out below. If there is no winner, because no player got to [10] Links on any card and the game rules do not require a guaranteed winner, then the pari-mutuel prize would jackpot to the following game.

The Big Prizes that ‘May’ be Won

Big Prizes in this example of the game are always on offer—irrespective of the size of the player pool, and are won by any player that achieve the relevant prize event.

For example:
$1,000,000 for any of the 4 Cards with 18 Links and above
$100,000 for any of the 4 Cards with 17 Links
$10,000 for any of the 4 Cards with 16 Links
$1,000 for any of the 4 Cards with 15 Links
$500 for any of the 4 Cards with 14 Links

These big prizes do not need to accumulate in size like an ordinary jackpot accumulation. From the first play of the game, these big prizes are always on offer as they can be insured against where the size of the offered prize is outside the risk limits of the game operator.

Using insurance at a cost of 2x the risk, the cost of covering the above guaranteed prizes, and the odds of winning them, are set out in the table below:

| Event | | Odds | |
|---|---|---|---|
| No. of Links | | 1 in . . . | Cost of Insurance |
| in respect of any of | | (approx. and | (approx. and |
| the 4 Cards | Prize | rounded) | rounded) |
| 18+ | £1,000,000 | 5,100,000 | £0.50 |
| 17 | £100,000 | 500,000 | £0.50 |
| 16 | £10,000 | 60,000 | £0.40 |
| 15 | £1,000 | 9,000 | £0.10 |
| 14 | £500 | 1,630 | £0.16 |
| | | | £1.66 |

There can be many possible variations of BINGO Link.

For example:
a game play could comprise less or more than 4 cards.
Players might need to get more or less than [10] links on a game play card to win the pari-mutuel prize.
The Game Play Area could be more or less than a 5×5 area. In circumstances where it is desirable to have a longer draw period (in particular in chat session applications of the game), the card configuration could be 6×6; 7×7 . . . etc.
Card shapes could be rectangular, or they could be of other shapes as described for example with reference to FIGS. 17A to 17AA.
Instant prizes could be given, for example the first player to have a set of cells drawn—see FIG. 29A which shows four cards each with a red “X” marked out so that if a player calls out that he or she has a card where the “red” cells have all been drawn they will win a prize. Since the 5×5 matrix ensures that all 25 numbers are drawn and ranked there is a possibility that if there are enough players (say 1000 or more) then a winner may be declared after 9 draws (the earliest that all 9 red cells will be picked) but with say about 100 players it may take a least 12 draws before a winner is declared for this part of the game. FIG. 29B shows that the game can continue until all 25 numbers have been drawn and the number of links per card are counted so that the allocating of larger prizes can also be determined based on the number of links.
Other instant prizes can also be based on for example a player recognizing that two of his or her cards have the same number of links (note that this has not occurred in the results of the game in FIG. 29B as all four cards have a different number of links). If for example a player has two cards each with 3×2 links then a small prize could be allocated for this combination of cards.

### Example 17—Casino Machine

FIG. 25 shows a schematic view of a casino machine, with provision for payment by way of a credit card or other payment mechanism, machine having four buttons, and a VDU displaying four virtual cards as well as four stacks of virtual tokens to mimic the play of a card and token game described above. At the top of the VDU screen there is a banner which displays the ranking of the symbols which appear on the cards.

Each of the four cards shows the 25 symbols being the numbers from 1 to 25, with each of the numbers appearing at a different physical location on the separate cards. The player will be given a choice of starting a game by pressing the “card” button, and depending upon the cards displayed may pay for a standard bet, or may be given the opportunity to bet an increased amount, as repeated pressing of the “bet” button will allow the amount of the bet to be increased or decreased (not shown) and when the player is ready to play he or she can press the pay table button to make the payment and commence a game. The “flip” button allows the player to control the speed of play as each time the button is depressed a number will be displayed with its ranking (this could be a real-time draw for the next symbol to be selected but is more likely to be the display of one symbol at a time from a pre-selected draw for that game, the pre-selection may have been completed in the time taken for the player to place his or her bet). At that press of the flip button the corresponding virtual token will move from the stack onto the appropriate location on a card. Since a player has chosen four cards, these can be played simultaneously, and as numbers are chosen and their ranking is displayed in the top banner this will scroll across the screen to allow players to watch the progress of the virtual tokens and to look for and identify links on each of the cards.

The screenshot in FIG. 25 shows that the first 10 numbers have been selected, and the 10^{th} selection is number four, so the relevant ranked token is shown moving from the stack to position of number four on each card. For example in the first card shown at the top left of the screen the symbol 4 is located towards the bottom of the fourth column counting from the left, but in the bottom left card the symbol 4 is in the fifth column and the second row.

Either or both the Casino machine and/or the Game server to which it is connected has an internal map of the virtual cards displayed on the screen and a provision to count the number of links on each of those cards to determine if the player has one or more cards having a sufficient number of links to justify the allocation of a prize. It will be appreciated that the amount of the prize, the number of links required, or other permutations such as having two or more cards with the same number of links for a prize allocation will be part of the rules of the game and published in association with each casino machine.

FIG. 26 shows three such machines connected via a local area network to a game server which can control the play, record the outcomes and allocate prizes. So far as a player is concerned it does not matter if the draw is unique to their casino machine, or if the draw is a casino wide draw for players all participating in a game at that time.

### Example 18—Online Gaming Machines and Interaction with Servers

FIGS. 27 and 28 show the schematics for the online game server previously described with reference to FIGS. 24A to 24H.

FIG. 27 shows that the gaming machine has a microprocessor and a communications module allowing it to access information from a game server, and to make a payment to a payment server. The microprocessor may also receive input from a camera so that it can read a QR code or other machine-readable code in order to allow it to play an off-line game as previously described. In these gaming machines it is preferable that a game involves a one-off draw, as is the case with the scratch card versions of the game, in order to minimise the risk of collusion between players.

### Example 19—VDUs for a Bingo Hall

FIGS. 29A and 29B show a desk like VDU for use in a bingo hall in which a large number of players can be seated at their desks or tables in order to play a game where the numbers or symbols are called out by the promoter. Four cards per VDU are shown as this is a convenient number for players to watch and also allows for other prize allocations, e.g. where two or more cards have a matching number of links.

With the VDU's as shown in FIGS. 29A and 29B it is still possible to call out the symbols as they drawn, but at the same time the VDUs at these venues may be connected either wirelessly or through some suitable wired network such as a local area network in order to receive and transmit information to and from a game server. The functionality these machines can be the same as that of the handheld gaming machines or the casino machines.

FIG. 29A also shows the layout of four cards each with a red X pattern as previously described.

### Variations

The above examples describe linking numbers (2, 3 or 5 numbers) in a straight line, in order or in reverse order on a matrix card, as determined by or in reference to a random draw of the n numbers. However, it is possible to use any patterns other than straight lines. For example, a diamond shape pattern, which could be 8 in a row to form the diamond shape, could be used and the prize could be allocated accordingly. Similarly, other patterns of any other shape and sizes are possible such as but not limited to triangular, Z-shaped, L-Shaped, U-shaped, hexagonal etc. Random patterns could be used, as long as the linking criteria set out in the rules of the relevant game were met.

Similarly, the symbols or numbers that the player plays need not be 25 and can be more or less than 25. For example a Link2Win™ game consisting of 36 n numbers and a 6×6 Link2Win™ card (containing 36 squares) could be established using the features of this invention, but incorporating more prize winning opportunities (e.g. linking 2, 3, 4, 5 and/or 6 numbers linked in order, or in reverse order) and bigger top prizes, which are created as a consequence of the greater odds that result from the 6×6 expanded Link2Win™ game.

The size of the Link2Win™ card or board can be smaller or bigger than a 5×5 matrix consisting of 25 squares or grids. Also, the matrix need not be a square matrix. It may be a matrix of a regular or other such recognisable shape, such as a rectangular matrix of any n×y dimension, for example, a 6×3, or a 10×7 rectangular matrix. Alternatively, it may be a matrix consisting of an odd or irregular shape. A variety of such examples are shown in FIGS. 17A to 17AA (27 different examples).

The matrix may be represented by one single line of symbols (as it can be translated into a 2 dimensional matrix based on the order of the symbols). However for ease of play (and understanding by players) they will prefer to see a 2 dimensional layout of the symbols on a printed card or screen in order to recognise links between adjacent cells. However the computing device described in our co-pending patent application need not store the cell numbers in a physical 2 dimensional matrix. The single line could be straight and therefore not joined at each end, such as 25×1 lines, or a 50×1 line or even greater. Alternatively, the single line can be of some other shape, and may be joined at each end, such as a single line comprising the outside line of a circle, or square etc.

The Game Play Area(s) to be used need not be limited to a Link2Win™ card or board. The Game Play Area can be any two-dimensional or multi-dimensional area that can be used when placing three or more symbols at the Game Play Area, with the symbols being placed at the area in a regular or irregular spatial arrangement, so that some symbols are bordered by or are close to other symbols and in accordance with the rules of the relevant game one or more relationships between any two or more of the symbols at the Game Play Area, can occur.

The Game Play Area to be used may include any visual representation of a matrix comprised of any grouping (including any multi-dimensional grouping) of “squares”, “circle”, “rectangle” hexagon”, or “diamond” shape or object on a Card, including but not limited to a grouping comprised of z x z shapes or objects (e.g. 5×5; 6×6), or z x y squares (e.g. 4×5; 4×6), or any ordered or disordered configuration of shapes or objects.

Any size, shape and/or colour of the real and/or or virtual tokens may be used.

In some of the examples described above, SUPERLINK is played by any/all players that correctly get the 25^{th} drawn number. The use of the 25^{th} drawn number as the SUPERLINK number can be changed to any other drawn number. Also, more than one number can be used as the SUPERLINK number. For example, the 24^{th} and 25^{th} drawn numbers can be used as the SUPERLINK numbers. Any player getting one of those numbers could qualify for SUPERLINK. Also, it is possible to have two, three or even more combinations to be used as the SUPERLINK numbers where players need to correctly get just one of the numbers (or alternatively they might need to get more than one of the numbers). A person skilled in the art will appreciate that with just 1 number as the SUPERLINK number in Examples 1 and 2 of the 5×5 matrix game, or any other example that is relevant, the odds of being a SUPERLINK player is 1 in 25. In certain situations it may be desirable to increase the number of players that get this benefit, so having 2 numbers as SUPERLINK numbers instead of just one, with a SUPERLINK play applying to any Link2Win™ card that has correctly chosen one of those numbers, gets the odds down to 1 in 12.5.

Although, the examples described above show the use of numbers on the card, the game can be played using any other form of symbols or icons or in some cases even physical objects.

Obtaining links of the numbers or symbols on a Game Play Area need not always be based on the consecutive ranking or placement order/value of the numbers/symbols as determined in the associated random draw and can instead be based on some other rule. For example, obtaining links can be based on every odd drawn number (ranking or placement order/value) e.g., 1^{st}, 3^{rd}, 5^{th} and so on and/or every even drawn number (ranking or placement order/value) e.g., 2^{nd}, 4^{th}, 6^{th} and so on.

Further, the exampled games are based on linking numbers on a 5×5 card by reference to the drawn numbers in a random draw with the immediately prior drawn number, to create a link. But variations of the game can be configured where the pattern to be matched on the card comprise drawn numbers matched in any order. For example, a 5 link could in this variation comprise linking any 5 numbers on the card in a straight continuous line. An example of this is the following drawn numbers (identified by any order of draw from a range of 5 consecutive drawn numbers). The drawn numbers might be, in order of draw: 7^{th} 8^{th} 9^{th} 10^{th} and 11^{th}. The corresponding 5 Link on the matrix card could in this variation be: 9^{th} 7^{th} 10^{th} 8^{th} 11^{th}.

Alternatively, and as a further example, links could be formed using consecutively drawn numbers from the random draw by linking two or more numbers on the Game Play Area based on a game rule that allows a link when there are one or more non complying numbers located in between the relevant numbers that are to be linked.

Variations to what constitutes a Link can also be made. For example, a game could comprise Links of only 2 symbols. For example, 4 consecutively that are linked together on a Game Play Area can form: 3×2 Links (overlapping links using common symbols); or 2×2 Links (when the game rules set only allow discrete links).

And there are many variations involving players having interaction, in addition to the four examples set out in Examples 8 to 11.

Various hardware configurations to implement the game/s are possible. For instance, the Link2Win™ game could be implemented using a client-server model in which a server entity is used to process the game data and then transmit the output to one or more client machines. The client-server model could also be implemented using one or more game terminals, such as terminals using touch screens. The client-server could also be implemented in a casino environment where the game terminals are multi-function, operating the game as part of or similar to a slot-machine based game. Alternatively, the Link2Win™ game could be implemented using a stand-alone computer, in which a stand-alone application would do the game processing of the card data and display the output in graphical form to the user.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

### Kit of Parts

It will also be understood that where a product, method or process as herein described or claimed and that is sold incomplete, as individual components, or as a “Kit of Parts”, that such exploitation will fall within the ambit of the invention.

These and other features and characteristics of the present invention, as well as the method of operation and functions of the related elements of structures and the combination of parts and economics of manufacture, will become more apparent upon consideration of the following description with reference to the accompanying drawings, all of which form part of this specification, wherein like reference numerals designate corresponding parts in the various figures.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However it is to be understood that the invention may assume various alternative variations, including multi-layered games and 3-D games, except where expressly specified to the contrary. It is also to be understood that the specific devices illustrated in the attached drawings, and described in the following specification are simply exemplary embodiments of the invention, hence specific dimensions and other physical characteristics related to the embodiments disclosed herein are not to be considered as limiting.

### Advantages of the Preferred Embodiments

Some of the advantages of the apparatus of the present invention and/or the preferred embodiments are as follows:

Great Flexibility:

A significant advantage of the set of cards and the new lottery system is that it has great flexibility and can be configured to suit the market into which it is to be offered. And it can have numerous visual front ends, all supported and running on the same underlying gaming system. For example, the new lottery system has applications of use in the LOTTO and Lottery sectors (including Keno), the Casino sector, the Slot sector, as well as in the Bingo sector of the gaming market. Further, the present invention allows a gaming event to operate with prizes, without prizes, or to operate using a totalizer or pari-mutuel system (where the prize pool depends upon the number of entries and is not a fixed amount) or to operate using a pari-mutuel system in combination with one or more ‘additional fixed prizes’, or to operate games as a single entry game played ‘on demand’ by one player and played as an instant play. Quicker Games: The present invention allows for quicker games when compared to a typical bingo game.

Reduced n Numbers without Reduction to the Odds:

The present invention allows reduced n numbers without adverse reduction in game odds when compared to a typical bingo game.

Instant and Maintained Game Excitement: Various applications of the game can provide the ‘won’ feeling, right from the start, then suspense as the ‘won’ prize decreases, then suspense as the won prize is lost, and then anticipation as winnings start to get closer, and excitement as winnings reappear, with the anticipation of further winnings. For cards that lose, there is the ‘almost’ or ‘nearly’ won feeling. Other applications can provide for a virtually instant start of winnings, followed by a continual increase to those winnings creating game excitement.

Numerous Prize Points:

A large number of prize winning levels—36-45 in total in the first two exampled games, but there could be more.

Multiple Winnings:

The games offer multiple prizes that can be won, up to 3 separate prizes in the exampled games set out in Examples 1 and 2-3 separate prize-winning categories for Links of 2, 3, and/or 5- and a player can win in all 3 categories.

Side Bet Opportunities:

The games offer the opportunity to offer additional side bets, creating further betting opportunities from within a single game.

Big Lotto Style Prizes can Always be on Offer:

The games can have odds that rise through the prize winning levels (36-45 in the first two exampled games) to surpass the odds in large big prize lottery games, such as the odds in EuroMillions (top prize is odds of 1 in 108 million) and American PowerBall (top prize is odds of 1 in 175 million). The games can have large insured ‘Lotto’ style prizes—always on offer.

Integrity of the Winning Results:

The winning card numbers/links are easily determined by a participant and the gaming operator and the determination of a winning card is based on the tried and proven method of a random draw of numbers after entry to the relevant game is closed. This is a process that can be of the highest integrity with the random number generator subject to checking by the licensing bodies.

Advantages of Involvement of Independent Auditing Party:

Further, the game results can be subject to an independent audit process, which can be done immediately after each game or even years later. We believe this ability to carry out independent audits will significantly reduce the chance of fraud affecting the winning result. The independent auditing party can simultaneously and independently receive raw gaming data and, following the closure of the relevant game, check and verify the integrity of the winning results as determined by the gaming operator using duplicate gaming software. This ability to involve an independent auditing party is of significant advantage and it enhances the integrity of the results of games using our invention.

All Required Cards can be Ranked:

An advantage of the invention is that each card containing one or more links can be ranked, against each other card.

Gaming System Guarantees a Winner:

A further advantage of the invention is that in a game involving a pool of participants, the gaming system can undertake eliminations and at relevant stages, separate cards that are tied in order to separate out a single first placed or ranked card. It does this by utilising the rankings of the 5, and/or 3 and/or 2 Links as has been set out in Examples 1.5-1.8. Each of the card's performances can be ranked against each other, resulting in the invention being able to always determine a first ranked card. The system of LOTTO cannot guarantee a first division winner, whether that be a single first division winner or two or more winners that share the first prize. This invention provides a transparent method to do so, and in a game involving a pool of players it can do so irrespective of the order of the number choices set out on each card and irrespective of the order of the random draw.

Gaming System is Structured to be Significantly Certain that a Single First Ranked Card Will Always Occur:

In contrast to LOTTO type games, games using this invention where a pool of entries occurs can, when required, always guarantee a first ranked card for any first place prize on offer and that it will be virtually certain that it will always be a sole first ranked card. The only circumstances where the gaming system of this invention cannot determine a single first ranked winner is where: (a) the winning card has the same matching Link results and the same rankings of ALL those Links by reference to Examples 1.5-1.8 as one or more other cards; and/or (b) ALL the cards in the game, and without exception, have no Links at all. Both events are extremely unlikely and are sufficiently remote that a single first ranked card can be said to be virtually certain. Nevertheless, if there are tied first ranked cards remaining after all the ranking and elimination procedures as set out in Examples 1.5-1.8 have been completed, then the remaining tied cards share the relevant prize.

Gaming System can be Used in Periodic Draws:

A further advantage is that the gaming system can be used in periodic draws, such as a yearly draw, where the computer software stores all the cards since the prior periodic draw and processes a free to entry game for a pari-mutuel prize funded by a portion of all entries made during the relevant period.

Gaming System Incorporates a Super Prize Function:

A further advantage is that the gaming system can incorporate a super prize function, similar in functionality to a Power Ball play in a Lotto game, where prizes can be significantly increased. This has been referred to as the SUPERLINK number located on the bottom right hand square of the 5×5 card. An example of the increase in prizes occurs when considering Table 17 (SUPERLINK prizes) against Table 16 (standard prizes).

Gaming System can be Used in a Virtual Environment:

A further advantage of the invention, is that it can be adapted from a pure numbers game, into a virtual game where the gaming experience and the delivery of results is through virtual or animated means that can be made to be more visually exciting than a pure numbers game.

Gaming System Allows for Player Interaction:

As set out in Examples 8 to 11, a further advantage of the invention is that it can allow players to interact with the game during the game draw in ways that deliver and enhance player satisfaction, and/or improve a players winning chances.

Gaming System Allows for Competitions:

A further advantage of the invention is that it can be used in a competition format, where a pool of players compete against each other and where one winner is to emerge, or it allows a single player to challenge him or herself against a computer, similar to a chess computer, thereby providing an interactive and challenging gaming event.

Gaming System can be Used in Numerous Other Gaming Sectors:

A further advantage of the invention is that it can be used in many different gaming sectors or categories, such as use in the LOTTO and Lottery sectors (including Keno), as well as the Casino, Slot, and Bingo sectors of the gaming market.

Gaming System has Important Advantages for State Lottery Operators:

As set out in Examples 3-5, further advantages are that the invention can be used by State Lottery Operators in various applications of the invention (including by way of Link2Win™ Scratch Card applications) all using a State Lottery Operator's existing POS lottery retailer networks, with no need for online entry purchasing transactions, while at the same time still providing for players to experience the convenience and excitement of a computer animated and visually engaging play-out of the results of a game utilising the invention on a player's personal computer device (e.g. on mobile, tablet, PC). And these advantages and relevant aspects of the invention can extend to other lottery games (including other scratch cards) of a State Lottery Operator.

Advantages for Use in a Regional or Worldwide Lottery:

The gaming system of this invention has as one of its advantages the ability to be used in a regional or worldwide lottery game. The game of the present invention will have some significant advantages or appeal when used in a regional or worldwide lottery compared with the standard ‘LOTTO’ type games, many of which have remained unchanged for years. These advantages or appeal will include: Unique and Exciting: The games of this invention are unique, different and easy to play with game and draw excitement. The games can be full of suspense;

Transparent:

Results and game processes are transparent and able to be independently audited;

Player Engagement:

The games of this invention can deliver, transparently, the ‘won’ feeling, or the ‘nearly won’ feeling, right from the start;

Can Attract Players:

It is generally accepted that new, exciting and easily understood games attract and retain players, which is of interest to all gaming operators. The games of the present invention meets all these points;

Wide Odds Range:

The games of the present invention can give rise to a wide range of odds, both in respect of the ability to win any prize and in respect of the ability to create significant Lotto style prizes, which occur as a consequence of the creation of the sizable odds that are created as a consequence of the invention set out in the exampled games. For example, prize points with odds of 1 in 22; 40; 75; 363; and 418 million arise in the exampled 5×5 game—see Example 1.19, Table 12;

Numerous Prize Points:

The matrix game of the present invention also allows for many prize points (36-45 in the first two exampled games); including for a unique prize for a complete failure to secure any 2 Link match on a card;

A Complimentary Game:

The games of the present invention can be positioned by lottery organizations as complimentary games to their existing Lotto type businesses;

Online and Mobile Applications:

The games are ideal for online game applications (including mobile) which is where many of the world's gaming and lottery organizations have a keen focus, but the games of this invention are equally capable of being used in a retail environment (scratch cards) or through standard Lotto type POS lottery retailers—where a televised or broadcast draw occurs, or where the results are played on a player's mobile, tablet or personal computer device; and

Flexible Market Positioning:

The games of this invention can be positioned with different price and prize points and different play frequencies. For example, the 5×5 card game can be position as an instant play or daily game, and the 6×6 game could be positioned as a higher priced weekly game.

### INDUSTRIAL APPLICABILITY

As described above, the preferred embodiments of the invention allows for apparatus for playing a game comprising individual cards or a set of cards (whether printed on paper or card or displayed on a Visual Display Unit). The cards can be used for a gaming event with prizes, without prizes, or to operate using a totalizer or pari-mutuel system (where the prize pool depends upon the number of entries and is not a fixed amount) or to operate using a pari-mutuel system in combination with one or more ‘additional fixed prizes’, or to operate using fixed prize amounts. In respect of a game that is played by a pool of players, the gaming event can be set to close at a defined time or upon the reaching of defined parameters such as the reaching of a predetermined number of ticket sales or prize pool.

The apparatus of the preferred embodiments of the invention allow quicker games. The present invention allows a reduced range of n numbers without reduction to game odds.

The preferred embodiment of the invention guarantees a winning result and that it will be substantially certain that there will be a single card (player) as the sole winner.

The preferred embodiments of the invention provide the advantages listed above.

1. Apparatus for playing a game comprising a substrate wherein the substrate has a matrix of symbols, the symbols comprising a set of sequential symbols, wherein the symbols have been allocated at random to locations on the substrate to populate the matrix so that the resulting layout on the substrate comprises the location of each symbol within the matrix, and means for displaying on or in association with each matrix the existence of links between symbols in the matrix in accordance with the rules of the game.

2. Apparatus for playing a game comprising a card wherein the card displays at least one matrix of a first set of symbols, the matrix having m cells, and each matrix displays differing symbols on or in at least some of its cells, the differing symbols chosen from the first set of n symbols, a second set of sequentially ranked symbols which can be used to identify the ranking of the location of each symbol of the first set of symbols in the or each matrix and means for displaying on or in association with each matrix the existence of links between symbols in the matrix in accordance with the rules of the game.

3. Apparatus for playing a game as claimed in claim 2, wherein the links are displayed between adjacent symbols having sequential rankings.

4. Apparatus for playing a game comprising a set of cards wherein each card displays at least one matrix of m cells, and each matrix displays differing symbols on at least some of its cells, the differing symbols chosen from a set of n symbols, the layout of the symbols differing from matrix to matrix on the cards, means for displaying on or in association with each matrix the sequence in which the symbols have been ranked during the course of a game so that each of the symbols is ranked within a matrix, and means for displaying on or in association with each matrix the existence of adjacent symbols having sequential rankings.

5. Apparatus for playing a game as claimed in claim 4, wherein m=n.

6. Apparatus for playing a game as claimed in claim 4, wherein each matrix displays a full set of n differing symbols and each symbol appears only once on each matrix.

7. Apparatus for playing a game as claimed in claim 4, wherein each card is a printed card having a substrate on which the set of m cells is printed in a matrix and the symbols are printed on or in association with the matrix, with each symbol being located within the confines of a respective cell.

8. Apparatus for playing a game as claimed in claim 4, wherein the apparatus also includes a set of at least n tokens for each card, each token being of a size that is equal to or less than the cell size of each cell in the matrix, each token having at least two faces, a first face and a contrasting face and each token having a sequential ranking chosen from 1 to n recorded on both the first face and the contrasting face, so that tokens can be placed on the cells in sequence with a first face showing as each symbol is called and links between sequentially selected symbols in adjacent cells can be recorded by changing the display of one or more tokens on the cells so that the one or more tokens display a contrasting face.

9. Apparatus for playing a game as claimed in claim 1, wherein the card is a scratch card and the symbols are printed on a hidden layer which can be revealed by scratching away a scratchable layer.

10. Apparatus for playing a game as claimed in claim 4, wherein the cards are scratch cards and the ranking is printed on a hidden layer which can be revealed by scratching away a scratchable layer.

11. Apparatus for playing a game as claimed in claim 10, wherein the random matrix of symbols on each card is printed on or above the scratchable layer.

12. A set of cards as claimed in claim 10, wherein each card also includes at least one machine readable code.

13. Apparatus for playing a game as claimed in claim 4, wherein the apparatus includes at least one visual display unit (VDU) displaying one or more cards.

14. Apparatus for playing a game as claimed in claim 13, wherein the or each visual display unit is adapted to display the ranking of each cell in a matrix as each cell number is selected during the course of a game.

15. Apparatus for playing a game as claimed in claim 13, wherein each visual display unit is adapted to display links between sequentially selected symbols in adjacent cells.

16. Apparatus for playing a game as claimed in claim 13, wherein each visual display unit is adapted to allow a player to allocate or re-arrange the set of n symbols within the matrix of m cells to define his own arrangement of symbols prior to play.

17. Apparatus for playing a game as claimed in claim 13, further including a game server, wherein there are a plurality of visual display units adapted to receive and send game information from and to the game server which is adapted to (a) record entries, (b) use a random or pseudo random selection process for the symbols during the course of a game and (c) to relay information on the selection of the symbols to each visual display unit.

18. Apparatus for playing a game as claimed in claim 13, wherein the plurality of visual display units are or form part of casino machines which are connected to a game server by a secure network.

19. Apparatus for playing a game as claimed in claim 13, wherein the plurality of visual display units are or form part of machines chosen from the group comprising: personal computers, gaming machines, tablets, smart phones, hand held or portable machines, and the like.

20-41. (canceled)

42. Apparatus for playing a game as claimed in claim 1, wherein the links are displayed between adjacent symbols having sequential rankings.
